(19) United States
(12) Patent Application Publication
(10) Pub. No.: US 2018/0277018 A1
(43) Pub. Date: Sep. 27, 2018

(54) INFORMATION PROCESSING SYSTEM, INFORMATION PROCESSING METHOD, AND INFORMATION PROCESSING DEVICE

(71) Applicants: Jun MURATA, Tokyo (JP); Yuto Karei, Tokyo (JP); Kei Oyamada, Kanagawa (JP)

(72) Inventors: Jun MURATA, Tokyo (JP); Yuto Karei, Tokyo (JP); Kei Oyamada, Kanagawa (JP)

(73) Assignee: Ricoh Company, Ltd., Tokyo (JP)

(21) Appl. No.: 15/923,173

(22) Filed: Mar. 16, 2018

(30) Foreign Application Priority Data
Mar. 21, 2017 (JP) 2017-055204

(51) Int. Cl. G09B 19/06; G09B 5/06; G09B 5/10; G09B 5/12; G09B 7/02

(52) U.S. Cl. CPC G09B 19/06; G09B 5/065; G09B 5/10; B43L 1/00; G09B 7/02; G09B 5/12; G09B 5/125

(57) ABSTRACT

According to an embodiment, an information processing device includes a memory having computer readable instructions stored thereon and at least one processor. The at least one processor is configured to execute the computer readable instructions to: set, in response to an instruction from a first terminal device, task information containing a task and a request for an answer to the task; present, in the first terminal device, a user interface meant for inputting the instruction; manage the task information; and receive the answer which is sent from a second terminal device and which is associated to the task included in the task information that is obtained by the second terminal device. For each of sets of identification information enabling identification of the second terminal device that sent the answer, the at least one processor further manages the received answer in a corresponding manner to the task information containing the task.

### CROSS-REFERENCE TO RELATED APPLICATIONS

The present application claims priority under 35 U.S.C. § 119 to Japanese Patent Application No. 2017-055204, filed on Mar. 21, 2017. The contents of which are incorporated herein by reference in their entirety.

### BACKGROUND OF THE INVENTION

### 1. Field of the Invention

The present invention relates to an information processing system, an information processing method, and an information processing device.

### 2. Description of the Related Art

Typically, a CALL system (CALL stands for Computer Assisted Language learning) is known that supports language learning with the use of a computer. In a CALL system, for example, a teacher computer is connected to a plurality of computers, each of which is assigned to a student, via a server; and contents such as voice contents, video contents, and text contents are delivered to the students' computers from the teacher computer. For example, each student uses the corresponding computer to reproduce the delivered contents; records his or her own pronunciations according to the reproduced contents; and sends the pronunciations to the teacher computer. Based on the voice data sent from the students' computers, the teacher evaluates each student. In this way, the CALL system can support language learning of each student.

In Japanese Unexamined Patent Application Publication No. 2015-179342, in a system including an information processing system, a first terminal, and a second terminal; a technology is disclosed that enables achieving enhancement in the user-friendliness at the time of distributing data from the first terminal device to the second terminal device.

In a conventional CALL system, the association between the contents delivered from the teacher computer and the voice data sent from the students' computers in response to the delivered contents is not taken into account. Hence, in the case of offering evaluation by comparing the voice data sent from the students with the delivered contents, it leads to an increase in the work burden. As a result, it becomes difficult to achieve efficiency while conducting the class.

In view of the issues mentioned above, there is a need to enable easy understanding of the relationship between the delivered contents and the data sent in response to those contents.

### SUMMARY OF THE INVENTION

According to an embodiment, an information processing device includes a memory having computer readable instructions stored thereon and at least one processor. The at least one processor is configured to execute the computer readable instructions to: set, in response to an instruction from a first terminal device, task information containing a task and a request for an answer to the task; present, in the first terminal device, a user interface meant for inputting the instruction; manage the task information; and receive the answer which is sent from a second terminal device and which is associated to the task included in the task information that is obtained by the second terminal device. For each of sets of identification information enabling identification of the second terminal device that sent the answer, the at least one processor further manages the received answer in a corresponding manner to the task information containing the task.

### BRIEF DESCRIPTION OF THE DRAWINGS

FIG. 1 is a diagram illustrating an arrangement of devices in an information processing system according to an embodiment;

FIG. 2 is a block diagram illustrating an exemplary configuration of the information processing system according to the embodiment;

FIGS. 3A and 3B are diagrams for explaining a method, according to the embodiment, for responding to the listening of a voice;

FIG. 4 is a diagram illustrating an exemplary hardware configuration of a class management server implementable in the embodiment;

FIG. 5 is a diagram illustrating an exemplary hardware configuration of a teacher PC implementable in the embodiment;

FIG. 6 is a diagram illustrating an exemplary hardware configuration of a student terminal implementable in the embodiment;

FIG. 7 is a functional block diagram for explaining an example of the functions of the class management server according to the embodiment;

FIG. 8 is a functional block diagram for explaining an example of the functions of the teacher PC according to the embodiment;

FIG. 9 is a functional block diagram for explaining an example of the functions of the student terminal according to the embodiment;

FIG. 10 is a sequence diagram illustrating an example of a class course registration operation performed by a staff member using the information processing system according to the embodiment;

FIG. 11 is a sequence diagram illustrating an example of a class setting operation performed by a teacher using the information processing system according to the embodiment;

FIG. 12 is a sequence diagram illustrating an example of operations performed in a class by a teacher and students using the information processing system according to the embodiment;

FIG. 13 is a diagram illustrating an example of screen transition in a staff member PC according to the embodiment;

FIGS. 14 to 18 are diagrams illustrating exemplary screens displayed in the staff member PC according to the embodiment;

FIG. 19 is a diagram illustrating an example of screen transition in the teacher PC according to the embodiment;

FIGS. 20A to 20D and FIGS. 21 to 27 are diagrams illustrating exemplary screens displayed in the teacher PC according to the embodiment;

FIG. 28 is a diagram illustrating an example of screen transition in the student terminal according to the embodiment; and

FIGS. 29 to 34 are diagrams illustrating exemplary screens displayed in the student terminal according to the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An exemplary embodiment of an information processing system, an information processing method, and an information processing device is described below in detail with reference to the accompanying drawings. The information processing system according to the embodiment is assumed to constitute a CALL system (CALL stands for Computer Assisted Language Learning) meant for supporting language learning. Prior to the explanation of the embodiment, in order to facilitate understanding, the explanation is given about the users who are defined in the CALL system according to the embodiment.

In the CALL system according to the embodiment, four types of user, namely, a student, a teacher, a staff member, and an administrator are defined. That is, a student, a teacher, a staff member, and an administrator represent the roles assigned to the users and, in the CALL system according to the embodiment, each user is given authority according to the role assigned thereto. In the following explanation, unless otherwise specified, a user who is assigned with the role of either a student, or a teacher, or a staff member, or an administrator is called either a student, or a teacher, or a staff member, or an administrator.

A student represents a user who does language learning activities using the CALL system according to the embodiment. A teacher provides language education to the students using the CALL system. A staff member performs management of the teachers and the students. For example, a staff member assigns the role of a student or the role of a teacher to other users. Moreover, a staff member can assign the role of a staff member to other users.

Furthermore, the staff member manages the classes conducted in the CALL system. An administrator performs administration of the information processing system that constitutes the CALL system. The administrators have the top-level rights in the information processing system; and then the rights are increasingly restricted for the staff members, the teachers, and the students in that order.

Configuration Implementable in Embodiment

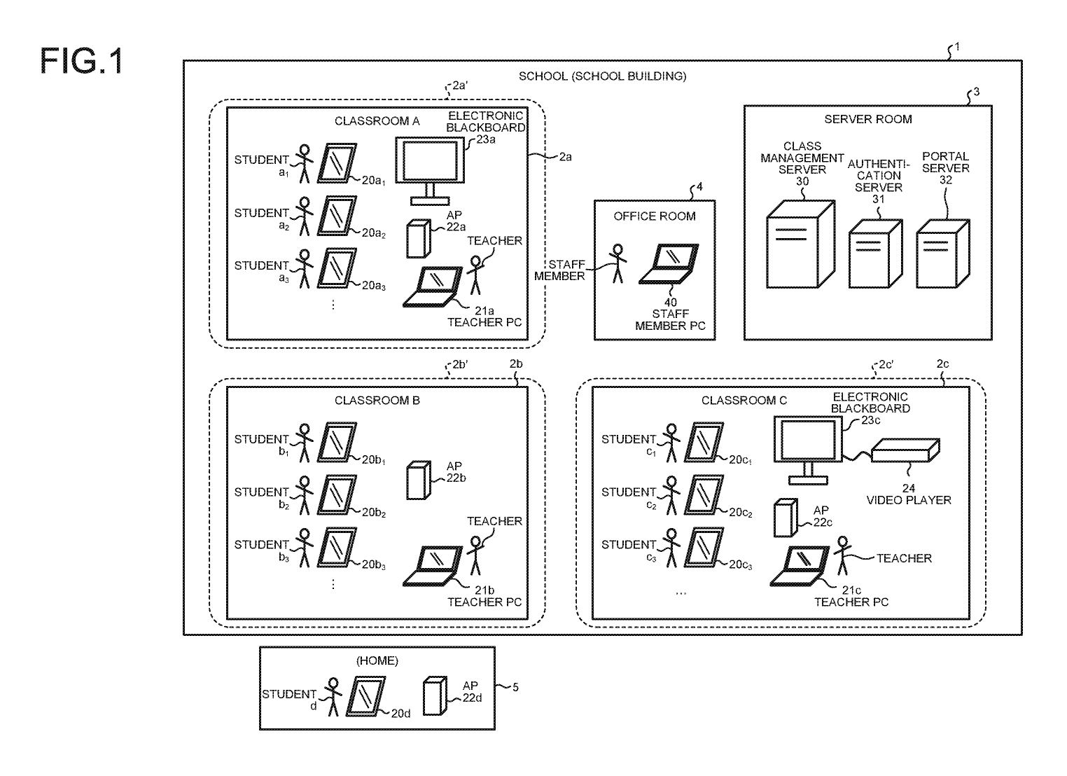

In FIG. 1 is illustrated an arrangement of devices in the information processing system according to the embodiment. In the information processing system according to the embodiment, a school 1 represents a building structure (a school building), and has a plurality of classrooms 2a, 2b, and 2c representing partitioned spaces (rooms). In FIG. 1, the classrooms 2a, 2b, and 2c are also illustrated as classrooms A, B, and C, respectively. Moreover, the school 1 has a server room 3 and an office room 4 representing partitioned spaces (rooms). Alternatively, the server room 3 and the office room 4 can be set up in a single room.

With reference to FIG. 1, in the classroom 2a, an access point (AP) 22a of a wireless local area network (LAN) is installed, and an electronic blackboard 23a is installed. The electronic blackboard 23a is capable of receiving the writing done thereon using, for example, a dedicated pen and displaying it as an image; and is capable of displaying videos or still images that are input from outside. Moreover, with reference to FIG. 1, a communicable area 2a′ represents the network area in which wireless communication can be performed using the AP 22a. Herein, the communicable area 2a′ for the AP 22a is set to include the classroom 2a but is set not to include the other classrooms 2b and 2c. Regarding an AP 22 installed in each other classroom too, in an identical manner, the communicable area does not include the other classrooms other than the concerned classroom.

In the classroom 2a, students a₁, a₂, a₃, and so on take classes using student terminals 20a₁, 20a₂, 20a₃, and so on, respectively, that are capable of performing wireless communication with the AP 22a. If the student a₁ carries the student terminal 20a₁ to the classroom B, then the student terminal 20a₁ becomes able to perform wireless communication with an AP 22b. Although the student terminals 20 are configured to be able to perform wireless communication with the AP 22 installed in each room, the APs 22 do not include the other classrooms in the respective communicable areas. Hence, if the student a₁ possessing the student terminal 20a₁ is present in the classroom B, then he or she cannot communicate with the AP 22a. A teacher PC 21a is a personal computer (PC) used by a teacher for controlling a class conducted using the student terminals 20a₁, 20a₂, 20a₃, and so on. The teacher PC 21a can be installed in a fixed manner in the classroom 2a or can be carried along every time to the classroom 2a by a teacher.

The classrooms 2b and 2c too have a substantially identical configuration to the configuration in the classroom 2a. In the example illustrated in FIG. 1, the classroom 2b has the AP 22b installed therein, but does not have an electronic blackboard installed therein. In the classroom 2b, for example, students b₁, b₂, b₃, and so on take classes using student terminals 20b₁, 20b₂, 20b₃, and so on, respectively; and a teacher uses a teacher PC 21b to control the classes conducted using the student terminals 20b₁, 20b₂, 20b₃, and so on. A communicable area 2b′ represents the communicable area for the AP 22b and is adjusted in an identical manner to the communicable area 2a′.

Meanwhile, in the embodiment, as student terminals 20a₁, 20a₂, . . . , 20b₁, 20b₂, . . . , 20c₁, 20c₂, and so on; tablet PCs are used that are configured to be easily portable and that have the wireless communication function and a touch-sensitive panel. However, that is not the only possible case. Alternatively, as the student terminals 20a₁, 20a₂, . . . , 20b₁, 20b₂, . . . , 20c₁, 20c₂, and so on; it is possible to use laptop PCs or desktop PCs.

Moreover, in the example illustrated in FIG. 1, the classroom 2c has an AP 22c, an electronic blackboard 23c, and a video player 24 installed therein. To the electronic blackboard 23c, videos and voices output from the video player 24 are supplied. Thus, the electronic blackboard 23c can reproduce the videos and the voices supplied from the video player 24. Moreover, in an identical manner to the classrooms 2a and 2b; in the classroom 2c, for example, students c₁, c₂, c₃, and so on take classes using student terminals 20c₁, 20c₂, 20c₃, and so on, respectively; and a teacher uses a teacher PC 21c to control the classes conducted using the student terminals 20c₁, 20c₂, 20c₃, and so on. A communicable area 2c′ represents the communicable area for the AP 22c and is adjusted in an identical manner to the communicable area 2a′.

With reference to FIG. 1, the server room 3 has a class management server 30, an authentication server 31, and a portal server 32 installed therein. The class management server 30 that functions as an information processing device manages the classes during which the student terminals 20a₁, 20a₂, . . . , 20b₁, 20b₂, . . . , 20c₁, 20c₂, . . . , and so on are used in the classrooms 2a, 2b, and 2c. The authentication server 31 manages the accounts of the users such as the students, the teachers, the staff members, and the office clerks in the school; and accordingly authenticates the users. In the embodiment, the users who access the information processing system are limited to the users who have their accounts managed in the authentication server 31. However, that is not the only possible case. Alternatively, for example, the configuration can be such that a user from outside the school can be allowed to use the information processing system in collaboration with an external system.

The portal server 32 provides, for example, the portal website of the school. Using the portal website, the users in the school can acquire various tools meant for implementing the functions provided by the information processing system. Meanwhile, in the embodiment, the student terminals 20 are provided by the school, and are already equipped with an application program that is required for using the information processing system according to the present invention. In this way, tools including the application program are managed in the school portal, thereby enabling the school to restrict free use of the application program. Meanwhile, in case student terminals are not provided by a school, it does not imply that the present embodiment cannot be implemented. That is, the method described above is one of the examples of managing and controlling the target users of the system in an appropriate manner.

The office room 4 is the room in which, for example, a staff member is stationed, and the staff member uses a staff member PC 40 in the office room 4. Thus, the staff member PC 40 is used by a staff member and is capable of, for example, performing registration and setting of students, teachers, and staff members in the class management server 30 as well as performing registration and editing of information various classes in the class management server 30.

The information processing system according to the embodiment is configured to be accessible also from the outside of the school 1. For example, from his or her home 5, a student d can access the information processing system using a terminal device 20d via an AP 22d and can participate in the classes conducted using the information processing system. Moreover, instead of using wireless communication via the AP 22d, the information processing system can be accessed using wired communication as long as the terminal device 20d is compatible. However, in these cases, the use of the information processing system is partially restricted as compared to the participation from the classrooms 2a, 2b, and 2c. More particularly, although the student d can revise the intended classes, he or she cannot take the classes on a real-time basis. Meanwhile, the terminal device 20d can be a tablet PC identical to the student terminals 20, or can be a personal computer having an identical configuration to the teacher PCs 21, for example.

Meanwhile, in FIG. 1, it is illustrated that there are three classrooms 2a, 2b, and 2c in the school 1. However, that is only exemplary. That is, the school 1 can have four or more classrooms, or can have two or less classrooms. Moreover, in FIG. 1, it is illustrated that the information processing system according to the embodiment is completely configured within a single school building. However, that is not the only possible case. Alternatively, the information processing system according to the embodiment can be configured across a plurality of school buildings, or can be configured across a plurality of schools too.

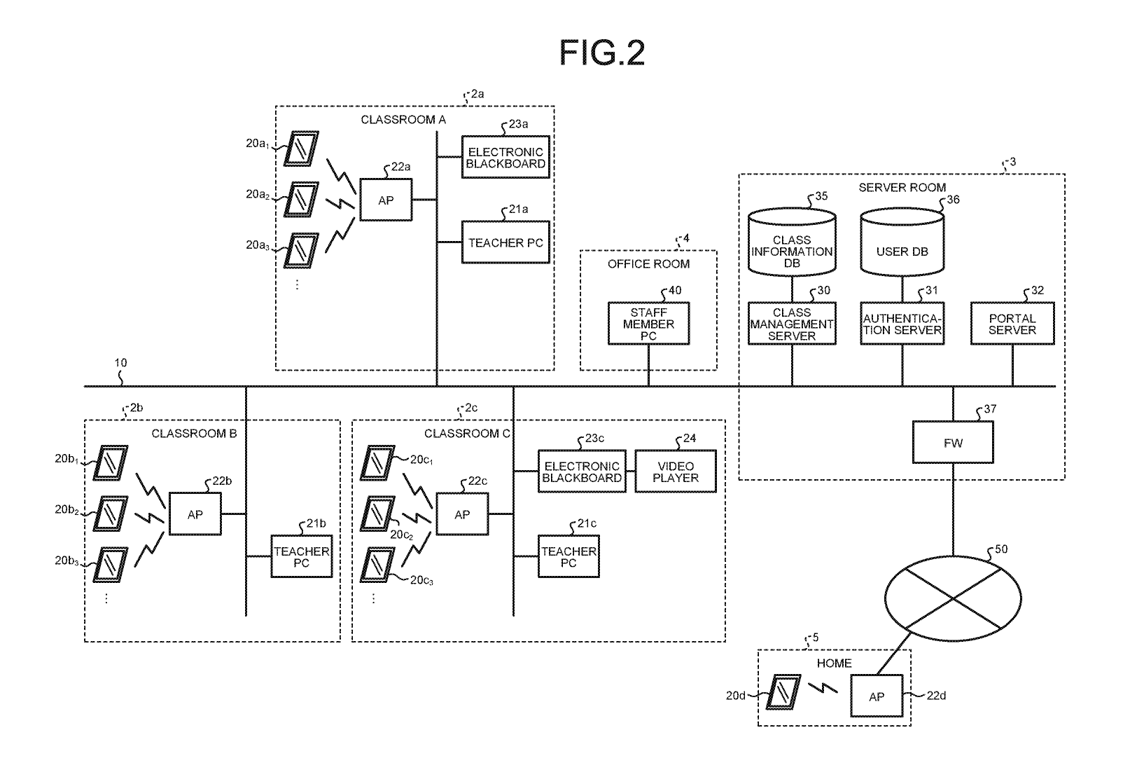

In FIG. 2 is illustrated an exemplary configuration of the information processing system according to the embodiment. With reference to FIG. 2, the constituent elements identical to those illustrated in FIG. 1 are referred to by the same reference numerals, and the detailed explanation thereof is not repeated. In the school 1, a network 10 is laid based on, for example, a local area network (LAN). In the server room 3, the class management server 30, the authentication server 31, and the portal server 32 are connected to the network 10. In the office room 4, the staff member PC 40 is connected to the network 10. In the classrooms 2a, 2b, and 2c; the teacher PCs 21a, 21b, and 21c as well as the APs 22a, 22b, and 22c are connected to the network 10. Moreover, the electronic blackboard 23a in the classroom 2a and the electronic blackboard 23c in the classroom 2c are connected to the network 10.

In the classroom 2a, the student terminals 20a₁, 20a₂, and so on are connected to the network 10 via the AP 22a. In an identical manner, in the classroom 2b, the student terminals 20b₁, 20b₂, and so on are connected to the network 10 via the AP 22b. Moreover, in the classroom 2c, the student terminals 20c₁, 20c₂, and so on are connected to the network 10 via the AP 22c.

In the classrooms 2a, 2b, and 2c; the APs 22a, 22b, and 22c, respectively, are set to have such ranges of Internet protocol (IP) addresses for the wireless LAN that the IP addresses do not overlap among the ranges. For example, the subnet mask is set at “255.255.255.0”; the AP 22a is set to have the range of IP addresses from “192.168.0.21” to “192.168.0.60”; the AP 22b is set to have the range of IP addresses from “192.168.0.61” to “192.168.0.100”; and the AP 22c is set to have the range of IP addresses from “192.168.0.101” to “192.168.0.140”. In each of the student terminals 20a₁, 20a₂, . . . , 20b₁, 20b₂, . . . , 20c₁, 20c₂, and so on; the destination IP address is mandatorily set according to the corresponding classroom, so that the connection of the student terminals 20a₁, 20a₂, . . . , 20b₁, 20b₂, . . . , 20c₁, 20c₂, and so on in the respective classrooms 2a, 2b, and 2c can be controlled.

Moreover, it is assumed that the class management server 30 is set in advance as the default destination for the student terminals 20a₁, 20a₂, . . . , 20b₁, 20b₂, . . . , 20c₁, 20c₂, and so on.

In the classroom 2a, the electronic blackboard 23a includes a touch-sensitive panel in which an input device and a display device are formed in an integrated manner; and is capable of obtaining, as image data, the images drawn by the user on the touch-sensitive panel using, for example, a dedicated pen. The electronic blackboard 23a can send the obtained image data to the network 10. Moreover, the electronic blackboard 23a can display videos, which are based on video data received via the network 10, using the display device in the touch-sensitive panel.

In an identical manner, the electronic blackboard 23c installed in the classroom 2c too obtains, as image data, the images drawn on the touch-sensitive panel and sends the image data to the network 10; and can display videos that are based on video data received via the network 10. The electronic blackboard 23c installed in the classroom 2c can also display the videos output from the video player 24 connected thereto; and can send the videos, which are output from the video player 24 and are displayed, to the network 10.

In the server room 3, the authentication server 31 has a user database (DB) 36 connected thereto. The user DB 36 is used to manage account information of the users, such as staff members, teachers, students, and other employees of the school 1, who access the information processing system according to the embodiment. An example of the account information that is stored in the user DB 36 is explained with reference to Tables 1 and 2. In Table 1 is illustrated an example of an account information table in which the account information of each user is stored.

TABLE 1

Account information

| User name | User ID | Password |
|---|---|---|
| Staff member A | shoku-a@abc.def.ac | ******* |
| Staff member B | shoku-b@abc.def.ac | ******* |
| [symbol] | [symbol] | [symbol] |
| Teacher A | kyou-a@abc.def.ac | ******* |
| Teacher B | kyou-b@abc.def.ac | ******* |
| [symbol] | [symbol] | [symbol] |
| Student A | seito-a@abc.def.ac | ******* |
| Student B | seito-b@abc.def.ac | ******* |
| [symbol] | [symbol] | [symbol] |

In the example illustrated in Table 1, each record in the account information table includes following items: “user name”, “user ID”, and “password”. The item “user ID” is used to store identification information enabling identification of the users. The item “password” is used to store passwords that are utilized in combination with the user IDs at the time of authentication. The account information contains the information stored in the items “user ID” and “password”. With that combination, the uniqueness of a single user is guaranteed, and the account information is managed as the account of a single user. The item “user name” is used to store the names of the users corresponding to the user IDs. In the account information table, the user names, the user IDs, and the passwords are managed in a corresponding manner. The account information table is stored in the user DB 36.

The authentication server 31 performs an authentication operation in response to an authentication request received via the network 10. For example, based on the user ID and the password included in a received authentication request, the authentication server 31 refers to the account information table stored in the user DB 36. If it is confirmed that account information matching with the received combination of the user ID and the password is stored in the account information table, then the authentication server 31 determines that authentication is successful. However, if it is confirmed that account information matching with the received combination of the user ID and the password is not stored in the account information table, then the authentication server 31 determines that authentication is not successful. Then, the authentication server 31 sends the authentication result to the source of request. Upon receiving the authentication result, the source of request accordingly performs control in which, if the authentication is successful, the user corresponding to the concerned account information is allowed to access the information processing system.

The user DB 36 is further used to store and manage, as role information, the users and their respective roles. In Table 2 is illustrated an example of a role information table in which the role information is stored.

TABLE 2

| User ID | Role |
|---|---|
| shoku-a@abc.def.ac | Staff member |
| kyou-b@abc.def.ac | Teacher |
| seito-b@abc.def.ac | Student |
| kanrisha@abc.def.ac | Administrator |
| [symbol] | [symbol] |

As illustrated in Table 2, each record in the role information table includes items “user ID” and “role”. The item “user ID” corresponds to the item “user ID” included in the account information table. The item “role” is used to store the role (such as student, teacher, staff member, or administrator) assigned to each user having the user ID stored in the item “user ID”. In this way, a role is associated to each user in the role information table. Herein, the role information table is stored in the user DB 36.

With respect to a user who has been authenticated as a result of the authentication operation performed in response to an authentication request, the authentication server 31 refers to the role information table based on the user ID specified in that authentication request and obtains user information such as the role associated to the concerned user ID. In the case of successful authentication, the authentication server 31 includes the user information in the authentication result that is sent. As a result, the rights according to the obtained role are granted to the user having the concerned user ID.

Meanwhile, the variety of information to be stored in the account information table illustrated in Table 1 is set and then stored in the account information table by, for example, an administrator. However, that is not the only possible case. Alternatively, the variety of information to be stored in the account information table can be set by the users, and then an administrator or a staff member can store the information in the account information table.

The variety of information to be stored in the role information table is set and then stored in the role information table by a staff member or an administrator. However, that is not the only possible case. Alternatively, an administrator can store the variety of information in the role information table. At that time, a user can set the information about the roles equivalent to his or her role or about lower-level roles (having more restricted authority), and can store the information in the role information table.

For example, a user having the role of a “staff member” can store the information about the users having either the role of “staff member”, or the role of “teacher”, or the role of “student” in the role information table; but cannot store the information about the users having the role of “administrator” in the role information table. Similarly, a user having the role of a “teacher” can store the information about the users having either the role of “teacher” or the role of “student” in the role information table; but cannot store the information about the users having the role of “staff member” and the role of “administrator” in the role information table.

In the server room 3, the class management server 30 has a class information DB 35 connected thereto. The class management server 30 manages the classes according to class information stored in the class information DB 35.

In the information processing system according to the embodiment, regarding the classes managed as a CALL system, the brief explanation is given below. The classes are managed using a table, which is generally called a timetable, in which a single day is divided into predetermined time slots called school hours and such days are grouped in the unit of weeks. A single class is assumed to be taken in a single school hour; and the classroom and the teacher in charge is set for each class. Moreover, class courses including one or more classes are defined. For example, a class course is set with a predetermined period of time, such as one year (full year) or half year (first semester or second semester), treated as the unit of time. For example, a class course includes a series of classes based on a certain theme. However, that is not the only possible case.

In Table 3 is illustrated an example of a class information table that is stored in the class information DB 35. In the example illustrated in Table 3, each record in the class information table includes following items: “course”, “teacher in charge”, “schedule”, and “student”. Thus, in the example illustrated in Table 3, classes are managed in the unit of class courses.

TABLE 3

| | | Schedule | |
|---|---|---|---|
| | Teacher in | (time-schedule, school | |
| Course | charge | hour, classroom) | Student |
| Subject a | Teacher A | (Apr. 3, 2017, 2, A), | seito-a@abc.def.ac, |
| | | (Apr. 10, 2017, 2, B) | seito-b@abc.def.ac, |
| | | | . . . |
| Subject b | Teacher A, | (Apr. 5, 2017, 5, B), | seito-b@abc.def.ac, |
| | Teacher B | (Apr. 12, 2017, 3, B) | seito-c@abc.def.ac, |
| | | | . . . |
| Subject c | Teacher C | (Apr. 6, 2017, 3, C), | seito-a@abc.def.ac, |
| | | (Apr. 13, 2017, 3, C) | seito-d@abc.def.ac, |
| | | | . . . |
| [symbol] | [symbol] | [symbol] | [symbol] |

The item “course” is used to store the title of the class course. The item “teacher in charge” is used to store the name of the teacher who is in charge of taking the classes of the concerned class course. Alternatively, in the item “teacher in charge”, the user ID of the teacher in charge can be stored either in place of the name of that teacher or along with the name of that teacher. Moreover, the item “teacher in charge” can have the names of a plurality of teachers stored therein. The item “schedule” is used to store the schedule of one or more classes included in the concerned class course. The schedule of a class includes information such as the time schedule, the school hour, and the classroom of that class. Each schedule has the school hour and the classroom associated for each time schedule, and is stored in the item “schedule”. The item “student” is used to store the user IDs of the students who have registered for taking the classes of the concerned class course. The item “student” can have a plurality of student IDs stored therein.

In the example illustrated in Table 3, a class course “subject b” has two teachers in charge, namely, “teacher A” and “teacher B” associated thereto. Moreover, it is illustrated that, in the item “schedule”, regarding the class course “subject b”, a class is set on Apr. 5, 2017 at the fifth school hour in the classroom B and a class is set on Apr. 12, 2017 at the third school hour in the classroom B.

The class information DB 35 is further used to store a connection information table in which connection setting information with respect to the network 10 in the classrooms 2a, 2b, and so on is stored. In Table 4 is illustrated an example of the connection information table that is stored in the class information DB 35.

TABLE 4

| | Electronic | | | |
|---|---|---|---|---|
| | blackboard | | | |
| Classroom | IP address | SSID of AP | IP address range of AP | Password |
| Classroom A | 192.168.0.11 | ######## | 192.168.0.21-192.168.0.60 | ******** |
| Classroom B | — | ######## | 192.168.0.61-192.168.0.100 | ******** |
| Classroom C | 192.168.0.21 | ######## | 192.168.0.101-192.168.0.140 | ******** |
| [symbol] | [symbol] | [symbol] | [symbol] | [symbol] |

In the example illustrated in Table 4, each record in the connection information table includes following items: “classroom”, “electronic blackboard IP address”, “SSID of AP”, IP address range of AP”, and “password”. The item “classroom” is used to store the information enabling identification of the classrooms 2a, 2b, and so on. For example, with reference to FIG. 1, the classrooms 2a, 2b, and so on have classroom names of “classroom A”, “classroom B”, and so on; and the item “classroom” in the example illustrated in Table 4 is used to store such a classroom name. The item “electronic blackboard IP address” is used to store the IP address set in the electronic blackboard that is installed in the concerned classroom. In the example illustrated in FIG. 1, there is no electronic blackboard installed in the classroom 2b. Hence, in the record corresponding to the classroom 2b (the classroom B), the item “electronic blackboard IP address” is left empty.

The item “SSID of AP” is used to store the SSID (which stands for Service Set IDentifier) set in the concerned AP from among the APs 22a, 22b, and so on installed in the classrooms 2a, 2b, and so on. The item “IP address range of AP” is used to store the range of IP addresses for the wireless LAN set in the concerned AP from among the APs 22a, 22b, and so on installed in the classrooms 2a, 2b, and so on. Herein, the ranges of IP addresses are set in such a way that there is no repetition of IP addresses among the APs 22a, 22b, and so on installed in the classrooms 2a, 2b, and so on. The item “password” is used to store the password to be used at the time of establishing connection with the concerned AP from among the APs 22a, 22b, and so on installed in the classrooms 2a, 2b, and so on.

For example, regarding the student terminal 20a₁, corresponding to the classroom 2a (the classroom A), when a value is set in the item “SSID of AP”, when a single available IP address is set in the item “IP address range of AP”, and when a value is set in the item “password”; it becomes possible to establish communication between the AP 22a, which is installed in the classroom 2a, in a limited way. As a result, in the classroom 2a, the student terminal 20a₁ can get connected with the network 10 via the AP 22a. Meanwhile, the student terminal 20a₁ is restricted from getting connected to the outside of the communicable area 2a′ for the AP 22a, such as restricted from getting connected to the network 10 available in the classroom 2b.

The class management server 30 further stores, in the class information DB 35, information about the lessons covered in the classes as task information. For example, in language learning, the lesson of listening to a voice and then responding to that voice is often covered. In that case, at the time of listening to a voice, the method of responding to the listened voice is specified.

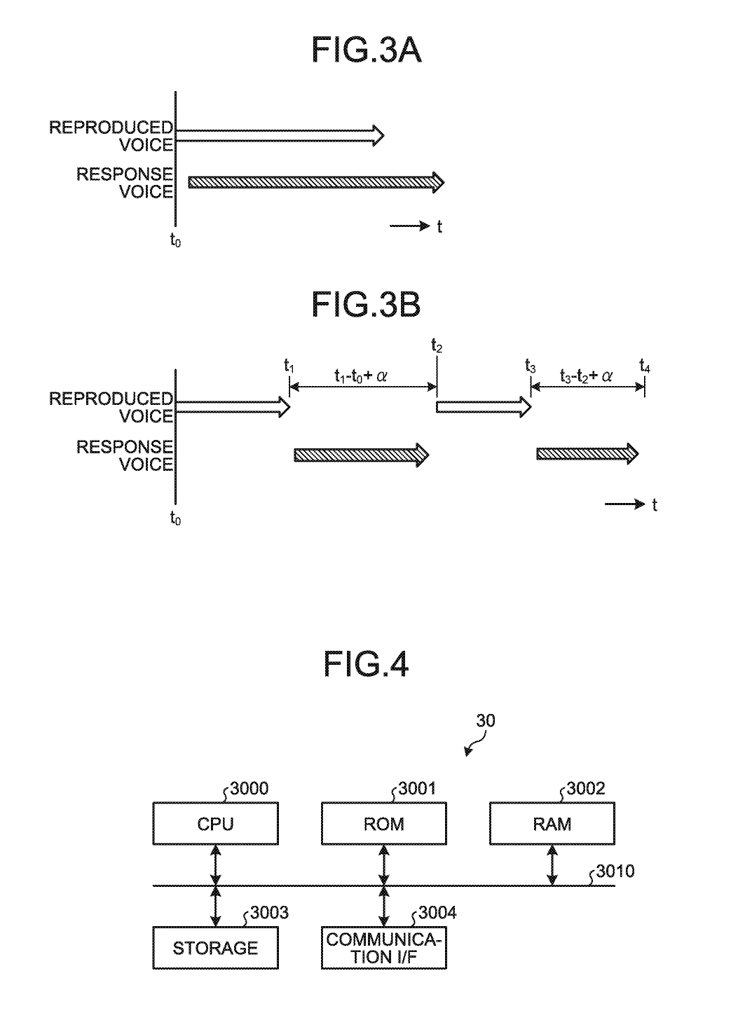

As an exemplary method of responding, as illustrated in FIG. 3A, it is possible to think of a method in which, while listening to a voice (a reproduced voice) that is continuously reproduced in a first language from a timing to, the contents of that voice are uttered, as a voice response to that voice, in the first language or in a second language. This method is called concurrent utterance. In that case, in a precise sense, the voice response neither starts at the same time as the reproduced voice nor ends at the same time as the reproduced voice.

As another example of the method of responding, as illustrated in FIG. 3B, it is possible to think of a method as follows: a voice in the first language is broken into predetermined units such as sentences, and intermittent voice reproduction is done in which, after the voice equivalent to a particular unit is reproduced, the voice equivalent to the next unit is reproduced after a certain period of time according to the length of the voice; and, in between the voice equivalent to the particular unit and the voice equivalent to the next unit, the contents of the former voice are uttered, as a voice response to that voice, in the first language or in a second language. This method is called shadowing.

In the example illustrated in FIG. 3B, in the reproduced voice, after a first voice having the length of a time period t₁−t₀ is reproduced, a second voice is reproduced after a time interval of t₁−t₀+α from the timing t₁. Herein, the time period α represents the margin with respect to the length of the reproduced voice. The time interval of t₁−t₀+α represents the time period specified for the purpose of uttering the voice response. In an identical manner, in the reproduced voice, after a second voice having the length of a time period t₃−t₂ is reproduced, a third voice is reproduced after a time interval obtained by adding the time period α to the time period t₃−t₂ from the timing t₃. Thus, immediately after the reproduced voice is reproduced, the period of time reflecting the adjustment amount of α in the reproduction period is provided as the response time for the students. Meanwhile, α need not be set only as a positive time period but can be set also as a negative time period.

In the concurrent utterance illustrated in FIG. 3A, the period of time obtained by multiplying a multiplying factor m to the entire time period of the reproduce voice can be set as the time limit for the voice response. More particularly, if tₜₒₜₐₗ represents the entire time period of the reproduced voice whose reproduction is started at the timing to, then the voice response is set to have the time limit of tₜₒₜₐₗ×M from the timing to. In that case, the time period extended by tₜₒₜₐₗ×M with respect to the time period tₜₒₜₐₗ represents the margin.

In Table 5 is illustrated a task information table that is stored in the class information DB 35. In the example illustrated in Table 5, the task information table is created on a class-by-class basis, and each task information table is identified by class identification information enabling identification of the concerned class. Each task information table includes a single set of class identification information and information of one or more lessons representing task information. A lesson includes presentation of a task by a teacher and a demand for a response to the presented task. In response to the demand for a response, a student generates a deliverable with respect to the lesson.

Each record in the task information table indicates the information of a single lesson and includes following items: “lesson name”, “task”, “response”, “necessity of submission”, “registration flag”, “public/private”, and “end flag”. Meanwhile in Table 5, each record starts with a serial number that enables identification of that record and that is assigned automatically, for example. Moreover, the item “lesson name” is used to store the name of the concerned lesson.

TABLE 5

| Class identification information | | | | | | | |
|---|---|---|---|---|---|---|---|
| (time-schedule, school hour, | | | | | | | |
| classroom) | | | | | | | |
| | | Task | | | | | |
| | | (contents | Response (user | | | | |
| | | information, | ID, response | | | | |
| Serial | Lesson | Response | data, | Necessity | Registration | Public/ | End |
| number | name | information) | evaluation) | of submission | flag | private | flag |
| #1 | Listening | Voice, | (seito- | Required | Currently | Private | Not |
| | comprehension | concurrent, | a@abc.def.ac, | | registering | | ended |
| | (***) | margin (xm) | oto.wav, 4), | | | | |
| | | | (seito- | | | | |
| | | | b@abc.def.ac, | | | | |
| | | | oto.wav, 3), | | | | |
| | | | . . . | | | | |
| #2 | Listening | Voice, | | Not | Registered | Public | Ended |
| | comprehension | shadow (±α) | | required | | | |
| | (∘∘∘) | | | | | | |
| #2 | Listening | Video, | | Required | Registered | Public | Not |
| | comprehension | concurrent, | | | | | ended |
| | (ΔΔΔ) | margin (xm) | | | | | |
| [symbol] | [symbol] | [symbol] | [symbol] | [symbol] | [symbol] | [symbol] | [symbol] |

In Table 5, the item “task” is used to store the information indicating the task in the concerned lesson. In this example, a task includes information about the contents used as the teaching material and includes response information indicating a demand for a response to those contents. The contents information is in the form of, for example, voices or videos. More particularly, it is possible to use information indicating the location of storage of voice data or video data to be presented as contents to the students. Moreover, a single item “task” can have a plurality of sets of contents information included therein. The response information for contents contains, as the details of the demand for a response, information demanding a response in the form of voice recording using either the concurrent utterance or the shadowing or information demanding a response in the form of text input. Thus, the students happen to give a response to the contents according to the method specified in the response information.

Meanwhile, the item “task” can also include the margin described earlier. In the case of concurrent utterance, the multiplying factor m represents the margin. In the case of shadowing, ±α represents the margin.

The item “response” is used to store information related to the response given by each student to the concerned task. In the example illustrated in Table 5, the item “response” includes the user ID of the student who gave a response, response data information indicating the data of response, and the evaluation of the teacher to the data of response. Herein, the item “response” can be used to store the response data information of each of a plurality of students who are taking the concerned class.

With reference to the example illustrated in FIGS. 3A and 3B, the data of responses is in the form of voice data; and, in this example, the file names of voice data are used as the response data information. Meanwhile, the data of responses is in accordance with the task and is not limited to be voice data. Alternatively, for example, text data can be used as the data of responses, or text data and voice data can be used together as the data of responses. The evaluation represents the information that is set by the teacher after checking the data of responses.

In Table 5, the item “necessity of submission” is used to store information (such as a flag) that indicates whether or not a student needs to submit response data with respect to the task. The item “registration flag” is used to store information indicating whether the registration status, in the class information DB 35, of the contents specified in the item “task” indicate: registered; currently registering; or not registered. The item “public/private” is used to store a state (such as a flag) indicating whether the concerned lesson is made public or kept private to the students participating in that class. The item “end flag” is used to store a flag indicating whether or not the concerned lesson has ended.

Returning to the explanation with reference to FIG. 2, the portal server 32 can be configured by implementing the existing captive portal technology. In the captive portal technology, at the time of using a network, an HTTP client (HTTP stands for HyperText Transfer Protocol) is obliged to view a particular website on the network. For example, any access to the information processing system by a user inside the school 1 or outside the school 1 is forcibly guided to the portal server 32 because of the captive portal technology.

The portal server 32 presents, for example, a login screen to the source device of access for enabling the input of login information (for example, a user ID and a password) with respect to the information processing system. The portal server 32 sends the login information, which has been input from the login screen, to the authentication server 31 and requests for authentication. If the authentication is successful, then the source device of access becomes able to access the intended access destination.

The network 10 is connected to Internet 50 via, for example, a firewall (FW) 37. Moreover, for example, the AP 22d that is installed in the home 5 of the student d is connected to the Internet 50. Thus, the student d can perform communication with the AP 22d using the terminal device 20d, and can get connected to the Internet 50. When the connection from the terminal device 20d is allowed by the FW 37, the terminal device 20d can get connected with the network 10 in the school 1 via the Internet 50 and the FW 37.

Meanwhile, with reference to FIGS. 1 and 2, although the explanation is given for a case in which the authentication server 31 belongs to the information processing system in the school 1, that is not the only possible case. Alternatively, for example, the authentication of users in the information processing system can also be performed using an external authentication service on the outside of the school 1. In that case, for example, the authentication server 31 receives account information of the user who is requesting for an access to the information processing system, sends the received account information to the external authentication service, and requests the external authentication service to perform authentication.

With reference to FIGS. 1 and 2, explained below in brief is the flow of a class based on the information processing system according to the embodiment. An administrator or a staff member sets connection information and stores it in the class information DB 35 illustrated in Table 4. Moreover, the administrator or the staff member stores the account information of each user in the account information table in the user DB 36 as illustrated in Table 1, and stores the role information of each user in the role information table in the user DB 36 as illustrated in Table 2. Furthermore, the administrator or the staff member sets the classes to be taken by the students a₁, a₂, . . . , b₁, b₂, . . . , c₁, c₂, . . . , and so on according to, for example, the demand of each student; and registers the setting in the class information DB 35.

Firstly, the staff member sets the class courses and the classes using, for example, the staff member PC 40, and sends the setting to the class management server 30. Then, the class management server 30 stores the setting about the class courses and the classes, which is sent by the staff member PC 40, in the class information table in the class information DB 35 illustrated in Table 3 and thus registers the class information.

The teacher PC 21 is installed with a browser application program (hereinafter, called a browser) that performs display and input control based on predetermined control information such as HTML data (which stands for HyperText Markup Language). When the browser runs in the teacher PC 21, for example, a user interface (hereinafter, called UI) can be created in the teacher PC 21 according to display control information supplied via the network 10.

A teacher (assumed to be the teacher A) accesses the class management server 30 from the teacher PC 21a. In response to the access, the class management server 30 sends display control information to the teacher PC 21a for the purpose of creating a predetermined UI. In the teacher PC 21a, the browser creates the UI in the teacher PC 21a according to the display control information. Thus, the transmission and reception of information between the teacher PC 21a and the class management server 30 is performed using the browser, for example.

The teacher A uses the teacher PC 21a and obtains, from the class management server 30, the class information of the class of which he or she is in charge; and makes preparations of the class based on the class information. For example, the teacher A uses the teacher PC 21a to set the tasks according to the class information, inputs information of each item, and sends the input information to the class management server 30. Moreover, the teacher A prepares contents as the teaching material in the teacher PC 21, and uploads the prepared contents from the teacher PC 21a to the class management server 30.

In the student terminals 20a₁, 20a₂, . . . , 20b₁, 20b₂, . . . , 20c₁, 20c₂, and so on used by the students a₁, a₂, . . . , b₁, b₂, . . . , c₁, c₂, and so on; a class application representing an information processing program is installed for enabling participation in the classes in the CALL system that is based on the information processing system according to the embodiment.

A student (assumed to be the student a₁) runs the class application in, for example, the student terminal 20a₁ and accesses the information processing system, which constitutes the CALL system in the school 1, via an arbitrary AP. The access from the student terminal 20a₁ is forcibly guided to the class management server 30, and the input of the login information is requested. The login information that is input in the student terminal 20a₁ in response to the request is sent from the student terminal 20a₁ to the class management server 30. Based on that login information and the account information, the class management server 30 confirms whether the student a₁ is a registered student. If the student a₁ is not registered in the class management server 30, then the login information is sent to the authentication server 31, and the authentication server 31 performs authentication. If the authentication based on the login information as performed by the authentication server 31 is successful, then the student terminal 20a₁ gets connected to the class management server 30. However, if the authentication is not successful, then an error is returned. Thus, not only the use of the information processing system can be restricted by allowing access only to the users in the school, but it also becomes possible to distinguish whether or not each user who accessed the information processing system is a student registered to take classes.

The class management server 30 sends, to the student terminal 20a₁, information about the list of classes available to the user whose user ID is included in the login information. The student terminal 20a₁ displays the list of classes sent from the class management server 30. The student a₁ selects the class to be taken next (assumed to be a class A) from the list of classes displayed in the student terminal 20a₁. Then, the student terminal 20a₁ sends the information indicating the selected class A to the class management server 30.

Based on the information indicating the class A as sent from the student terminal 20a₁, the class management server 30 refers to the class information table (Table 3) and the connection information table (Table 2) stored in the class information DB 35; identifies the classroom in which the class A will be conducted (assumed to be the classroom 2a); and obtains a single available IP address from the range of IP addresses assigned to the AP 22a installed in the identified classroom. Then, the class management server 30 sends the obtained IP address and the SSID of the AP 22a to the student terminal 20a₁. According to the IP address and the SSID as sent from the class management server 30, the student terminal 20a₁ establishes connection with the AP 22a. As a result, only within classroom 2a in which the class A is conducted, the student terminal 20a₁ becomes able to get connected to the information processing system of the school 1.

When the class A starts, the teacher A makes the concerned lesson public and sets the lesson to be in the obtainable state. The student a₁ uses the student terminal 20a₁ and obtains the contents, that is, a task and the response information of the lesson made public. Then, student a₁ performs the task using the student terminal 20a₁. For example, when the response information in the task indicates concurrent utterance, the student a₁ uses the student terminal 20a₁ and records his or her own utterance while reproducing the obtained contents. The recorded voice data is stored in the student terminal 20a₁. Herein, with respect to a single task, the student a₁ can record his or her own utterance for a plurality of number of times.

When the task is finished, the student a₁ can send the voice data recorded for the task as the deliverable with respect to the task to the class management server 30. Moreover, if the response information of the task demands for the response in the form of text information, then the text information can be edited and sent to the class management server 30. Subsequently, the class management server 30 stores, in the task information table illustrated in Table 5, the information indicating the voice data as sent from the student terminal 20a₁ as the deliverable with respect to the task.

After the class is finished or while the class is going on, the teacher A can access the class management server 30 using the teacher PC 21a and can check the voice data that is sent by the student a₁ from the student terminal 20a₁ as the deliverable with respect to the task. Moreover, the teacher A can offer evaluation to the deliverable. Furthermore, the student a₁ can get connected to the information processing system from, for example, his or her home so as to access the class management server 30; can check the voice data sent by himself or herself as the deliverable; and can revise the class.

In this way, in the information processing system according to the embodiment, the deliverable of the student a₁ gets stored in the class management server 30 in a corresponding manner to the task that demanded the response in the form of the deliverable. Hence, for example, the deliverable of each student who took the class A can be easily checked by the teacher A in a corresponding manner to the class A.

Detailed Explanation of Configuration Implementable in Embodiment

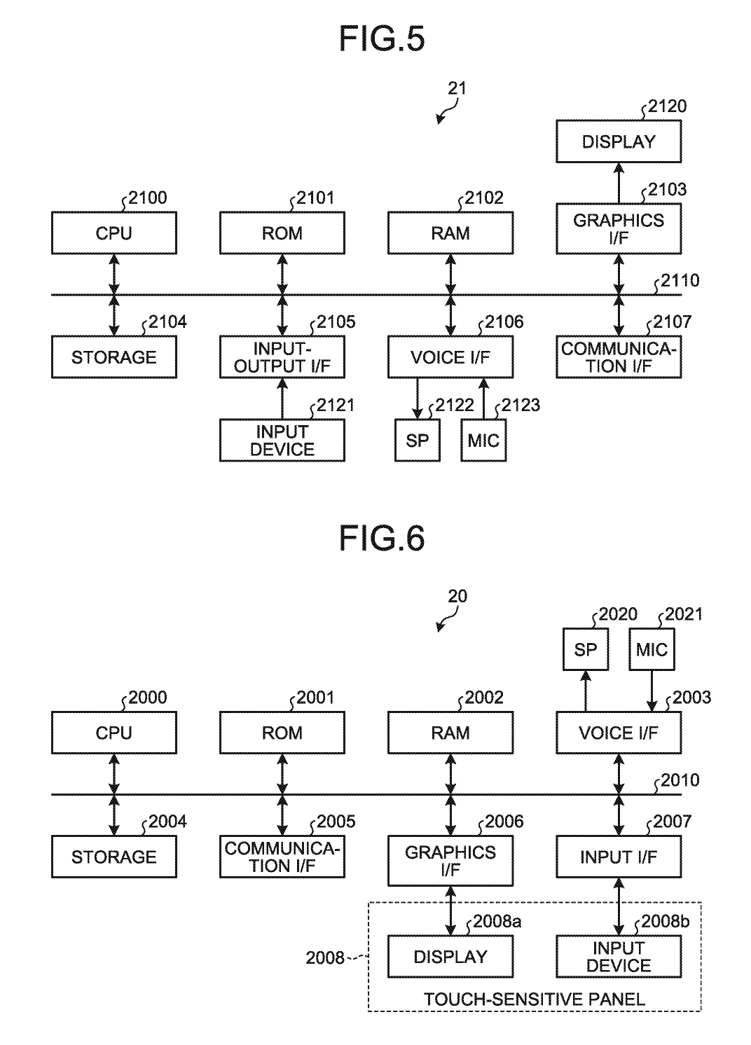

Given below is the detailed explanation of a configuration implementable in the embodiment. In FIG. 4 is illustrated an exemplary hardware configuration of the class management server 30 implementable in the embodiment. With reference to FIG. 4, the class management server 30 includes a central processing unit (CPU) 3000, a read only memory (ROM) 3001, a random access memory (3002), a storage 3003, and a communication interface (I/F) 3004 that are communicably connected to each other by a bus 3010.

The storage 3003 is a memory medium configured using a hard disk drive or a nonvolatile semiconductor memory. The CPU 3000 follows the instructions given in a computer program that is stored in advance in the storage 3003 or the ROM 3001, operates using the RAM 3002 as the work memory, and controls the overall operations of the class management server 30. The communication I/F 3004 follows the instructions from the CPU 3000 and controls the communication performed via the network 10.

In the example illustrated in FIG. 4, the storage 3003 is embedded in the class management server 30. However, that is not the only possible example. Alternatively, for example, the storage 3003 can be an external memory device connected to the class management server 30 either directly or via the network 10. Meanwhile, the class information DB 35 can be configured using a predetermined memory area in the storage 3003. However, that is not the only possible case. Alternatively, the class information DB 35 can be configured using an external memory device that is connected either directly or indirectly to the class management server 30.

The authentication server 31 and the portal server 32 implementable in the embodiment can have an identical configuration to the configuration of the class management server 30 illustrated in FIG. 4. Hence, that explanation is not repeated.

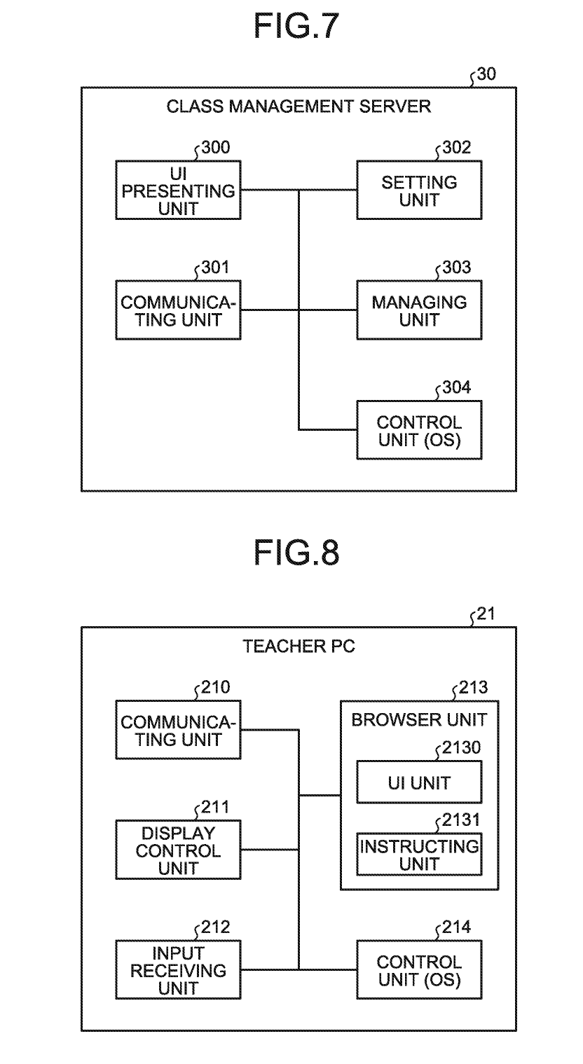

In FIG. 5 is illustrated an exemplary hardware configuration of the teacher PC 21 implementable in the embodiment. With reference to FIG. 5, the teacher PC 21 includes a CPU 2100, a ROM 2101, a RAM 2102, a graphics I/F 2103, a storage 2104, an input-output I/F 2105, a voice I/F 2106, and a communication I/F 2107 that are communicably connected to each other by a bus 2110.

The storage 2104 is a memory medium for storing data in a nonvolatile manner, and it is possible to use a hard disk drive or a flash memory. The storage 2104 is used to store the computer programs and the data meant for the operations of the CPU 2100.

The CPU 2100 follows the instructions given in a computer program that is stored in advance in, for example, the ROM 2101 or the storage 2104, operates using the RAM 2102 as the work memory, and controls the overall operations of the teacher PC 21. The graphics I/F 2103 generates display signals compatible to a display 2120 based on display control signals generated by the CPU 2100 according to the computer program. The display 2120 displays a screen according to the display signals supplied from the graphics I/F 2103.

The input-output I/F 2105 transmits data to and receives data from external devices. Herein, for example, a universal serial bus (USB) can be used as the input-output I/F 2105. In this example, an input device 2121 is connected to the input-output I/F 2105 for the purpose of receiving user input. Examples of the input device 2121 include a keyboard and a pointing device such as a mouse. The communication I/F 2107 follows instructions from the CPU 2100 and controls the wired communication or the wireless communication performed with the network 10.

The voice I/F 2106 has a speaker (SP) 2122 connected thereto for converting analog voice signals into voice and outputting the voice, and has a microphone (MIC) 2123 connected thereto for converting voice into electrical signals and outputting the electrical signals. For example, the voice I/F 2106 converts digital voice signals, which are provided from the CPU 2100 via the bus 2110, into analog voice signals; and can provide the analog voice signals to the speaker 2122. Moreover, the voice I/F 2106 converts the analog voice signals, which are output according to the voice picked up by the microphone 2123, into digital voice signals; and can send the digital voice signals to the CPU 2100 via the bus 2110. Meanwhile, regarding the speaker 2122 and the microphone 2123, the speaker 2122 can be headphones or earphones and can be combined with the microphone 2123 to configure a headphone set.

Meanwhile, the staff member PC 40 can have an identical configuration to the configuration of the teacher PC 21. Hence, that explanation is not repeated. However, the staff member PC 40 may not include the voice I/F 2106.

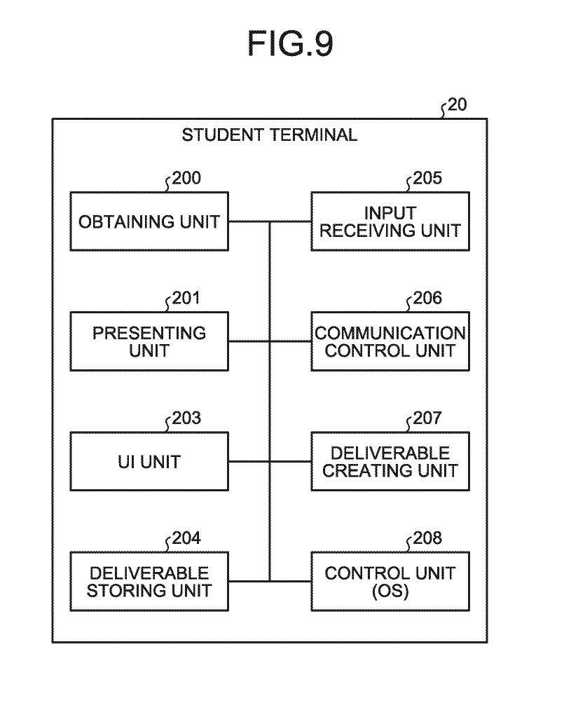

In FIG. 6 is illustrated an exemplary hardware configuration of the student terminal 20 implementable in the embodiment. With reference to FIG. 6, the student terminal 20 includes a CPU 2000, a ROM 2001, a RAM 2002, a voice I/F 2003, a storage 2004, a communication I/F 2005, a graphics I/F 2006, and an input I/F 2007 that are communicably connected to each other by a bus 2010. Thus, the student terminal 20 includes the CPU 2000, the ROM 2001, and the RAM 2002; and can be regarded as a computer.

The student terminal 20 further includes a display 2008a and an input device 2008b. The display 2008a and the input device 2008b are formed in an integrated manner and constitute what is called a touch-sensitive panel 2008. The input device 2008b is assumed to be capable of receiving the input via the touches of a finger.

The storage 2004 is configured using, for example, a nonvolatile semiconductor memory, and is used to store various computer programs and data meant for the operations of the CPU 2000. Meanwhile, it is also possible to use a hard disk drive as the storage 2004. The ROM 2001 is used to store, in advance, computer programs and data meant for the activation and the operations of, for example, the student terminal 20. The CPU 2000 follows the instructions given in the computer programs that are stored in the storage 2004 or the ROM 2001, operates using the RAM 2002 as the work memory, and controls the overall operations of the student terminal 20. The communication I/F 2005 follows the instructions from the CPU 2000, establishes connection with an access point (AP) using a wireless LAN, and controls the communication performed with the network 10 via the AP.

The graphics I/F 2006 converts display control signals, which are generated by the CPU 2000 according to the computer programs, into display signals compatible to the display 2008a and sends the display signals to the display 2008a.

The display 2008a includes, for example, a liquid crystal display (LCD) functioning as the display device, and includes a driving circuit for driving the display device according to display signals. The input I/F 2007 converts a signal, which is output from the input device 2008b in response to, for example, a touch operation with respect to the input device 2008b, into a control signal compatible to the CPU 2000; and outputs the control signal to the bus 2010.

The voice I/F 2003 has a speaker 2020 connected thereto for converting analog voice signals into voice and outputting the voice, and has a microphone 2021 connected thereto for converting voice into electrical signals and outputting the electrical signals. For example, the voice I/F 2003 converts digital voice signals, which are provided from the CPU 2000 via the bus 2010, into analog voice signals; and can provide the analog voice signals to the speaker 2020. Moreover, the voice I/F 2003 converts the analog voice signals, which are output according to the voice picked up by the microphone 2021, into digital voice signals, and can provide the digital voice signals to the CPU 2000 via the bus 2010. Meanwhile, regarding the speaker 2020 and the microphone 2021, the speaker 2020 can be headphones or earphones and can be combined with the microphone 2021 to configure a headphone set.

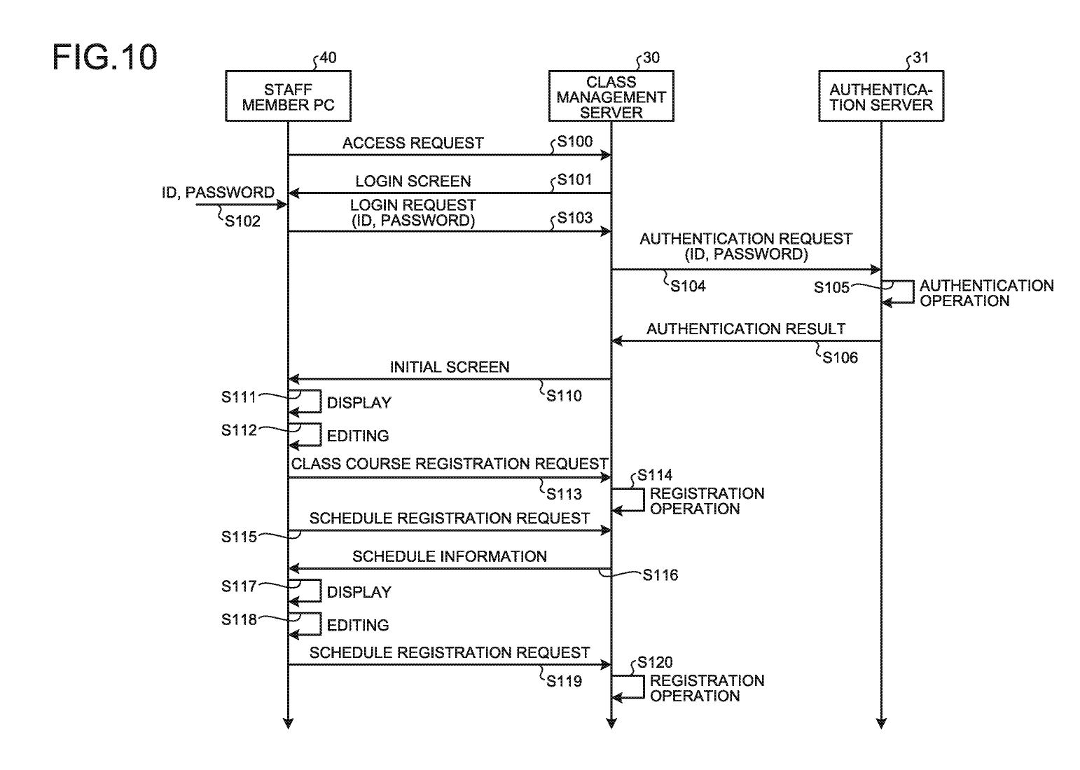

FIG. 7 is a functional block diagram for explaining an example of the functions of the class management server 30 according to the embodiment. With reference to FIG. 7, the class management server 30 includes a UI presenting unit 300, a communicating unit 301, a setting unit 302, a managing unit 303, and a control unit 304. The UI presenting unit 300, the communicating unit 301, the setting unit 302, the managing unit 303, and the control unit 304 are implemented using computer programs running in the CPU 3000. However, that is not the only possible case. Alternatively, some or all of the UI presenting unit 300, the communicating unit 301, the setting unit 302, the managing unit 303, and the control unit 304 can be configured using hardware circuits that operate in cooperation with each other.

The communicating unit 301 controls the communication I/F 3004 and performs communication via the network 10. The UI presenting unit 300 generates display control information, such as HTML data, meant for creating a predetermined UI in response to a request received from the communicating unit 301. Then, the communicating unit 301 sends the generated display control information to the device that issued the request (for example, the teacher PC 21) via the network 10, so that a UI is created in that device. The setting unit 302 sets task information according to the information input via the UI. Moreover, according to the information received via the network 10, the setting unit 302 also sets class information that is to be stored in the class information table illustrated in Table 3. The managing unit 303 manages the class information table and the task information table (Table 5) that are stored in the class information DB 35. For example, the managing unit 303 stores, in the class information DB 35, the task information and the class information set by the setting unit 302. Moreover, for example, in response to a request received via the network 10, the managing unit 303 refers to the class information DB 35 and extracts information.

The control unit 304 represents, for example, an operating system (OS) installed in the class management server 30, and controls the overall operations of the class management server 30.

Meanwhile, an information processing program meant for implementing the functions of the class management server 30 according to the embodiment is recorded as an installable file or an executable file in a computer-readable recording medium such as a compact disk (CD), a flexible disk (FD), or a digital versatile disk (DVD). However, that is not the only possible case. Alternatively, the information processing program can be stored in a downloadable manner in a computer connected to a network such as the Internet 50. Still alternatively, the information processing program can be distributed via a network such as the Internet 50.

The information processing program contains modules of the abovementioned constituent elements (the UI presenting unit 300, the communicating unit 301, the setting unit 302, and the managing unit 303). As far as the actual hardware is concerned, the CPU 3000 reads the information processing program from a memory medium such as the storage 3003 and executes it, so that the abovementioned constituent elements are loaded in a main memory device such as the RAM 3002; and the UI presenting unit 300, the communicating unit 301, the setting unit 302, and the managing unit 303 get generated in the main memory device.

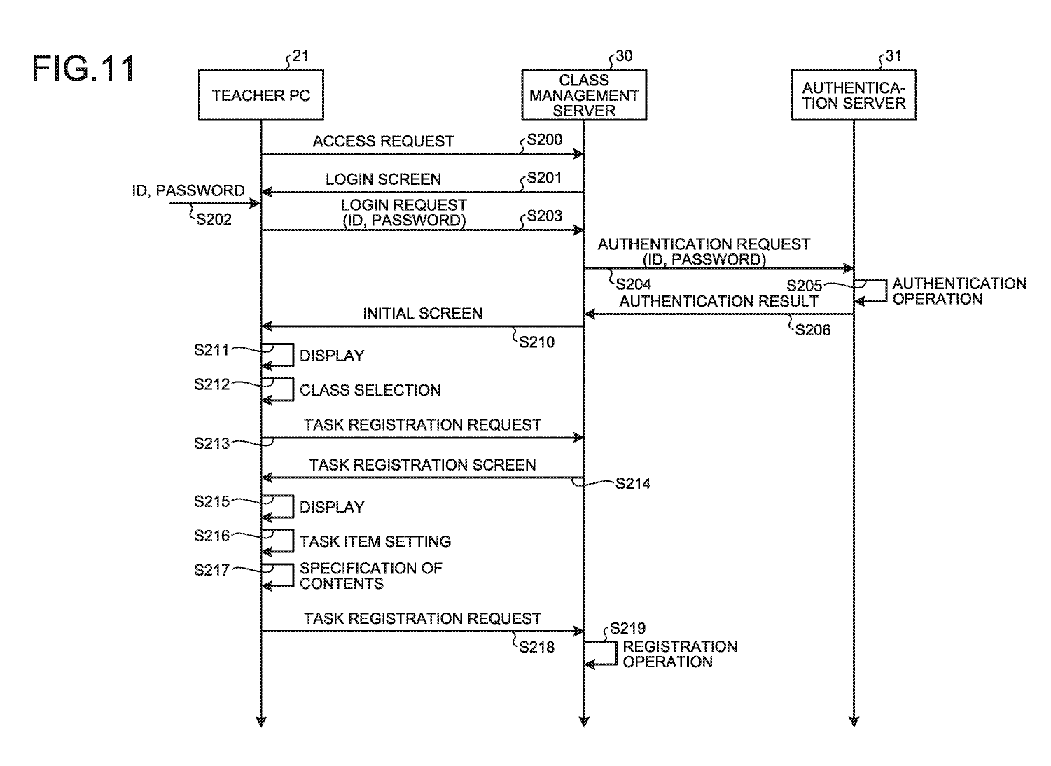

FIG. 8 is a functional block diagram for explaining an example of the functions of the teacher PC 21 according to the embodiment. With reference to FIG. 8, the teacher PC 21 includes a communicating unit 210, a display control unit 211, an input receiving unit 212, a browser unit 213, and a control unit 214. The communicating unit 210, the display control unit 211, the input receiving unit 212, the browser unit 213, and the control unit 214 are implemented using computer programs running in the CPU 2100. However, that is not the only possible case. Alternatively, some or all of the communicating unit 210, the display control unit 211, the input receiving unit 212, the browser unit 213, and the control unit 214 can be configured using hardware circuits that operate in cooperation with each other.

The communicating unit 210 controls the communication I/F 2107 and performs communication via the network 10. The display control unit 211 generates a display control signal according to, for example, screen information, and sends the display control signal to the graphics I/F 2103. The input receiving unit 212 receives input information corresponding to an operation performed with respect to the input device 2121.

The browser unit 213 is created when a browser application program is run in the CPU 2100. As far as the browser unit 213 is concerned, it is possible to use a commonly-used browser application program such as the Internet Explorer (registered trademark) or Safari (registered trademark). The browser unit 213 includes a UI unit 2130 and an instructing unit 2131. The UI unit 2130 creates a UI according to the display control information such as HTML data; and sends screen information, which is meant for displaying a UI screen based on the created UI, to the display control unit 211. Moreover, the UI unit 2130 receives input information, which is received according to the UI screen, from the input receiving unit 212. The instructing unit 2131 issues an instruction to the control unit 214 according to the input information sent from the input receiving unit 212 to the UI unit 2130.

The control unit 214 represents, for example, an OS that controls the overall operations of the teacher PC 21. The functions of the communicating unit 210, the display control unit 211, and the input receiving unit 212 can be included in the functions of the control unit 214.

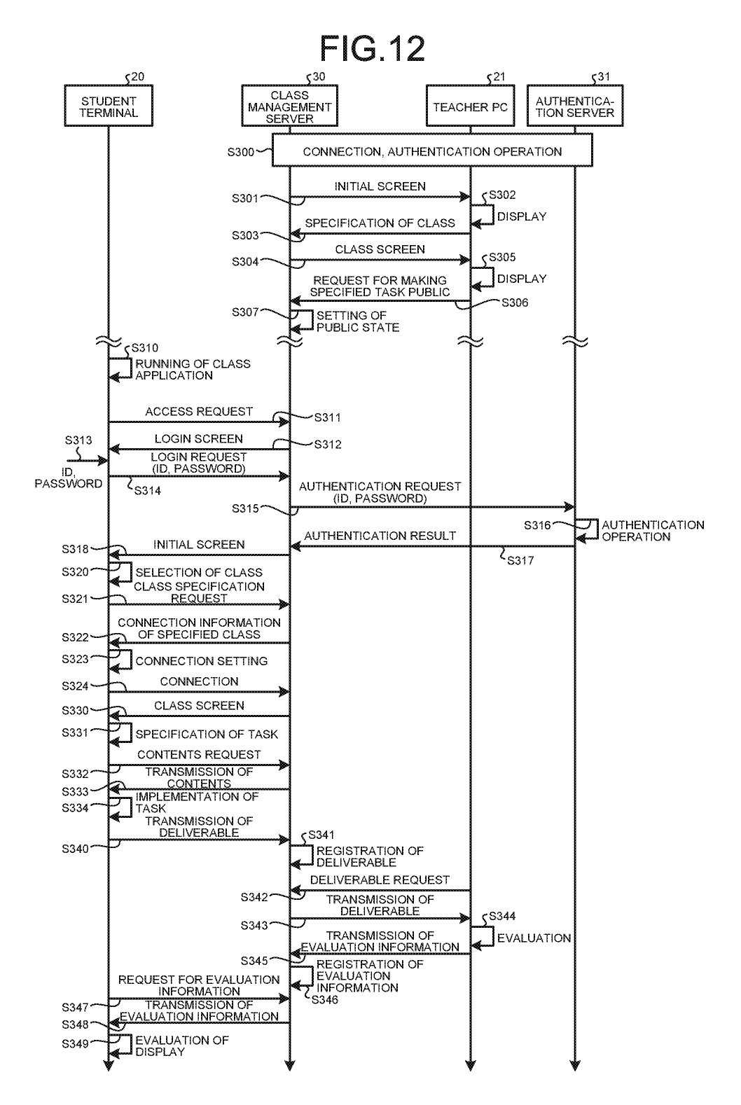

FIG. 9 is a functional block diagram for explaining an example of the functions of the student terminal 20 according to the embodiment. With reference to FIG. 9, the student terminal 20 includes an obtaining unit 200, a presenting unit 201, a UI unit 203, a deliverable storing unit 204, an input receiving unit 205, a communication control unit 206, a deliverable creating unit 207, and a control unit 208. The obtaining unit 200, the presenting unit 201, the UI unit 203, the deliverable storing unit 204, the input receiving unit 205, the communication control unit 206, the deliverable creating unit 207, and the control unit 208 are implemented using computer programs running in the CPU 2000. However, that is not the only possible case. Alternatively, some or all of the obtaining unit 200, the presenting unit 201, the UI unit 203, the deliverable storing unit 204, the input receiving unit 205, the communication control unit 206, the deliverable creating unit 207, and the control unit 208 can be configured using hardware circuits that operate in cooperation with each other.

The input receiving unit 205 receives input information corresponding to an operation performed with respect to the input device 2008b. The communication control unit 206 controls the communication I/F 2005 and performs communication via an access point of the wireless LAN. The control unit 208 represents, for example, an OS that controls the overall operations of the student terminal 20.

The obtaining unit 200 obtains task information from the class management server 30. The presenting unit 201 presents the task information that was obtained by the obtaining unit 200. For example, when the task information contains voice data and video data, the presenting unit 201 controls the reproduction of the voice data and the video data, and presents the task information.

The UI unit 203 generates display information meant for displaying a screen on the display 2008a, and sends the display information to the graphics I/F 2006. Moreover, the UI unit 203 performs operations according to the input information that is received by the input receiving unit 205 according to the screen displayed on the display 2008a by the UI unit 203. Furthermore, the UI unit 203 creates a controller meant for controlling voice recording and reproduction of voice data.

The deliverable creating unit 207 generates a deliverable according to the response information included in the task information obtained by the obtaining unit 200. For example, when the response information included in the task information is either concurrent utterance or shadowing, the deliverable creating unit 207 controls reproduction and voice recording of the voice data, which is included in the task information, according to a user operation of the controller created by the UI unit 203. Moreover, for example, when the task information contains video data; the deliverable creating unit 207 controls the reproduction of the video data according to a user operation of the controller.

The deliverable storing unit 204 controls the storing and the reading of the deliverable generated by the deliverable creating unit 207. For example, the deliverable storing unit 204 controls the storing of the deliverable in the storage 2004, and controls the reading of the stored deliverable from the storage 2004.

An information processing program meant for implementing the functions of the student terminal 20 according to the embodiment, that is, particularly implementing the functions of the obtaining unit 200, the presenting unit 201, the UI unit 203, the deliverable storing unit 204, and the deliverable creating unit 207 is recorded as an installable file or an executable file in a computer-readable recording medium such as a compact disk (CD), a flexible disk (FD), or a digital versatile disk (DVD). However, that is not the only possible case. Alternatively, the information processing program can be stored in a downloadable manner in a computer connected to a network such as the Internet 50. Still alternatively, the information processing program can be distributed via a network such as the Internet 50.

The information processing program contains modules of the abovementioned constituent elements (the obtaining unit 200, the presenting unit 201, the UI unit 203, the deliverable storing unit 204, and the deliverable creating unit 207). As far as the actual hardware is concerned, the CPU 2000 reads the information processing program from a memory medium such as the storage 2004 and executes it, so that the abovementioned constituent elements are loaded in a main memory device such as the RAM 2002; and the obtaining unit 200, the presenting unit 201, the UI unit 203, the deliverable storing unit 204, and the deliverable creating unit 207 get generated in the main memory device.

Specific Example of Operations in Information Processing System According to Embodiment

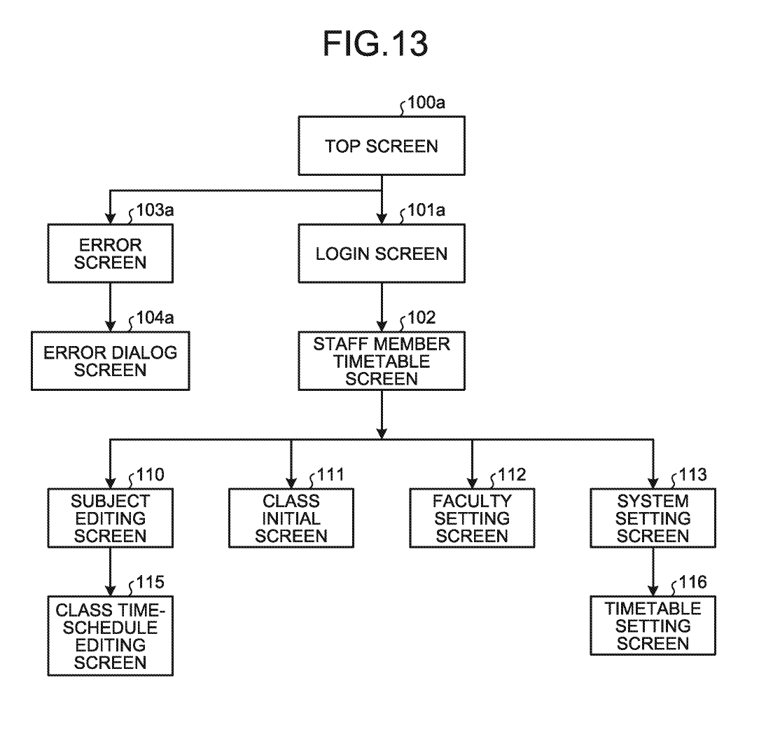

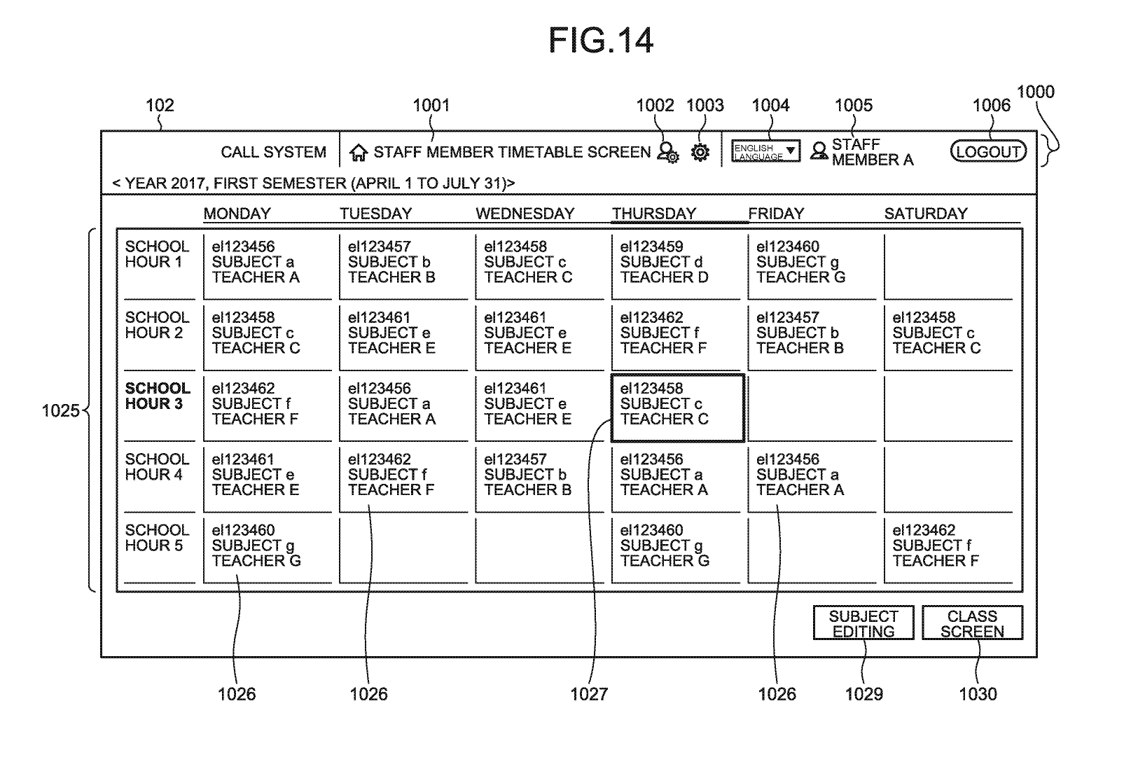

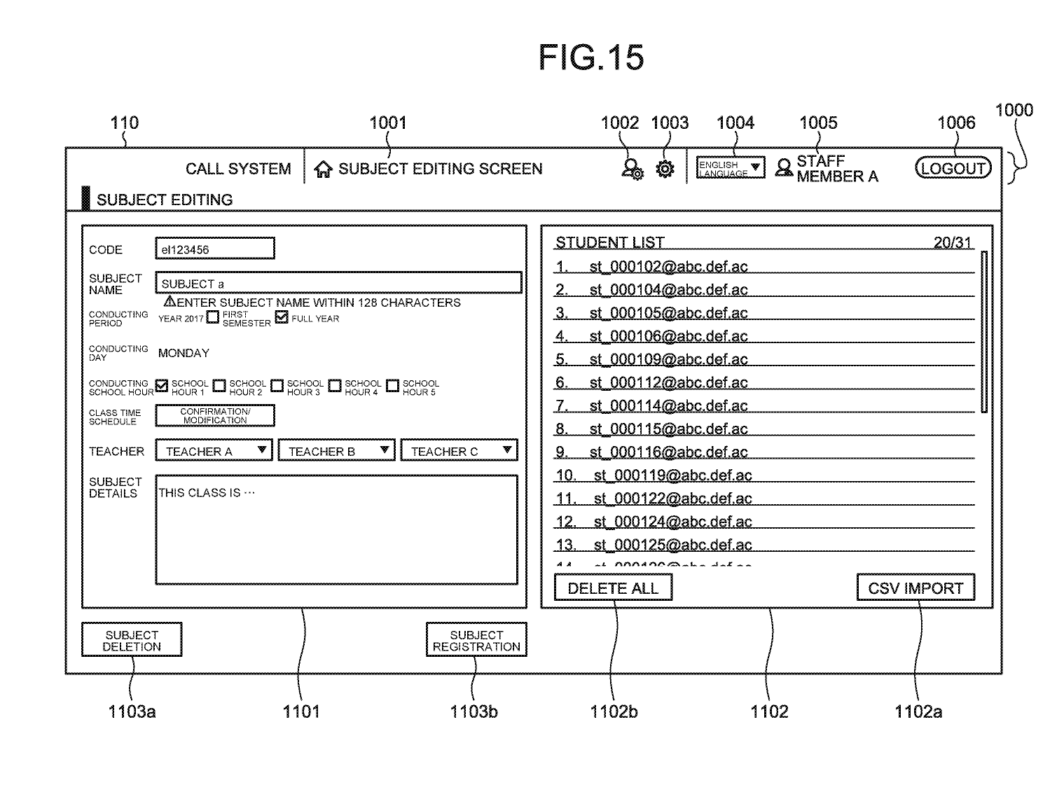

With reference to sequence diagrams illustrated in FIGS. 10 to 12, the operations performed in the information processing system according to the embodiment are explained in a more specific manner. In FIG. 10 is illustrated an example of a class course registration operation performed by a staff member; in FIG. 11 is illustrated an example of a class setting operation performed by a teacher; and in FIG. 12 is illustrated an example of operations performed in a class in which a teacher and students participate.

In the following explanation, each of the students a₁, a₂, . . . , b₁, b₂, . . . , c₁, c₂, and so on along with the student d (described later) are sometimes simply referred to as students. Moreover, since the student terminals 20a₁, 20a₂, . . . , 20b₁, 20b₂, . . . , 20c₁, 20c₂, and so on can have an identical configuration, they are referred to as the student terminals 20. Furthermore, since the teacher PCs 21a, 21b, and 21c can have an identical configuration, they are referred to as the teacher PCs 21. Moreover, since the APs 22a, 22b, and 22c can have an identical configuration, they are referred to as the APs 22.

With reference to FIGS. 10 to 12, the constituent elements identical to those illustrated in FIGS. 1 and 2 are referred to by the same reference numerals, and the detailed explanation thereof is not repeated. Meanwhile, prior to the implementation of the operations according to the sequence diagrams illustrated in FIGS. 10 to 12, as described earlier, it is assumed that connection information is stored in advance in the connection information table in the class information DB 35 illustrated in Table 4; account information of each user is stored in advance in the account information table in the user DB 36 illustrated in Table 1; and role information of each user is stored in advance in the role information table in the user DB 36 illustrated in Table 1. Moreover, a class taken by the students a₁, a₂, . . . , b₁, b₂, . . . , c₁, c₂, . . . , and so on is not limited to a class in a CALL classroom, and is assumed to have been set in advance with the setting registered in the class information DB 35.

FIG. 10 is a sequence diagram illustrating an example of a class course registration operation performed by a staff member in the information processing system according to the embodiment. The staff member uses the staff member PC 40 and requests for an access to the class management server 30 (Step S100). For example, the staff member activates a browser in the staff member PC 40 and, from the browser, requests for an access to the class management server 30. In response to the access request issued from the staff member PC 40, the class management server 30 sends a login screen to the staff member PC 40 (Step S101). According to the login screen displayed on the staff member PC 40, the staff member inputs login information (a user ID and a password) in the staff member PC 40 (Step S102), sends the login information to the class management server 30, and issues a login request (Step S103).

In response to the login request received from the staff member PC 40, the class management server 30 sends the login information to the authentication server 31 and issues an authentication request (Step S104). In response to the authentication request, the authentication server 31 performs authentication by referring to the user DB 36 based on the login information sent by the class management server 30 (Step S105). Then, the authentication server 31 sends the authentication result to the class management server 30 (Step S106).

If the authentication result sent by the authentication server 31 indicates that the authentication is successful, then the class management server 30 sends an initial screen to the staff member PC 40 (Step S110). On the other hand, if the authentication result indicates that the authentication is not successful, then the class management server 30 presents, for example, an error message to the staff member PC 40.

The staff member PC 40 displays the initial screen sent by the class management server 30 (Step S111) and receives editing according to the displayed initial screen (Step S112). Herein, in response to a user operation, the staff member PC 40 can request the class management server 30 for various screens meant for editing of the specified items. Moreover, in response to a user operation, the staff member PC 40 can also request, for confirmation purposes, for screens to be used in the classes included in the class course.

Then, the staff member inputs setting information of the class course according to various screens starting from the initial screen displayed on the staff member PC 40. Moreover, the role of the staff member is known from the authentication result, and the staff member is granted rights to register class courses using the screens. Herein, only a user having the role of a staff member or an administrator can perform registration of class courses. In response to a predetermined user operation thereof, the staff member PC 40 sends the input setting information to the class management server 30 and requests the class management server 30 to register the class course (Step S113). In response to that request, based on the setting information sent by the staff member PC 40, the class management server 30 stores information in the items of the class information table illustrated in Table 3 and performs a registration operation for registering the class course (Step S114).

Using the staff member PC 40, the staff member can request the class management server 30 to register the schedule of the class course that has been registered in the class information table illustrated in Table 3 (Step S115). For example, the staff member uses the staff member PC 40 and requests the class management server 30 to change or correct the schedule of the registered class course. In response to that request, based on the class information table illustrated in Table 3, the class management server 30 sends the information about the schedule of the class course to the staff member PC 40 (Step S116).

The staff member PC 40 displays the schedule information sent from the class management server 30 (Step S117) and receives editing with respect to the displayed schedule information (Step S118). When the editing of the schedule information is finished, the staff member PC 40 sends the edited schedule information to the class management server 30 and requests the class management server 30 to register the schedule (Step S119). In response to the request, based on the schedule information sent from the staff member PC 40, the class management server 30 updates the information in the class information table illustrated in Table 3 and registers the edited schedule information (Step S120).

Meanwhile, the operations from Step S115 onward are performed as may be necessary using the staff member PC 40.

FIG. 11 is a sequence diagram illustrating an example of a class setting operation performed by a teacher in the information processing system according to the embodiment. The teacher activates a browser in, for example, the teacher PC 21 and requests for an access to the class management server 30 from the browser (Step S200). In response to the access request from the teacher PC 21, the class management server 30 presents a login screen to the teacher PC 21 (Step S201). According to the login screen displayed on the teacher PC 21, the teacher inputs login information (a user ID and a password) in the teacher PC 21 (Step S202), and issues a login request (Step S203).

In response to the login request received from the teacher PC 21, the class management server 30 sends the login information to the authentication server 31 and issues an authentication request (Step S204). In response to the authentication request, the authentication server 31 performs authentication by referring to the user DB 36 based on the login information sent by the class management server 30 (Step S205). The authentication operation includes, for example, the confirmation of existence of the user having the concerned user ID and the confirmation of the role of that user. Then, the authentication server 31 sends, to the class management server 30, the authentication result and the user ID for which authentication was performed (Step S206).

If the authentication result sent by the authentication server 31 indicates that the authentication is successful, then the class management server 30 sends an initial screen to the teacher PC 21 based on the user ID (Step S210). On the other hand, if the authentication result indicates that the authentication is not successful, then the class management server 30 presents, for example, an error message to the teacher PC 21.

In the teacher PC 21, the browser displays the initial screen presented by the class management server 30 (Step S211). The initial screen includes, for example, a list of classes that the teacher is in charge of. In the initial screen displayed by the browser in the teacher PC 21, the teacher selects a class for which tasks are to be registered (Step S212). Then, the teacher PC 21 sends the information indicating the selecting class to the class management server 30 and requests the class management server 30 to register the tasks related to that class (Step S213).

In response to the request from the teacher PC 21, the class management server 30 presents a screen for registration of tasks to the teacher PC 21 (Step S214). In the teacher PC 21, the browser displays the task registration screen presented by the class management server 30 (Step S215). The teacher sets the items of each task according to the task registration screen displayed by the browser in the teacher PC 21 (Step S216). Moreover, the teacher specifies the contents (such as voice data or video data) to be used in the tasks (Step S217). The contents can be specified using, for example, a file selection screen that is typically included in the OS (the control unit 214) of the teacher PC 21.

When the setting of the items including the contents of the task is finished, the teacher sends the information about the set items and contents to the class management server 30 and requests the class management server 30 to register the task (Step S218). In response to the task registration request received from the teacher PC 21, the class management server 30 stores, in the task information table illustrated in Table 5, the information about the items and the information indicating the contents of the task sent by the teacher PC 21 and performs a task registration operation (Step S219). Moreover, the class management server 30 stores the contents, which are sent by the teacher PC 21, in, for example, the class information DB 35 in a corresponding manner to the information indicating the contents.

Meanwhile, for example, at Step S216, in response to a user operation, the teacher PC 21 can request the class management server 30 for a screen meant for the registration of the specified items. Moreover, in response to a user operation, the teacher PC can request the class management server 30 for a screen meant for checking the items of the set task or checking the selected contents.

FIG. 12 is a sequence diagram illustrating an example of operations performed by a teacher and students during a class in the information processing system according to the embodiment. At Step S300, the teacher (assumed to be the teacher A) activates a browser in the teacher PC 21; performs an authentication operation by performing identical operations to the operations at Steps S200 to S206 illustrated in FIG. 11; and accesses the class management server 30.

Once the teacher is successfully authenticated, the class management server 30 presents the initial screen to the teacher PC 21 (Step S301). In this case, the initial screen is meant for specifying the class to be started and, for example, represents a timetable screen in which the classes that the teacher is in charge of are selectively displayed. In the teacher PC 21, the initial screen is displayed by the browser (Step S302).

Based on the initial screen displayed in the teacher PC 21, the teacher specifies the class to be started and sends information indicating the specified class to the class management server 30 (Step S303). According to the information sent from the teacher PC 21, the class management server 30 presents a class screen of the specified class to the teacher PC 21 (Step S304). In the teacher PC 21, the browser displays the class screen presented by the class management server (Step S305). For example, as the class starts, the teacher requests the class management server 30 to make the lesson, which corresponds to the task taken up in the class, public (Step S306). In response to that request, the class management server 30 refers to the task information table illustrated in Table 5, and sets a value indicating the public state in the item “public/private” of the concerned lesson (Step S307).

A student taking the concerned class firstly runs the class application using his or her own student terminal 20 (Step S310). Herein, it is assumed that the class application is already installed in the student terminal 20. Using the class application, the student requests an access to the class management server 30 (Step S311). At this stage, it is assumed that the student terminal 20 gets connected to the network 10 of the school 1 from an arbitrary access point. In response to the access request received from the student terminal 20, the class management server 30 presents a login screen to the student terminal 20 (Step S312).

In the student terminal 20, the login screen is displayed by the class application. According to the login screen displayed in the student terminal 20, the student inputs login information (a user ID and a password) in the student terminal 20 (Step S313). Then, in the student terminal 20, the class application sends the login information to the class management server 30 and issues a login request (Step S314).

In response to the login request received from the student terminal 20, the class management server 30 determines whether or not the user ID specified in the received login information is registered as a student for taking classes. If the user ID is not registered, then the class management server 30 sends the login information to the authentication server 31 and issues an authentication request (Step S315). In response to the authentication request, the authentication server 31 refers to the user DB 36 based on the login information sent from the class management server 30, and performs an authentication operation (Step S316). Then, the authentication server 31 sends the authentication result to the class management server 30 (Step S317).

When the user ID is registered as a student for taking classes or when the authentication result sent by the authentication server 31 indicates that the authentication is successful, the class management server 30 presents an initial screen to the student terminal 20 based on the user ID (Step S318). In the initial screen, for example, a list of classes to be taken by the student on that day is displayed. The student operates the student terminal 20 and selects a class to be taken from among the listed classes (Step S320). The student terminal 20 sends information indicating the selected class to the class management server 30, and requests the class management server 30 to specify the classroom for taking that class (Step S321).

In response to the classroom specification request sent from the student terminal 20, the class management server 30 refers to the task information table, which is illustrated in Table 5, based on the information indicating the class and identifies the classroom in which the student has to take the class. Moreover, the class management server 30 further refers to the connection information table illustrated in Table 4 and obtains connection information enabling establishment of connection with the access point (assumed to be the AP 22a) in the identified classroom (assumed to be the classroom 2a). That is, from the connection information table, the class management server 30 obtains, as connection information, the value of the item “SSID of AP”, a single available IP address in the item “IP address range of AP”, and the value of the item “password” corresponding to the classroom 2a. Then, the class management server 30 sends the obtained connection information to the student terminal 20 (Step S322).

In the student terminal 20, the class application performs connection setting of the student terminal 20 according to the connection information sent by the class management server 30 (Step S323). After the connection setting is done, the student terminal 20 becomes able to get connected to the network 10 in a limited way only from the location of installation of the access point specified in the connection information.

Meanwhile, the class application can cancel the connection setting according to time. For example, when a predetermined period of time elapses since the establishment of connection, the class application cancels the connection setting. However, that is not the only possible case, and the class application can cancel the connection setting according to a particular timing. For example, the class application sets a margin of a predetermined period of time (for example, 10 minutes) with respect to the end timing of the time slot (school hour) set for the class, and accordingly cancels the connection setting.

The student carries the student terminal 20 to the classroom in which the class is going to be conducted. As a result, a connection operation is performed between the student terminal 20 and the AP 22a that is installed in the classroom 2a, and connection gets established therebetween (Step S324). When connection is established between the student terminal 20 and the AP 22a, it becomes possible to establish connection between the student terminal 20 and the class management server 30 via the AP 22a and the network 10.

Upon getting connected with the student terminal 20, the class management server 30 presents a class screen to the student terminal 20 (Step S330). In the student terminal 20, the class application displays the class screen presented by the class management server 30. Herein, the class screen is assumed to include a plurality of tasks. According to the class screen displayed in the student terminal 20, the student specifies the task to be carried out (Step S331). In the student terminal 20, the class application sends information indicating the specified task to the class management server 30, and requests the class management server 30 for the contents to be used in that task (Step S332).

In response to the request received from the student terminal 20, the class management server 30 refers to the task information table, which is illustrated in Table 5, based on the information indicating the task sent by the student terminal 20; obtains information about the contents to be used in that task; and obtains the contents (for example, voice data or video data) based on the information about the obtained contents. Then, the class management server 30 sends the obtained contents to the student terminal 20 (Step S333).

However, that is not the only possible case. That is, instead of sending the actual contents, the class management server 30 can send information indicating the location of the contents to the student terminal 20. In the student terminal 20, the class application obtains the contents based on the information indicating the location of the contents.

In the student terminal 20, the student carries out the task using the class application (Step S334). For example, if “concurrent utterance during reproduction of video data” represents the task, then the student uses the class application in the student terminal 20 to reproduce the contents obtained as video data from the class management server 30 and to record his or her utterances. When the task is finished, the student uses the class application in the student terminal 20 and sends voice data, which is obtained by recording his or her own utterances, as the deliverable with respect to the task to the class management server 30 (Step S340). The class management server 30 stores, in the task information table illustrated in Table 5, either the deliverable sent by the student terminal 20 or information indicating that deliverable (Step S341).

After the class is over or during the class, the teacher can offer evaluation to the deliverable received from the student terminal 20. For example, the teacher uses the teacher PC 21 and requests the class management server 30 for the deliverable of the student (Step S342). In response to the request, the class management server 30 refers to the task information table illustrated in Table 5 and identifies the deliverable of the student. Then, the class management server 30 sends the identified deliverable of the student to the teacher PC 21 (Step S343).

For example, in response to the request for the deliverable as issued by the teacher PC 21; the class management server 30 can present, to the teacher PC 21, a screen in which the deliverables submitted during the class conducted by the teacher are listed in a corresponding manner to the students who submitted the deliverables. From the displayed list of deliverables and the students, the teacher selects the desired deliverable using the browser in the teacher PC 21 and requests the class management server 30 for the selected deliverable. Then, the class management server 30 sends the deliverable, which is requested by the teacher PC 21, to the teacher PC 21. As a result, the teacher can easily obtain the deliverable of the desired student.

Then, the teacher offers evaluation to the deliverable of the student as sent by the class management server 30 (Step S344). For example, when the deliverable includes voice data recorded by the student, the teacher reproduces the deliverable using the browser in the teacher PC 21 and sets an evaluation value to the deliverable according to the reproduced voice. For example, the evaluation value can be a value from a five-grade evaluation. Meanwhile, a comment representing text information can also be appended as part of the evaluation. In the teacher PC 21, the browser displays the evaluation value that is set. If a comment is appended as part of the evaluation, then that comment also gets displayed.

In the teacher PC 21, when the teacher sets the evaluation value with respect to the deliverable, the browser sends evaluation information, such as the evaluation value indicating the result of evaluation, to the class management server 30 in a corresponding manner to the information (such as the user ID) indicating the student (Step S345). The class management server 30 stores the evaluation information, which is sent by the teacher PC 21, by adding it to the response data corresponding to the user ID and the lesson in the item “response” in the task information table illustrated in Table 5, and thus registers the evaluation information (Step S346).

During the class or after the class is finished, the student can check the evaluation offered to the deliverable submitted by him or her. For example, during the class, the student uses the student terminal 20 to send the user ID along with the information enabling identification of the class and the lesson to the class management server 30, and requests the class management server 30 for evaluation information (Step S347). In response to the request for evaluation information, the class management server 30 refers to the task information table in Table 5 based on the user ID and the identification information about the class and the lesson as sent by the student terminal 20, and obtains the evaluation information of the deliverable corresponding to the user ID and the class. Then, the class management server 30 sends the obtained evaluation information to the student terminal 20 (Step S348). Moreover, the class management server 30 can also send the actual evaluated material along with the evaluation information. In the student terminal 20, the browser displays the evaluation information, which is sent by the class management server 30, in a corresponding manner to the class and the lesson (Step S349). As a result of that display, the student can check the evaluation offered to the deliverable submitted by him or her, and can also revise the class.

Specific Example of Screen Display According to the Embodiment

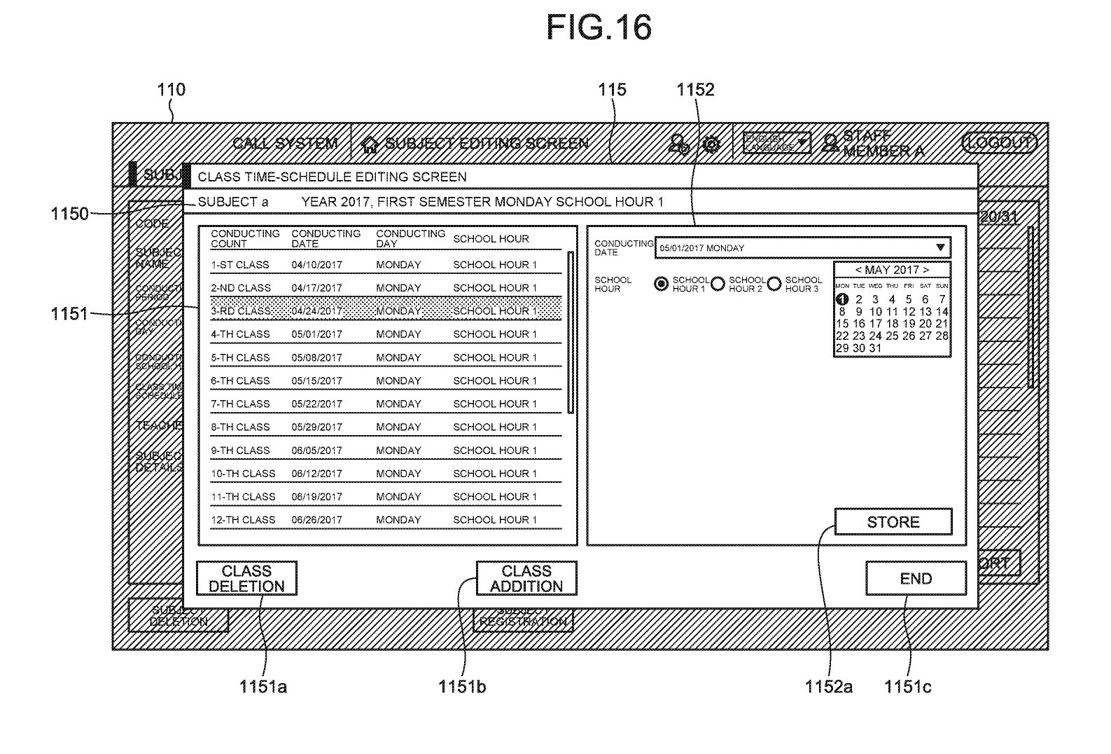

Explained below with reference to a specific example is the screen display performed in the staff member PC 40, the teacher PC 21, and the student terminal 20 according to the embodiment. In FIG. 13 is illustrated an example of screen transition in the staff member PC 40.

With reference to FIG. 13, for example, when an access request is issued from the staff member PC 40 to the class management server 30 at Step S100 illustrated in FIG. 10, a top screen 100a is the initially-displayed screen displayed by the portal server 32. Then, the screen of the staff member PC 40 changes from the top screen 100a to a login screen 101a. In the login screen 101a, an input area is provided for inputting the login information (a user ID and a password), and a button is provided for sending a login request. As explained with reference to Steps S102 to S106 in FIG. 10, after the login information is input in and sent from the login screen 101a and, when the authentication is successful, a staff member timetable screen 102 is displayed as the initial screen in the staff member PC 40 (Steps S110 and S111 illustrated in FIG. 10).

Meanwhile, if the access from the top screen 100a to the login screen 101a is not successful for some reason, then the screen display in the staff member PC 40 changes to an error screen 103a in which a system error message is displayed; and, for example, after a predetermined period of time thereafter, the screen display changes to an error dialog screen 104a as a notification of occurrence of an error.

The screen of the staff member PC 40 can change from the staff member timetable screen 102 to a subject editing screen 110, a class initial screen 111, a faculty setting screen 112, or a system setting screen 113. Moreover, the subject editing screen 110 can change to a class time-schedule editing screen 115; while the system setting screen 113 can change to a timetable setting screen 116.

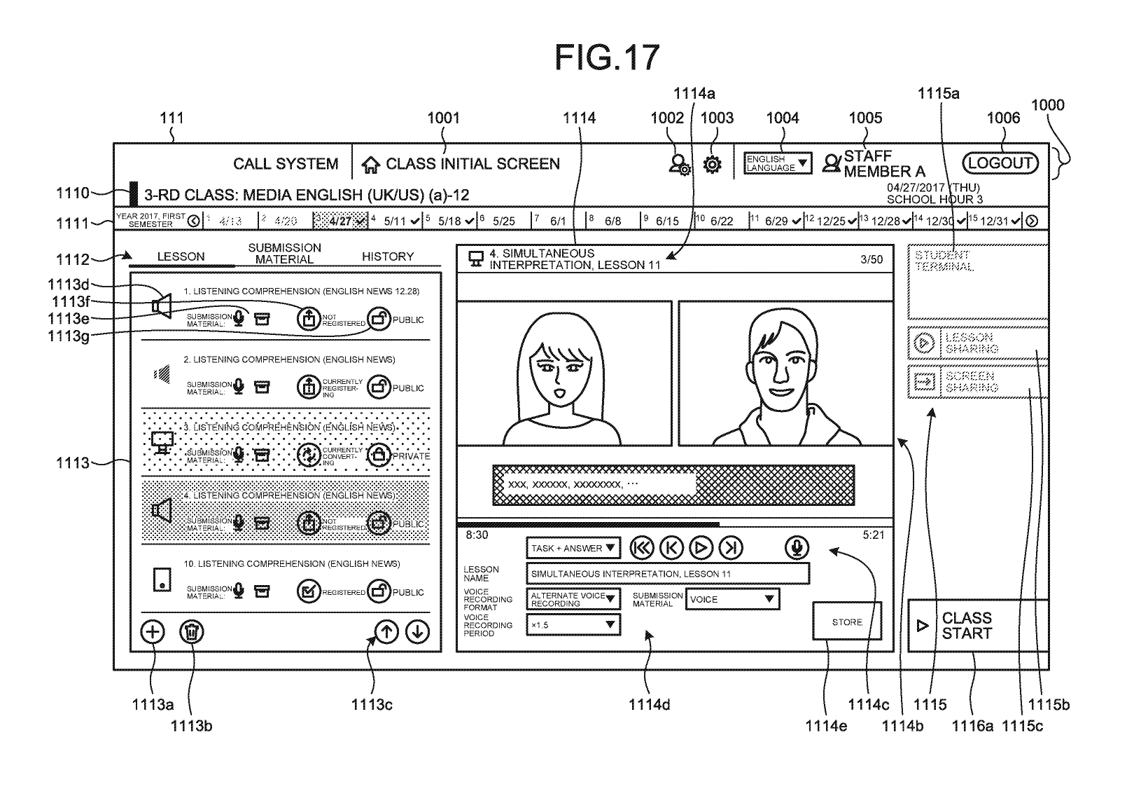

In FIG. 14 is illustrated an example of the staff member timetable screen 102 according to the embodiment. In the example illustrated in FIG. 14, the staff member timetable screen 102 has a title bar area 1000 in the upper part that includes a screen title 1001, icons 1002 and 1003, a language selecting portion 1004, a login information display portion 1005, and a logout button 1006.

The screen title 1001 is used to display the title of the staff member timetable screen 102. The icon 1002 represents an operator for changing the screen to the faculty setting screen 112 in response to a user operation. The icon 1003 represents an operator for changing the screen to the system setting screen 113 in response to a user operation. The language selecting portion 1004 represents an area for selecting the display language of a series of screens displayed in the staff member PC 40. The login information display portion 1005 is used to display the information about the staff member (user) who has currently performed login to the class management server 30 using the staff member PC 40. The logout button 1006 is used to log out of the class management server 30.

In the staff member timetable screen 102, a timetable display area 1025 is provided below the title bar area 1000. In the example illustrated in FIG. 14, in the timetable display area 1025, regarding each day from Monday to Saturday, school hours 1026 represent the unit formed by division at every predetermined time slots, and the school hours 1026 are arranged in a reticular pattern. Each school hour 1026 corresponds to a single class, and is used to display a code assigned to the concerned class course, a course name, and the name of the teacher in charge of that class (school hour). For example, the class management server 30 obtains information about the school hours by referring to the class information table (Table 3) stored in the class information DB 35, and displays the obtained information in the timetable display area 1025. Meanwhile, in FIG. 14, a school hour 1027 illustrated in a thick frame is assumed to have been selected.

In the staff member timetable screen 102, buttons 1029 and 1030 are provided in the lower part. The button 1029 is meant for editing the information about the school hour selected in the timetable display area 1025 (for example, the school hour 1027). When the button 1029 is operated, the screen display changes to the subject editing screen 110. The button 1030 is meant for displaying the class screen of the school hour selected in the timetable display area 1025 (for example, the school hour 1027). When the button 1030 is operated, the screen display changes to the class initial screen 111.

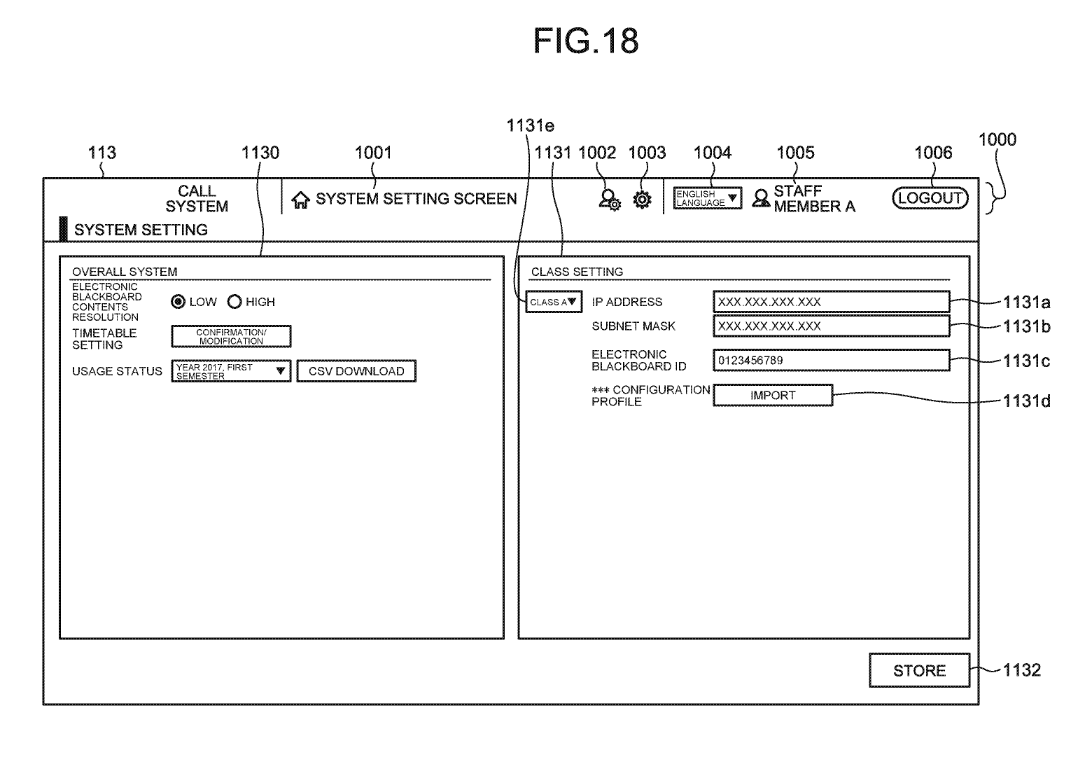

In FIG. 15 is illustrated an example of the subject editing screen 110 according to the embodiment. Meanwhile, in FIG. 15 and in subsequent identical drawings, the constituent elements identical to those illustrated in FIG. 14 are referred to by the same reference numerals and their explanation is not repeated. With reference to FIG. 15, in the subject editing screen 110, the title bar area 1000 in the upper part includes the screen title 1001, the icons 1002 and 1003, the language selecting portion 1004, the login information display portion 1005, and the logout button 1006.

In the example illustrated in FIG. 15, in the subject editing screen 110, below the title bar area 1000, a subject editing area 1101 and a student list area 1102 are provided. The subject editing area 1101 is meant for editing the information about the class course that includes the class (school hour) selected in the timetable display area 1025 of the staff member timetable screen 102.

In the example illustrated in FIG. 15, the subject editing area 1101 includes a code input area, a subject name input area, a conducting period setting portion, a conducting day setting portion, a conducting school-hour setting portion, a class time-schedule editing button, an in-charge teacher setting area, and a subject details input area. The code input area is used to input the code of the class course. The code need not be a unique value, and an arbitrary value can be set. The class management server 30 manages the class course with unique identification information apart from the code. The subject name input area is used to input the name of the class course.

The conducting period setting portion is used to set the conducting period of the concerned class course. In the example illustrated in FIG. 15, either the first semester of a particular year or the full year can be exclusively set in the conducting period setting portion. The conducting day setting portion is used to display, according to the selection in the timetable display area 1025, the day on which the class of the concerned class course is conducted. The conducting school-hour setting portion is used to display, according to the selection in the timetable display area 1025, the school hour for conducting the class of the concerned class course. The class time-schedule editing button is operated so as to change the screen display to the class time-schedule editing screen 115. The in-charge teacher setting area is meant for selecting, from among the users set to have the role of “teacher”, the teacher to be in charge of the class of the concerned class course based on the account information table illustrated in Table 1 and based on the role information table illustrated in Table 2. The subject details input area is meant for inputting text information representing the explanation of the concerned class course.

Meanwhile, if the information about the class course that includes the class selected in the timetable display area 1025 is already stored in the class information table (Table 3) in the class information DB 35, then the class management server 30 obtains the information from the class information table and displays the obtained information as the default value in the portions corresponding to the subject editing area 1101.

With reference to FIG. 15, below the subject editing area 1101, buttons 1103a and 1103b are provided. The button 1103a is meant for deleting the subject (the class course) being displayed in the subject editing area 1101. The button 1103b is meant for registering the subject (the class course) being displayed in the subject editing area 1101. When the button 1103b is operated, the value set in the portions corresponding to the subject editing area 1101 gets sent from the staff member PC 40 to the class management server 30 (Step S113 illustrated in FIG. 10), and the class management server 30 stores or overwrites the value in the class information table (Table 3) in the class information DB 35 (Step S114 illustrated in FIG. 10). When the button 1103a is operated, the values set in the portions in the subject editing area 1101 are cleared, and the information about the concerned class course is deleted from the class information table in the class information DB 35.

With reference to FIG. 15, in the student list area 1102 is displayed a list indicating the information about the students who are taking the class course displayed in the subject editing area 1101. For example, if the information (the user IDs) about the students who have registered for taking the class course that includes the class selected in the timetable display area 1025 is already stored in the class information table (Table 3) in the class information DB 35, then the class management server 30 obtains the student information from the class information table and displays the obtained information on the student list area 1102.

Below the student list area 1102, buttons 1102a and 1102b are provided. The button 1102a is meant for importing the list of students from, for example, a CSV file (CSV stands for Comma-Separated Values). For example, the list data of the students as imported from the file is sent from the staff member PC 40 to the class management server 30 and is stored in the class information table illustrated in Table 3. The button 1102b is meant for deleting the information about all students displayed in the student list area 1102. When the button 1102b is operated, the information about the students of the concerned class course gets deleted also from the class information table (Table 3) in the class information DB 35.

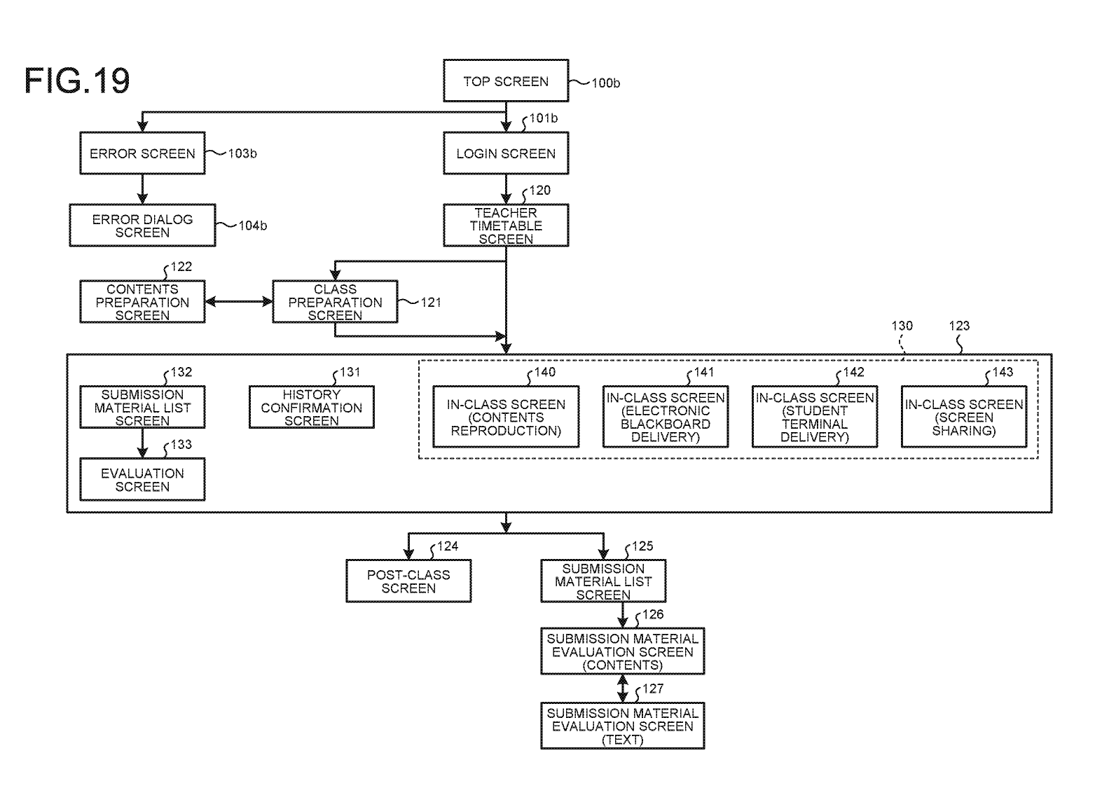

In FIG. 16 is illustrated an example of the class time-schedule editing screen 115 according to the embodiment that is displayed in response to an operation of the class time-schedule editing button in the subject editing area 1101. In the example illustrated in FIG. 16, the class time-schedule editing screen 115 is displayed in an overlapping manner on the subject editing screen 110. The class time-schedule editing screen 115 includes a class course information display area 1150, a time schedule specification area 1151, and a time schedule editing area 1152.

In the class course information display area 1150 are displayed the values that are input and set in the subject name input area, the conducting period setting portion, the conducting day setting portion, and the conducting school-hour setting portion provided above the class time-schedule editing button in the subject editing area 1101 illustrated in FIG. 15.

In the time schedule specification area 1151 is listed the time schedule of the classes of the concerned class course based on the input and the setting performed in the conducting period setting portion, the conducting day setting portion, and the conducting school-hour setting portion. The time schedule editing area 1152 is meant for editing the time schedule of the classes specified in the time schedule specification area 1151, and enables editing of the conducting date and the conducting school hour. A button 1152a is meant for storing the time schedule edited in the time schedule editing area 1152. When the button 1152a is operated, the edited time schedule is reflected in the display of the time schedule specification area 1151.

Below the class time-schedule editing screen 115; buttons 1151a, 1151b, and 1151c are provided. The button 1151a is meant for deleting the class specified in the time schedule specification area 1151. The button 1151b is meant for adding a class. When the button 1151b is operated, a class can be added corresponding to, for example, the time schedule and the school hour set in the time schedule editing area 1152. The button 1151c is meant for ending the editing of the time schedule of the class using the class time-schedule editing screen 115. When the button 1151c is operated, the class time-schedule editing screen 115 gets closed, and the screen display changes to the subject editing screen 110.

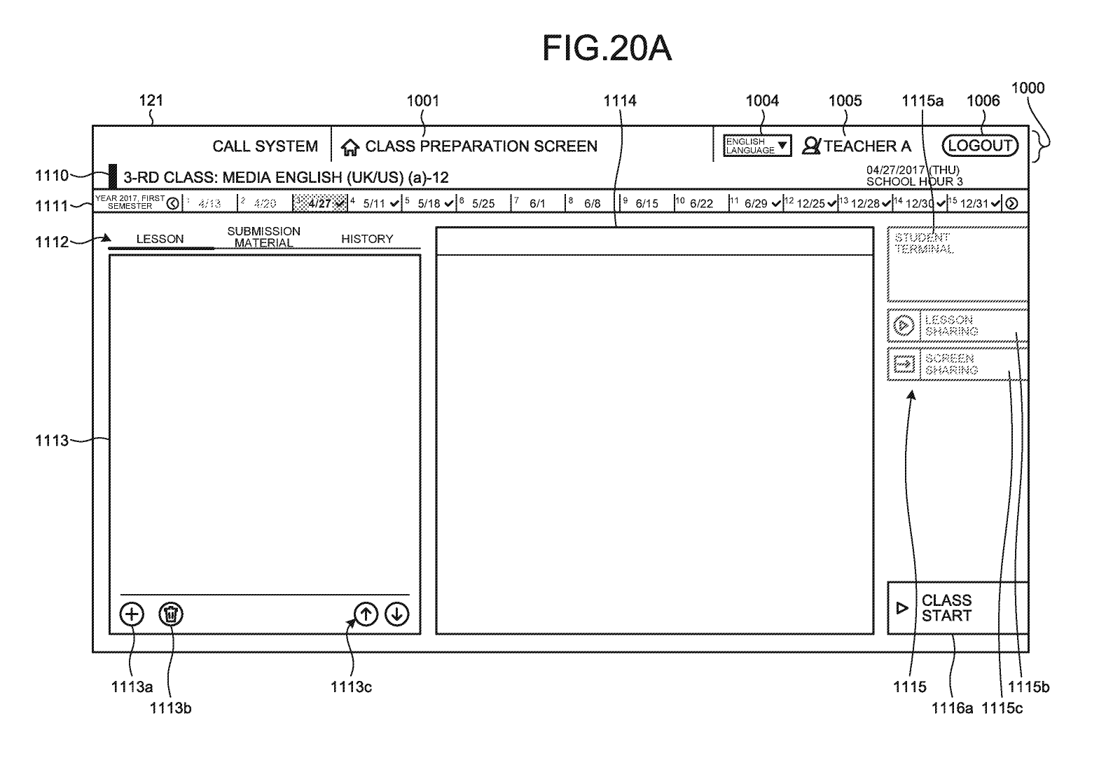

In FIG. 17 is illustrated an example of the class initial screen 111 according to the embodiment. With reference to FIG. 17, in the class initial screen 111, the title bar area 1000 in the upper part includes the screen title 1001, the icons 1002 and 1003, the language selecting portion 1004, the login information display portion 1005, and the logout button 1006.

In the example illustrated in FIG. 17, in the class initial screen 111, a class name display portion 1110 is provided below the title bar area 1000; and a time schedule specification bar 1111 is provided below the class name display portion 1110. Moreover, a lesson display portion 1113 and a contents presentation portion 1114 are provided below the time schedule specification bar 1111. Furthermore, on the right-hand side of the contents presentation portion 1114, a button group 1115 and a class start button 1116a are provided.

The class name display portion 1110 is used to display the class name of the class that is conducted in the school hour selected in the timetable display area 1025 in the staff member timetable screen 102. The time schedule specification bar 1111 is used to display a list of time schedules of the classes included in the class course that also includes the concerned class. The lesson display portion 1113 is used to display a list of lessons related to the class having the time schedule specified in the time schedule specification bar 1111. The contents presentation portion 1114 is used to present the contents to be used in the lesson specified in the lesson display portion 1113.

Above the lesson display portion 1113, a tab 1112 is provided that includes tabs for switching between a lesson list, a submission material list, and a history list. In the example illustrated in FIG. 17, in the tab 1112, the tab for displaying the lesson list in the lesson display portion 1113 is specified. In that case, in the lesson display portion 1113, the lessons included in the class under consideration in the class initial screen 111 are listed. For example, from the task information table (Table 5) stored in the class information DB 35, the class management server 30 obtains the task information table corresponding to the concerned class and performs display in the lesson display portion 1113 based on the values stored in the item “lesson name” of the records in the obtained task information table.

Each lesson displayed in the lesson display portion 1113 includes a lesson name and icons 1113d, 1113e, 1113f, and 1113g. The icon 1113d indicates the type of that lesson (such as voice reproduction, sharing of electronic blackboard screen, or voice exchange among the student terminals 20). The icon 1113e represents a pair of an icon indicating the type of the submission material (the deliverable) to be submitted in that lesson and an icon indicating submission or no submission of the submission material. The icon 1113f instructs, in response to the operation thereof, the registration of the contents to be used in the concerned lesson in the class management server 30, as well as indicates the registration status (not registered, being registered, being converted, or registered) of the contents in the class management server 30. The icon 1113g indicates whether the concerned lesson is in the public state or in the private state.

Below the lesson display portion 1113; buttons 1113a, 1113b, and 1113c are provided. The button 1113a is meant for instructing the addition of a lesson in the lesson display portion 1113. The button 1113b is meant for instructing the deletion of the lessons specified in the lesson display portion 1113. The button 1113c is a pair of buttons meant for changing the sequence of lessons specified in the lesson display portion 1113.

In the contents presentation portion 1114, the contents that are to be used in the lesson specified in the lesson display portion 1113 are presented. The contents presentation portion 1114 includes a title area 1114a, a contents area 1114b, a control area 1114c, a response setting area 1114d, and a button 1114e. The title area 1114a is used to display the lesson name. Regarding the contents area 1114b, when the contents represent video data, the video data is reproduced in the contents area 1114b as illustrated in FIG. 17. However, when the contents represent data other than video data, for example, an icon image indicating the type of the contents is displayed in the contents area 1114b.

The control area 1114c includes various operators meant for controlling the reproduction of the contents present in the contents area 1114b; includes a progress bar for indicating the position of reproduction of the contents; includes an operator meant for implementing voice recording; and includes a selection portion meant for selecting data to be output as the deliverable. In the selection portion, for example, it is possible to either select a combination of a task and an answer or select only an answer. Herein, the task implies the voice of contents and the answer implies a recorded voice.

The response setting area 1114d is used to perform the setting regarding the response with respect to the contents that are presented using the contents presentation portion 1114. In the example illustrated in FIG. 17, the response setting area 1114d includes a lesson name input area, a recording format setting portion, a submission material setting portion, and a recording period setting portion.

The lesson name input area is used to input the name of the concerned lesson; and the lesson name that is input in the lesson name input area is displayed in the title area 1114a. The recording format setting portion can be used to set either alternate voice recording (shadowing) or concurrent voice recording (concurrent utterance). The submission material setting portion is used to set the format of the data (such as voice data or text data) to be submitted as the submission material (deliverable) in the concerned lesson. The recording period setting portion is used to set the length of the recording period with respect to the length of the contents reproduced in one instance. For example, in the case of alternate recording, the period of time obtained by adding the margin period α, which is explained earlier with reference to FIG. 3B, to the reproduction period of the voice data that is intermittently reproduced is set as the length of the recording period. In the example illustrated in FIG. 17, the period of time equal to 1.5 times of the reproduction period of the voice data is set as the length of the recording period.

The button 1114e is meant for storing the details of the setting performed in the response setting area 1114d. In response to an operation of the button 1114e, the class management server 30 stores, in the class information DB 35, the details of the setting, which is done in the response setting area 1114d, in a corresponding manner to the class and the lesson.

In the class initial screen 111, the button group 1115 includes a status display portion 1115a and buttons 1115b and 1115c. The status display portion 1115a is used to display the status of the lesson specified in the lesson display portion 1113. The button 1115b is meant for specifying whether or not to synchronize the specified lesson among all students who are taking the class. The button 1115c is meant for specifying whether or not to display the details of the specified lesson on the electronic blackboard installed in the concerned classroom (for example, the electronic blackboard 23a installed in the classroom 2a). In the class initial screen 111, the function of the status display portion 1115a and the functions of the buttons 1115b and 1115c are disabled, and the display thereof is grayed out.

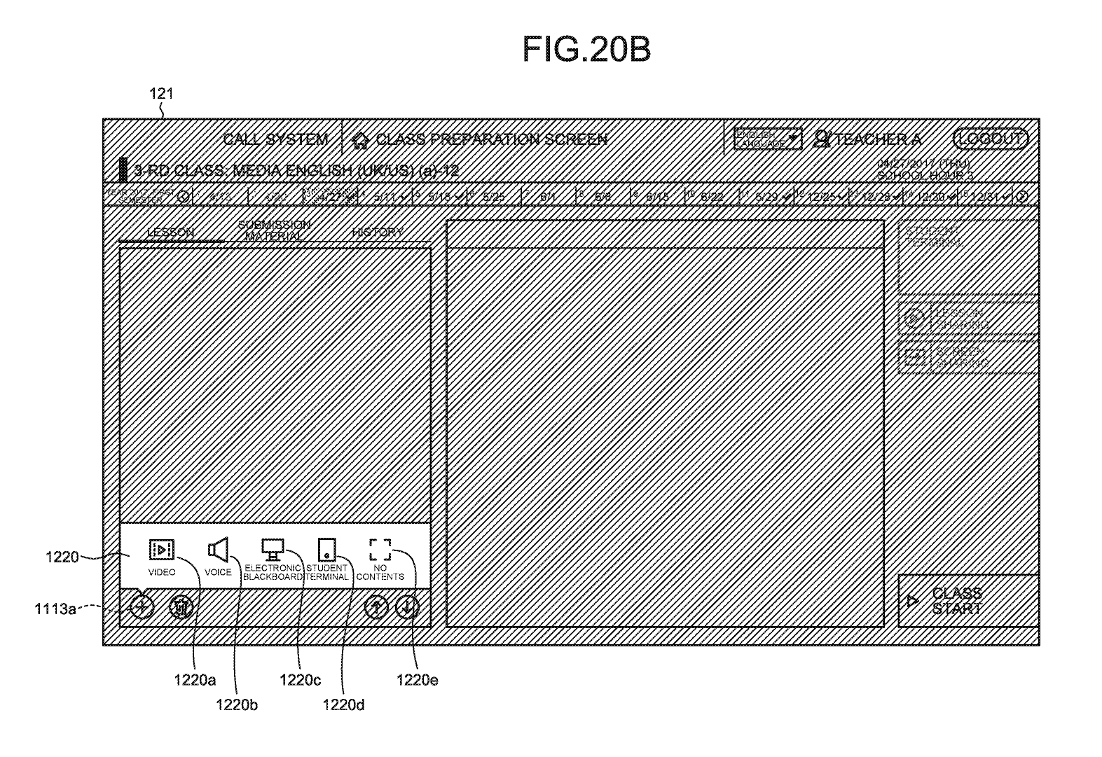

In FIG. 18 is illustrated an example of the system setting screen 113 according to the embodiment. The system setting screen 113 is meant for performing global settings of the information processing system constituting the CALL system according to the embodiment. With reference to FIG. 18, in the system setting screen 113, the title bar area 1000 in the upper part includes the screen title 1001, the icons 1002 and 1003, the language selecting portion 1004, the login information display portion 1005, and the logout button 1006. Moreover, in the system setting screen 113, below the title bar area 1000, a system overall-setting area 1130 and a classroom setting area 1131 are provided.

The system overall-setting area 1130 includes an electronic-blackboard contents resolution setting portion, a timetable setting portion, and a usage status obtaining portion. The electronic-blackboard contents resolution setting portion is meant for setting the image resolution in the electronic blackboard to “low” or “high” at the time of using the electronic blackboard during a class. The timetable setting portion is a button for displaying the timetable setting screen 116 that is meant for defining the duration of the class (the class course) and setting the time period of the school hour. The usage status obtaining portion is a button for specifying the duration of the class course and downloading, from the class management server 30 to the staff member PC 40, the CSV file including the information about the usage status of the system during the specified duration.

The classroom setting area 1131 is meant for performing communication-related setting in the classrooms 2a, 2b, and so on. The classroom setting area 1131 includes an IP address input portion 1131a, a subnet mask input area 1131b, an electronic blackboard ID input portion 1131c, a Wi-Fi (registered trademark) configuration profile setting portion 1131d, and a classroom selection area 1131e. Herein, the classroom selection area 1131e is meant for selecting the target classroom for setting from among the classrooms 2a, 2b, and so on. For the purpose of illustration, it is assumed that the classroom 2a is selected in the classroom selection area 1131e. The IP address input portion 1131a and the subnet mask input area 1131b are used to input the IP address and the subnet mask, respectively, on the network side of the AP 22a installed in the classroom 2a that is selected in the classroom selection area 1131e. The electronic blackboard ID input portion 1131c is used to input the identification information of the electronic blackboard 23a installed in the classroom 2a that is selected in the classroom selection area 1131e. The Wi-Fi configuration profile setting portion 1131d is a button for importing connection setting information based on the wireless LAN in the AP 22a installed in the classroom 2a that is selected in the classroom selection area 1131e.

The system setting screen 113 further includes, in the lower part, a button 1132 meant for storing a variety of information set in the system overall-setting area 1130 and the classroom setting area 1131. In response to an operation of the button 1132, the class management server 30 obtains, from the staff member PC 40, the variety of information set in the system overall-setting area 1130 and the classroom setting area 1131, and stores that information in the class information DB 35.

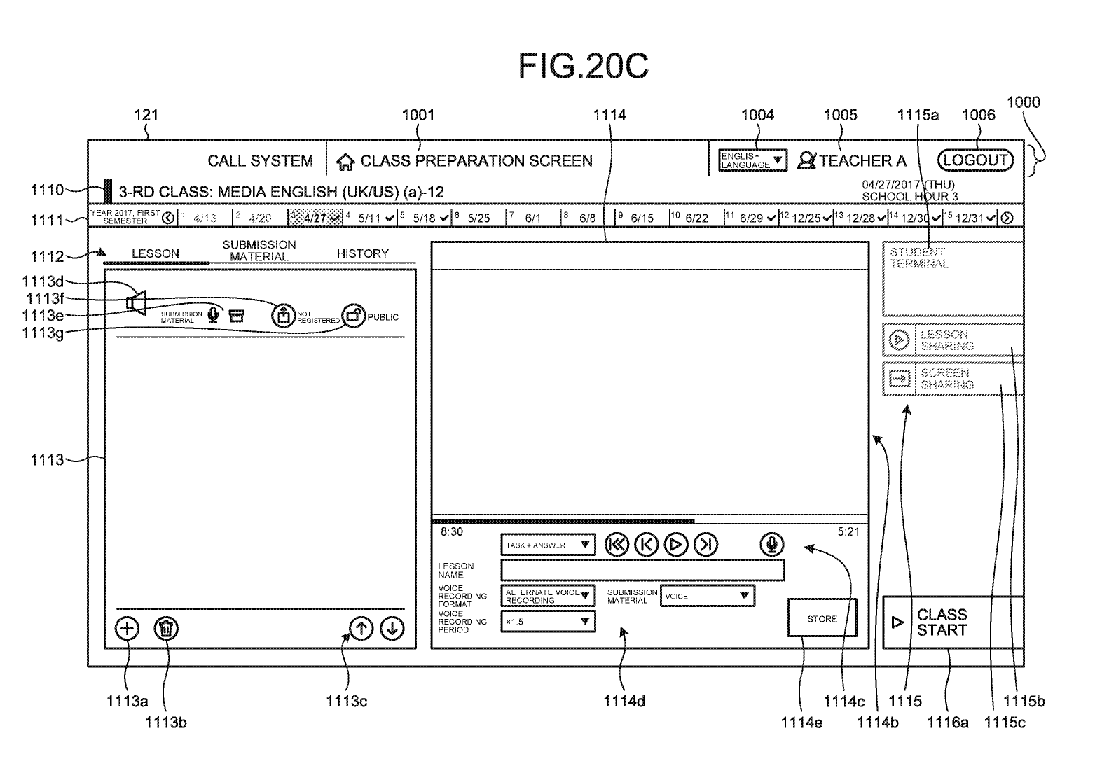

In FIG. 19 is illustrated an example of screen transition in the teacher PC 21. With reference to FIG. 19, for example, when an access request is issued from the teacher PC 21 to the class management server 30 at Step S200 illustrated in FIG. 11, a top screen 100b is the initially-displayed screen displayed by the portal server 32. Then, the screen on the teacher PC 21 changes from the top screen 100b to a login screen 101b that includes an input area meant for inputting the login information and a button meant for issuing a login request. As explained earlier with reference to Steps S202 to S206 illustrated in FIG. 11, the login information is input in and sent from the login screen 101b and, when authentication is successful, a teacher timetable screen 120 is displayed as the initial screen in the teacher PC 21 (Steps S210 and S211 illustrated in FIG. 11).

Meanwhile, if the access from the top screen 100b to the login screen 101b ends up in failure for some reason, then the screen display in the teacher PC 21 changes to an error screen 103b for displaying a system error message and, for example, after a predetermined period of time, the screen changes to an error dialog screen 104b for notifying the occurrence of an error.

The teacher timetable screen 120 has the same configuration as the staff member timetable screen 102 explained with reference to FIG. 14. In the teacher timetable screen 120, the timetable display area 1025 in the staff member timetable screen 102 is used for selectively displaying the classes that the teacher who performed login from the login screen 101b is in charge of. The screen of the teacher PC 21 can change from the teacher timetable screen 120 to a class preparation screen 121. From the class preparation screen 121, the teacher PC 21 can call a contents preparation screen 122 meant for preparing the contents to be used in the class.

Moreover, the screen of the teacher PC 21 can change from the teacher timetable screen 120 or the class preparation screen 121 to an in-class screen 130, a history confirmation screen 131, or a submission material list screen 132. Furthermore, the screen of the teacher PC 21 can change from the submission material list screen 132 to an evaluation screen 133.

The in-class screen 130 includes in-class screens 140, 141, 142, and 143 that are respectively based on contents reproduction, a delivery screen of the electronic blackboard screen, a delivery screen of the student terminal screen, and a screen of screen sharing. The teacher PC 21 can switch between the display of the in-class screens 140 to 143 included in a class screen group 123; the history confirmation screen 131; and the submission material list screen 132.

When the class is over, the screen of the teacher PC 21 can change from a screen included in the class screen group 123 to a post-class screen 124 or a submission material list screen 125. Moreover, the screen of the teacher PC 21 can change from the submission material list screen 125 to submission material evaluation screens 126 and 127 that are used to offer evaluation to contents and text data, respectively.

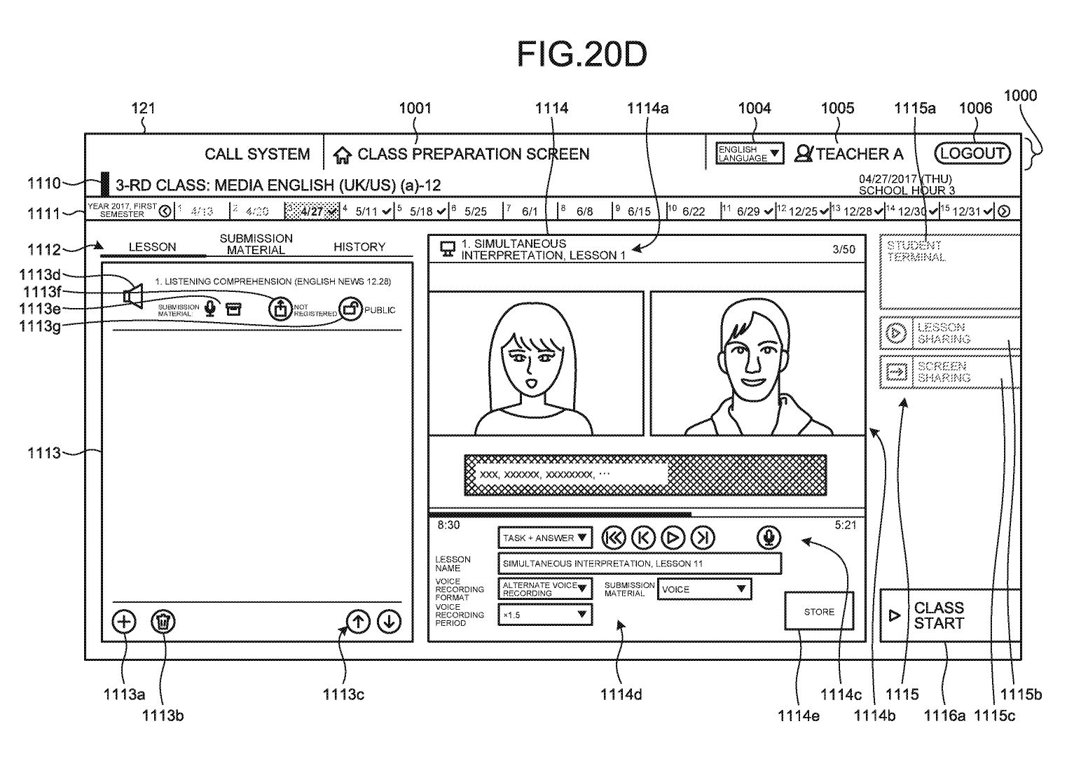

In FIG. 20A is illustrated an example of the class preparation screen 121 according to the embodiment. In the initial state thereof, the class preparation screen 121 displayed in the teacher PC 21 has no lesson set therein. Hence, as illustrated in FIG. 20A, the class preparation screen 121 in the initial state is equivalent to a screen in which the following areas in the class initial screen 111, which is displayed in the staff member PC 40 and which is explained earlier with reference to FIG. 17, are left blank: the area of display of the lessons in the lesson display portion 1113; and the contents presentation portion 1114. Meanwhile, in the lesson display portion 1113, the buttons 1113a, 1113b, and 1113c in the lower part are displayed, and thus new lessons can be added.

With reference to FIG. 20A, in the class preparation screen 121, the icons 1002 and 1003 are not displayed in the title bar area 1000.

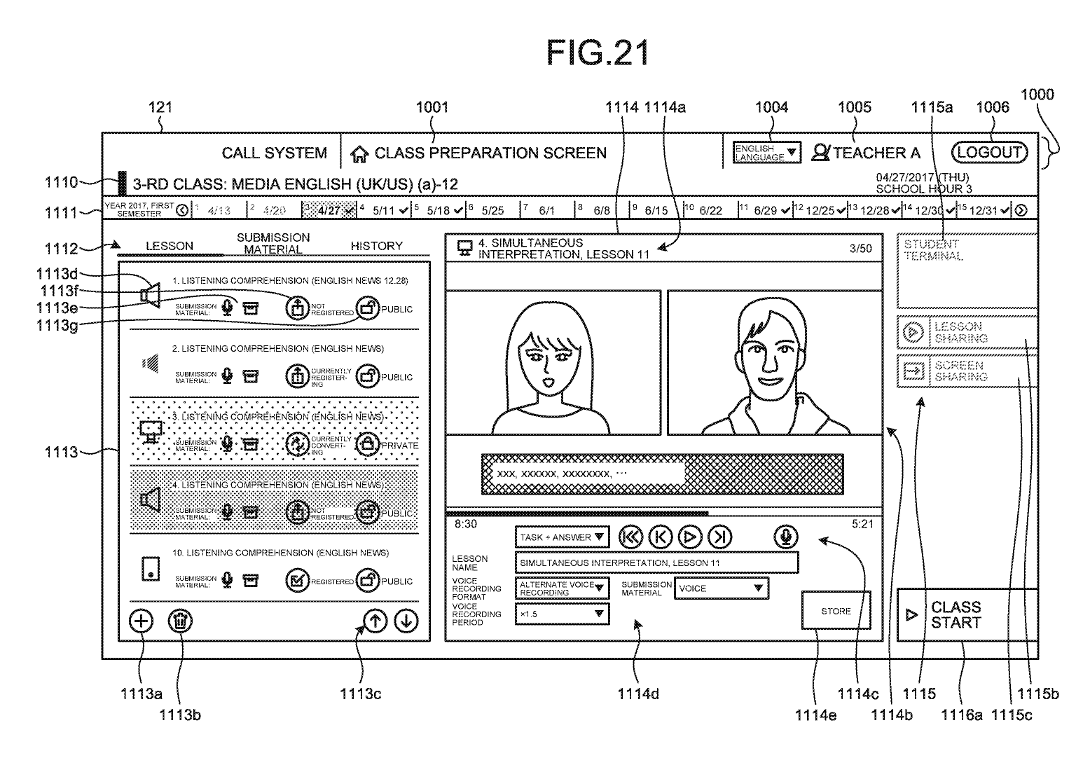

In the class preparation screen 121, the teacher can operate the button 1113a and add a lesson to the class specified in the teacher timetable screen 120. In FIG. 20B is illustrated an example of the class preparation screen 121 in the case in which the button 1113a has been operated. In response to the operation of the button 1113a, an additional-lesson specification area 1220 is displayed at the position corresponding to the button 1113a. In the example illustrated in FIG. 21, the display of the class preparation screen 121 is grayed out, and the additional-lesson specification area 1220 is displayed in an overlapping manner on the class preparation screen 121.

The additional-lesson specification area 1220 includes buttons 1220a, 1220b, 1220c, 1220d, and 1220e meant for specifying the type of the contents and adding a lesson in which the contents of the specified type are to be used. In response to an operation of any of the buttons 1220a, 1220b, 1220c, 1220d, and 1220e; the teacher PC 21 requests the class management server 30 to add, in the concerned class, a lesson in which the contents of the specified type are to be used. In response to that request, the class management server 30 adds a single record in, for example, the task information table that corresponds to the concerned class and that is stored in the class information DB 35.

From among the buttons included in the additional-lesson specification area 1220, the button 1220a is meant for specifying video data as the contents and specifying a lesson in which the video data is to be used. The button 1220b is meant for specifying voice data as the contents and adding a lesson in which the voice data is to be used.

In the additional-lesson specification area 1220, the button 1220c is meant for specifying, as the contents, the screen of the electronic blackboard 23 that is installed in the classroom in which the class specified in the teacher timetable screen 120 is conducted, and for adding a lesson in which those contents are to be used. For example, in the classroom 2c illustrated in FIGS. 1 and 2, the video player 24 is connected to the electronic blackboard 23c. When the button 1220c is specified, the video data that is reproduced in the video player 24 and input to the electronic blackboard 23c can be selected as the contents to be used in a lesson.

In the additional-lesson specification area 1220, the button 1220d is meant for specifying, as the contents, the data (voice data) sent from the student terminal 20, and for adding a lesson in which those contents are to be used. When the button 1220d is operated, the teacher does not prepare contents for the lesson. For example, each student performs communication from his or her own student terminal 20 with the student terminal 20 of the specified student, and carries out the lesson while using the voice data sent from the student terminal 20 of the specified student as the contents.

In the additional-lesson specification area 1220, the button 1220e is meant for adding a lesson in which contents are not to be used.

In the additional-lesson specification area 1220, when any of the buttons 1220c, 1220d, and 1220e is operated, after the operations performed in the teacher PC 21 in response to the operation of the button from among the buttons 1220c, 1220d, and 1220e are completed, the screen display in the teacher PC 21 is returned to the class preparation screen 121.

In FIG. 20C is illustrated an example of the class preparation screen 121 in which, with respect to the class preparation screen 121 in the state illustrated in FIG. 20B, the button 1220a is operated and video data is specified as the contents, and a lesson in which the video data is to be used is added. In FIG. 20C, as compared to the class preparation screen 121 illustrated in FIG. 20A, the display of a single lesson is added in the lesson display portion 1113.

In the display of the lesson added in the lesson display portion 1113, for example, in response to an operation of the icon 1113f, a standard file selection screen is displayed that is provided by the OS (the control unit 214) installed in, for example, the teacher PC 21; and thus the video data becomes selectable. At that time, the file selection screen filters the displayed file according to a predetermined extension that indicates the data type and that is attached to the file name of the file of the video data. When the selection of a file of contents using the file selection screen is completed, the uploading of the selected file to the class management server 30 starts. Accompanying the start of the uploading, the display of the icon 1113f changes to a display indicating that the file is being registered or a display indicating that the file is being converted.

In the class preparation screen 121 illustrated in FIG. 20C, a lesson name can be input in the lesson name input area of the response setting area 1114d. Meanwhile, in the example illustrated in FIG. 20C, other setting portions in the response setting area 1114d (i.e., the recording format setting portion, the submission material setting portion, and the recording period setting portion) have default values input therein in advance.

In FIG. 20D is illustrated an example of the class preparation screen 121 in the case in which the uploading of the video data to the class management server 30 has been completed and a lesson name has been input in the lesson name input area in the response setting area 1114d.

The class management server 30 stores, in the class information DB 35, the uploaded file in a corresponding manner to the record of the added lesson in the task information table illustrated in Table 5. When the uploading of the file is completed, in the class preparation screen 121 illustrated in FIG. 20D, an image gets displayed that is based on the video data uploaded in the contents area 1114b. Moreover, in the display of that lesson in the lesson display portion 1113, a title of the video data that is based on the uploaded file is displayed. When the video data has title information attached thereto as attribute information, the title information can be used as the title of the video data; or the file name of the video data can be used as the title.

Moreover, in the class preparation screen 121 illustrated in FIG. 20D, in the title area 1114a present in the upper part of the contents presentation portion 1114, the lesson name input in the lesson name input area of the response setting area 1114d is displayed.

Starting with an operation of the button 1113a, when the operations explained with reference to FIGS. 20A to 20D are performed in a repeated manner, it becomes possible to set a plurality of lessons for a single class. In FIG. 21 is illustrated an example in which five lessons are set in a single class as a result of performing the operations explained with reference to FIGS. 20A to 20D.

In response to an operation of the button 1030 (see FIG. 14) in the teacher timetable screen 120 for the purpose of displaying the class screen or in response to an operation of the class start button 1116a in the class preparation screen 121 for the purpose of starting a class, the teacher PC 21 switches the screen display to one of the in-class screens 140 to 142. Regarding the in-class screen from among the in-class screens 140 to 142 to which the teacher PC 21 switches the screen display, the decision is taken according to the type of the contents to be used in the specified lesson.

For example, when video data or voice data is specified as the contents of the lesson, the teacher PC 21 switches the screen to the in-class screen 140 meant for contents reproduction. When the screen of the electronic blackboard 23 is specified as the contents of the lesson, the teacher PC 21 switches the screen to the in-class screen 141 meant for electronic blackboard screen delivery. When voice data sent from the student terminal 20 is sent as the contents of the lesson, the teacher PC 21 switches the screen to the in-class screen 142 meant for student terminal delivery.

Meanwhile, regarding the in-class screen 143 meant for screen sharing, screen transition is performed in response to an operation of the button 1115c, which is meant for screen sharing, in any one of the in-class screens 140 to 142.

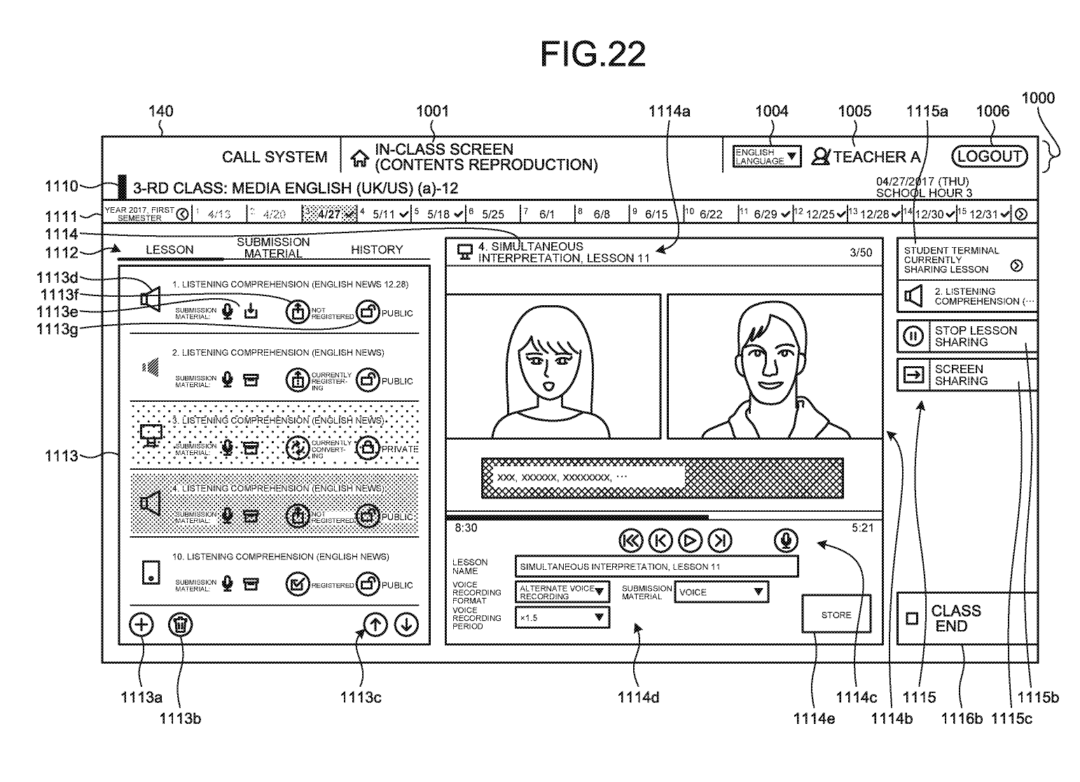

In FIG. 22 is illustrated an example of the in-class screen 140 according to the embodiment and meant for contents reproduction. Since the in-class screen 140 that is displayed in the teacher PC 21 has an equivalent configuration to the configuration of the class preparation screen 121 displayed in the teacher PC 21, the detailed explanation of the in-class screen 140 is not repeated.

In the example illustrated in FIG. 22, video data is used as the contents, and a video based on the video data is displayed in the contents area 1114b. Moreover, in the in-class screen 140 illustrated in FIG. 22, the class start button 1116a illustrated in FIG. 20 is changed to a class end button 1116b meant for instructing the end of the class. Furthermore, in the in-class screen 140, the status display portion 1115a and the buttons 1115b and 1115c in the button group 1115 are set to be in the active state. In the status display portion 1115a, it is notified that the specified lesson has been shared among the student terminals 20.

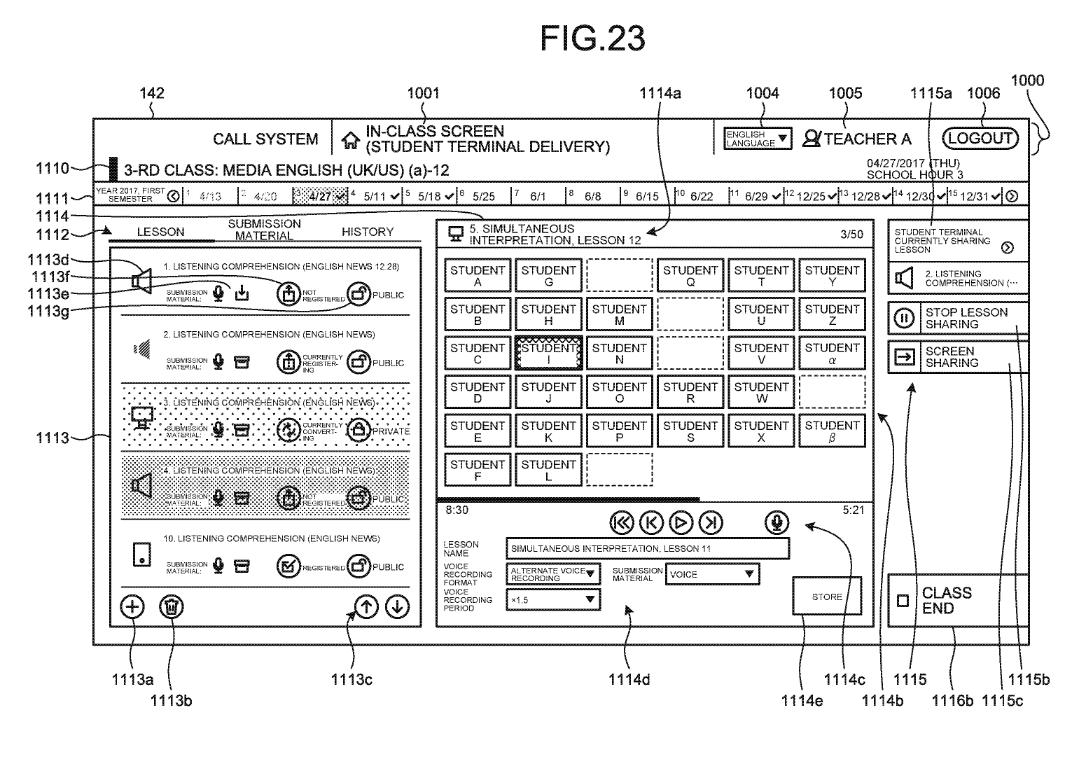

In FIG. 23 is illustrated an example of the in-class screen 142 according to the embodiment and meant for student terminal delivery. In the example illustrated in FIG. 23, in the in-class screen 142, the list of students who are taking the concerned class is displayed in the contents area 1114b. For example, when a lesson is specified in which the voice data sent from the student terminal 20 is to be used as the contents, the teacher PC 21 requests the class management server 30 for the list of students who are taking the concerned class. In response to the request, the class management server 30 refers to the class information table stored in the class information DB 35 and illustrated in Table 3; obtains the list of students who are taking the concerned class; and inquires the authentication server 31 and extracts the students who are attending on that day from among the obtained list of students. Then, the class management server 30 generates the in-class screen 142 in which the extracted list of students is displayed in the contents area 1114b, and presents the in-class screen 142 to the teacher PC 21.

For example, the teacher operates the teacher PC 21 and specifies a single student from the displayed list. In the example illustrated in FIG. 23, a “student I” is specified. Then, the teacher PC 21 sends information indicating the specified student to the class management server 30. Subsequently, for example, the class management server 30 instructs the student terminals 20 to ensure that peer-to-peer communication is performed between the student terminal 20 of the student I and the student terminals 20 of the students other than the student I. In each student terminal 20, according to the instruction, the class application performs setting related to peer-to-peer communication.

The class management server 30 instructs the student terminal 20 of the student I to store (record) the voice data that is based on the voice picked up by the microphone 2021 and to send the voice data to the other student terminals 20. Moreover, the class management server 30 instructs the student terminal 20 of each other student, other than the student I, who is attending the concerned class to store the voice data that is based on the voice picked up by the microphone 2021 and to store the voice data sent from the student terminal 20 of the student I. In each other student terminal 20, according to the instruction, the class application performs setting related to communication and voice data processing.

In each of the in-class screens 140 to 143, in response to an operation of the class end button 1116b, the teacher PC 21 sends class identification information, information indicating the lesson, and a notification about the end of the lesson to the class management server 30. According to such information sent from the teacher PC 21, in the record of the concerned lesson in the task information table corresponding to the class identification information, the class management server 30 changes the value of the end flag to the value indicating the end of the lesson.

In the class preparation screen 121 or in any one of the in-class screens 140 to 143, when the tab 1112 is changed to the submission material list, the screen display in the teacher PC 21 is changed to the submission material list screen 132.

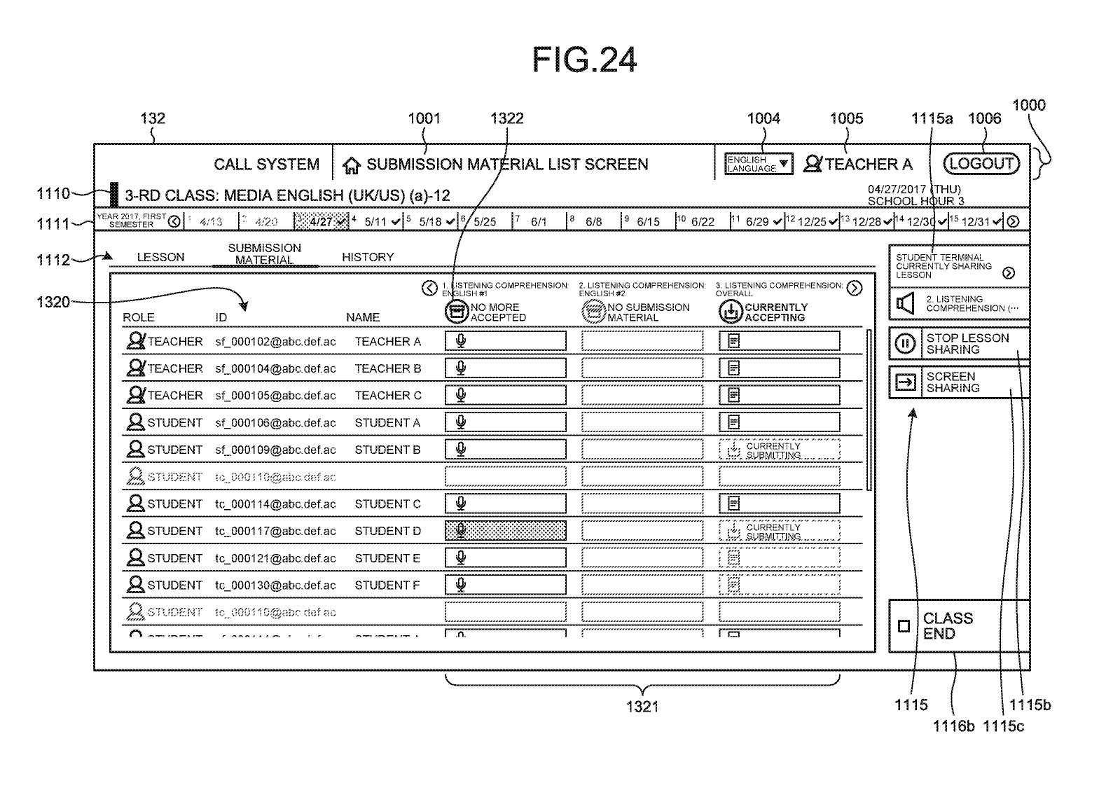

In FIG. 24 is illustrated an example of the submission material list screen 132 according to the embodiment. In the example illustrated in FIG. 24, below the time schedule specification bar 1111, a user list display area 1320 and a submission material list display area 1321 are provided. The user list display area 1320 is used to display the information (in this example, the role, the user ID, and the user name) about the users, that is, the teacher and the students related to the concerned class. Regarding each task included in the concerned class, the submission material list display area 1321 is used to display the presence or absence of the submission material from each user regarding each lesson included in the concerned class.

Meanwhile, in the submission material list display area 1321, an icon 1322 is displayed for indicating the status related to the submission material regarding each lesson. For example, regarding the submission material related to the concerned lesson, the icon 1322 indicates three types of status, namely, currently accepting, no more accepted, and no submission material. Each user can submit the submission material for the lesson for which the status indicates currently accepting.

The teacher can operate the teacher PC 21 and specify the desired submission material in the submission material list display area 1321 in the submission material list screen 132, and can offer evaluation to the specified submission material.

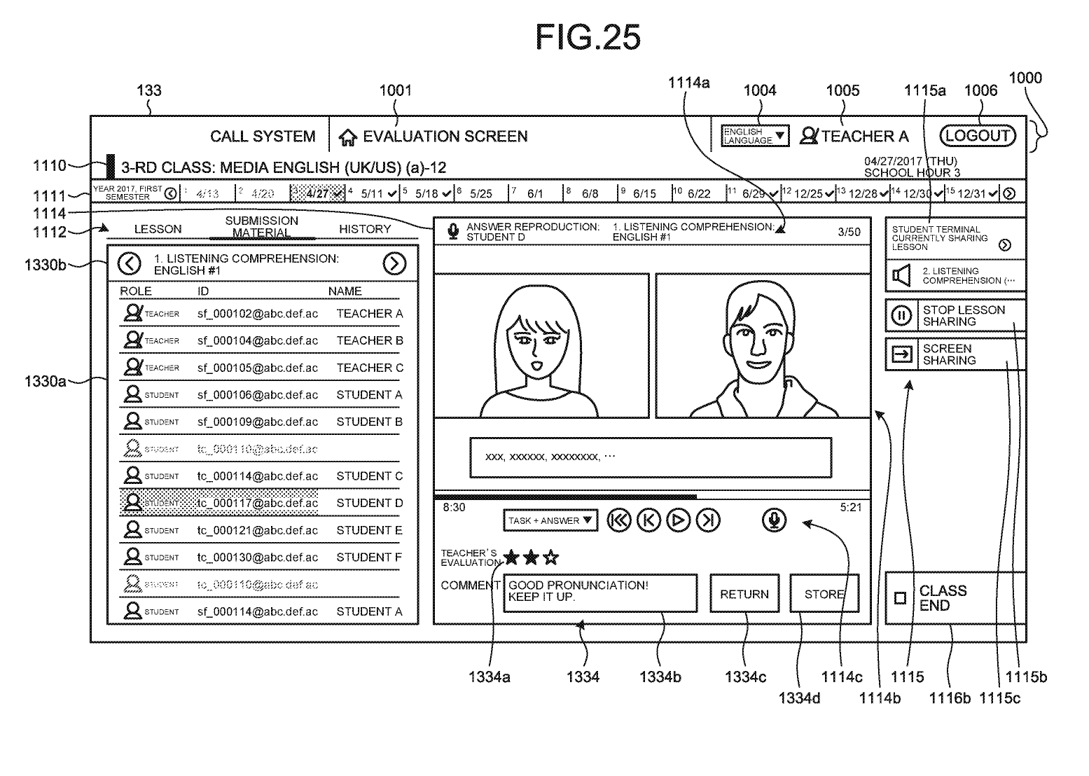

In FIG. 25 is illustrated an example of the evaluation screen 133 meant for offering evaluation to the specified submission material. In the example illustrated in FIG. 25, below the time schedule specification bar 1111, a user list display area 1330a is provided. The display in the user list display area 1330a corresponds to the user list display area 1320 in the submission material list screen 132 illustrated in FIG. 24. In the upper part of the user list display area 1330a, a lesson selection portion 1330b is provided. In the teacher PC 21, when the lesson selection portion 1330b is operated, it becomes possible to select the desired lesson from among the lessons in the submission material list display area 1321 in the submission material list screen 132 illustrated in FIG. 24.

In the evaluation screen 133 illustrated in FIG. 25, “student D” is selected in the user list display area 1330a, and a lesson “1. Listening comprehension: English #1” is selected in the lesson selection portion 1330b. In the title area 1114a is displayed the information selected in the user list display area 1330a and the lesson selection portion 1330b. Moreover, in the contents area 1114b are displayed the contents (video data) to be used in the lesson selected in the lesson selection portion 1330b. Moreover, regarding the voice, according to the selection in the selection portion in the control area 1114c, the voice based on the video data is reproduced along with the utterance voice recorded by the student D and included in the submission material. Herein, the voice is reproduced by the speaker 2122 that is connected to the teacher PC 21.

The teacher who is viewing the evaluation screen 133 listens to the voice that is reproduced from the teacher PC 21 and that represents the submission material from the student D, and offers evaluation to the concerned lesson taken by the student D.

In the evaluation screen 133, below the control area 1114c, an evaluation input area 1334 is provided that includes an evaluation input portion 1334a, an evaluation text input area 1334b, and buttons 1334c and 1334d. In the example illustrated in FIG. 25, the evaluation input portion 1334a enables input of a three-grade evaluation. The evaluation text input area 1334b enables input of a comment with respect to the evaluation.

The button 1334c is meant for resetting the evaluation input in the evaluation input portion 1334a and resetting the comment input in the evaluation text input area 1334b. The button 1334d is meant for storing the evaluation and the comment. For example, in response to an operation of the button 1334d, the teacher PC 21 sends, to the class management server 30, evaluation information containing the evaluation, which is input in the evaluation input portion 1334a, and the comment, which is input in the evaluation text input area 1334b, in a corresponding manner with, for example, the class identification information (the time schedule, the school hour, and the classroom) and the user ID of the student. Then, the class management server 30 stores the evaluation information, which is sent from the teacher PC 21, in the task information table based on the class identification information and the user ID.

In the class preparation screen 121 or in any one of the in-class screens 140 to 143, when the tab 1112 is changed to the history list, the screen display in the teacher PC 21 is changed to the history confirmation screen 131.

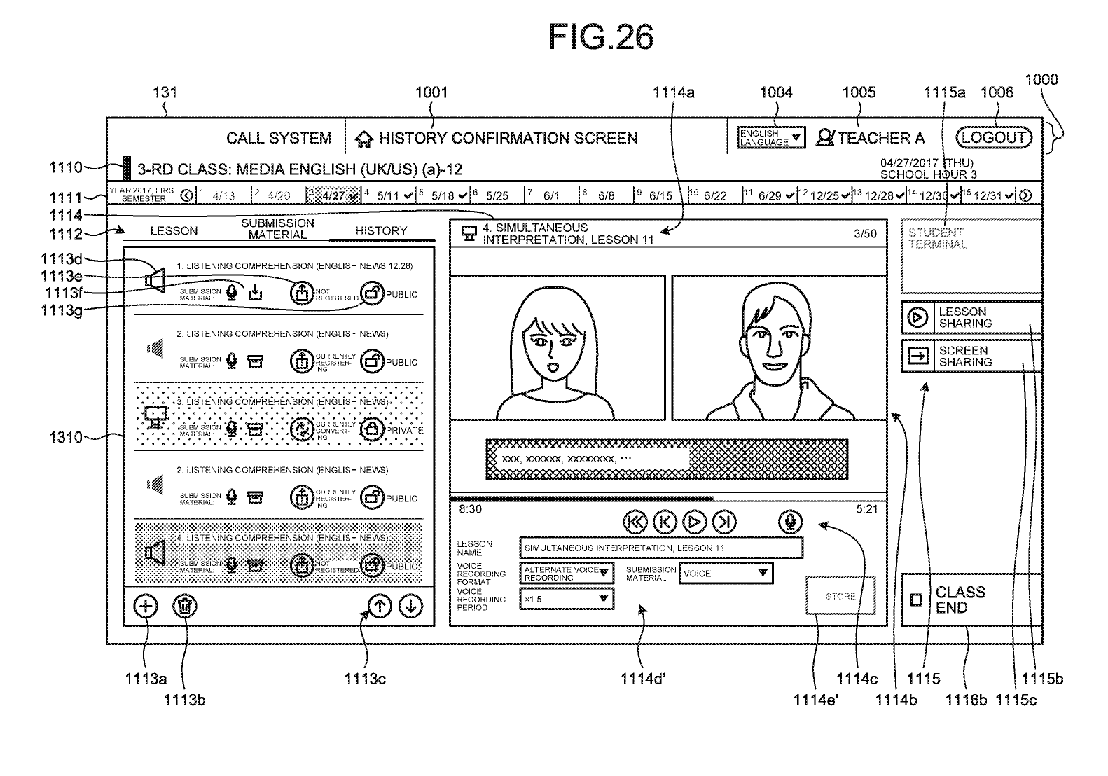

In FIG. 26 is illustrated an example of the history confirmation screen 131 according to the embodiment. In the example illustrated in FIG. 26, the history confirmation screen 131 has an identical configuration to, for example, the configuration of the class preparation screen 121 explained with reference to FIG. 20. A history display portion 1310 corresponds to the lesson display portion 1113 illustrated in FIG. 20; and, in the history confirmation screen 131, the lessons that are finished during the class are listed in the sequence in which the lessons were carried out. For example, when the history confirmation screen 131 is displayed in the teacher PC 21, the class management server 30 identifies the lessons for which the value of the item “end flag” in the task information table indicates the end of the lesson based on the class identification information, and sends the information included in the records of the identified lessons to the teacher PC 21. Based on the information received from the class management server 30, the teacher PC 21 arranges the finished lessons according to, for example, the end timings of the lessons and displays the list in the history display portion 1310. In the example illustrated in FIG. 26, it is illustrated that, after the first lesson to the third lesson are carried out in sequence, the second lesson is again carried out, and then the fourth lesson is carried out.

A response setting area 1114d′ corresponds to the response setting area 1114d illustrated in FIG. 20; and, in the history confirmation screen 131, only display of information is performed in each area and each portion, and editing of the information is not allowed. Moreover, regarding the button 1114e meant for storing the details of the setting done in the response setting area 1114d illustrated in FIG. 20, the button 1114e is substituted by a grayed-out button 1114e′ in the history confirmation screen 131 and thus the storing function is disabled.

Meanwhile, in the history confirmation screen 131, the status display portion 1115a is grayed-out and thus the display function is disabled.

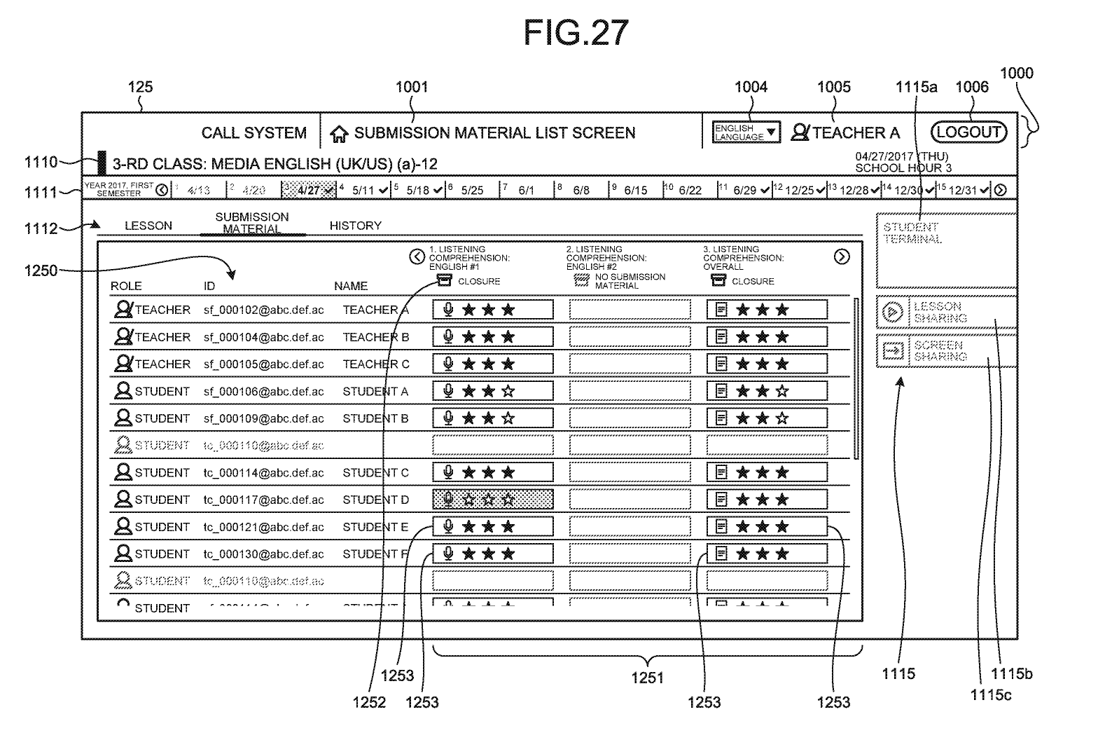

For example, when the class is finished, the teacher in charge can display the submission material list screen 125 on the teacher PC 21. In FIG. 27 is illustrated an example of the submission material list screen 125. With reference to FIG. 27, the submission material list screen 125 has an equivalent screen configuration to the screen configuration of the submission material list screen 132 explained with reference to FIG. 24. That is, in the submission material list screen 125, below the time schedule specification bar 1111, a user list display area 1250 and a submission material list display area 1251 are provided.

Meanwhile, since the submission material list screen 125 is meant to be used after the end of the class, the status display portion 1115a and the buttons 1115b and 1115c are grayed out and the functions thereof are disabled.

The user list display area 1250 is used to list the information (in this example, the role, the user ID, and the user name) about the users, that is, the teacher and the students related to the concerned class. Regarding each lesson included in the concerned class, the submission material list display area 1251 is used to display the presence or absence of the submission material from each user regarding each lesson included in the concerned class. Moreover, in the submission material list display area 1251, an icon 1252 is displayed for indicating the status related to the submission material regarding each lesson. Since the submission material list screen 125 is meant to be used after the end of the class, for the lesson for which the submission of a submission material is demanded, the icon 1252 indicates that the submission material is no more accepted.

In the submission material list screen 125, regarding the display in the submission material list display area 1251 indicating the submission material from each user, a mark 1253 is displayed indicating the evaluation set in the evaluation screen 133 illustrated in FIG. 25. As a result, the teacher can easily understand the evaluation offered to the submission material (deliverable) submitted from each student who took the class.

In the submission material list screen 125, from the display in the submission material list display area 1251 indicating the submission material of each user, when the desired display is specified, the detailed evaluation offered to the specified submission material can be confirmed. For example, in the teacher PC 21, from the display in the submission material list display area 1251 indicating the submission material of each user, when the desired display is specified and when that is followed by a predetermined operation, the display screen in the teacher PC 21 can be switched to the submission material evaluation screen 126 in which contents can be displayed. The submission material evaluation screen 126 has an equivalent screen configuration to the screen configuration of the evaluation screen 133 illustrated in FIG. 25 and, for example, enables offering evaluation while reproducing the voice representing the submission material. Moreover, if the concerned submission material has already been evaluated, then it is also possible to offer reevaluation and rewrite the evaluation information.

Furthermore, in response to a predetermined operation performed with respect to the submission material evaluation screen 126, the teacher PC 21 can switch the display screen to the submission material evaluation screen 127 in which evaluation can be offered using text data. In the submission material evaluation screen 127, for example, evaluation can be input using text data while reproducing the voice representing the submission material. In the submission material evaluation screen 127, the input area for inputting the text data is set to be greater than the evaluation text input area 1334b in the evaluation screen 133, thereby enabling input of a more detailed evaluation.

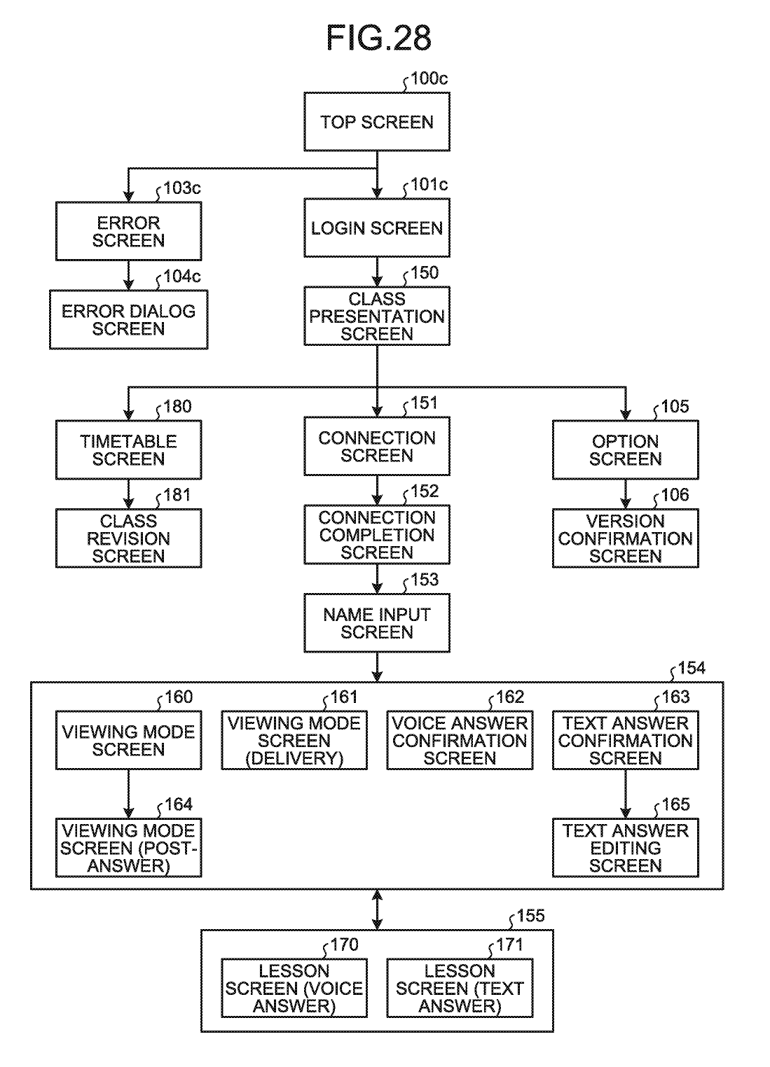

In FIG. 28 is illustrated an example of the screen transition in the student terminal 20 according to the embodiment. With reference to FIG. 28, a top screen 100c represents is the initially-displayed screen displayed by the portal server 32 when, for example, the student terminal 20 issues an access request to the class management server 30 at Step S311 illustrated in FIG. 12. Then, the screen of the student terminal 20 changes from the top screen 100c to a login screen 101c in which an input area is provided for inputting login information and a button is provided for sending a login request. As explained earlier with reference to Steps S312 to S317 illustrated in FIG. 12, the login information is input in and sent from the login screen 101c; and, when the authentication is successful, a class presentation screen 150 meant for selecting the class to be taken is displayed as the initial screen in the student terminal 20 (Step S318 illustrated in FIG. 12).

Meanwhile, if the access from the top screen 100c to the login screen 101c ends up in failure for some reason, then the screen display in the student terminal 20 changes to an error screen 103c for displaying a system error message and, for example, after a predetermined period of time, the screen changes to an error dialog screen 104c for notifying the occurrence of an error.

In response to an operation of the student terminal 20, the screen thereof can change from the class presentation screen 150 to a connection screen 151 or a timetable screen 180. The connection screen 151 is meant for performing such setting in the student terminal 20 which enables communication in the classroom in which the class is to be conducted; and is displayed in the student terminal at, for example, Step S322 illustrated in FIG. 12.

When the connection setting using the connection screen 151 is completed and when the student carries the concerned student terminal 20 to the classroom in which the class is going to be conducted and completes the connection with the access point in the classroom, a connection completion screen 152 gets displayed in the student terminal 20. Although a specific example is described later, the connection completion screen 152 has a screen configuration corresponding to, for example, the class presentation screen 150 described earlier.

Meanwhile, after changing to the timetable screen 180, the screen of the student terminal 20 can change to a class revision screen 181. The timetable screen 180 and the class revision screen 181 are screens accessible to a student from outside of the classroom (for example, from the home), and thus need not have classroom-by-classroom connection setting performed therein.

When a predetermined operation is performed in the class presentation screen 150, the student terminal 20 can change the screen display to a screen for performing a logout operation or to an option screen 105 that is meant for instructing the display of the version and license information of the class application installed in the student terminal 20. When an operation for instructing the display of the version and the license is performed in the option screen 105, the screen changes to a version confirmation screen 106.

After a name is input in a name input screen 153, the screen of the student terminal changes to class screen groups 154 and 155 meant for taking the class. For example, the screen of the student terminal 20 can change from the name input screen 153 to viewing mode screens 160 and 161, a voice answer confirmation screen 162, or a text answer confirmation screen 163 that are included in the class screen group 154.

The viewing mode screen 160 is meant for viewing, in the student terminal 20, the contents included in the lesson. The viewing mode screen 161 is meant for displaying the contents delivered by the teacher and answering the task while viewing the displayed contents. For example, in the case of a class conducted in the classroom 2c, when the teacher C displays a video output from the video player 24 on the electronic blackboard 23c and delivers the screen of the electronic blackboard 23c to the student terminals 20_{c1}, 20_{c2}, and so on; the screen in each of the student terminals 20_{c1}, 20_{c2}, and so on is changed to the viewing mode screen 161.

When a lesson demands the answer in the form of a voice, the voice answer confirmation screen 162 is meant for confirming the answer given to the task by recording the voice and submitting the answer as the deliverable. When the lesson demands the answer in the form of text input, the text answer confirmation screen 163 is meant for confirming the answer input as a text input with respect to the task and submitting the answer as the deliverable. Meanwhile, in response to an operation, the student terminal 20 can change the screen to a text answer editing screen 165; so that the text data confirmed in the text answer confirmation screen 163 can be edited, and the edited text data can be submitted as the deliverable.

In response to an operation, the student terminal 20 can change the screen from the viewing mode screen 160, or the viewing mode screen 161, or the voice answer confirmation screen 162, or the text answer confirmation screen 163 either to a lesson screen 170 based on the voice answer and included in the class screen group 155 or to a lesson screen 171 based on the text answer and included in the class screen group 155. In response to the reproduction of contents, the lesson screen 170 demands voice recording of utterances from the students. In an identical manner, in response to the reproduction of contents, the lesson screen 171 demands text input from the students. Regarding whether to change the screen of the student terminal 20 to the lesson screen 170 or the lesson screen 171, the selection is done according to, for example, the details of the request for a response based on the response information with respect to the lesson.

Meanwhile, for example, when an answer is given with respect to the task using the lesson screen 170 or the lesson screen 171, the student terminal 20 can change the screen to a viewing mode screen 164 that is meant to enable submission of the answer as the deliverable with respect to the task.

In the explanation given above, in the student terminal 20, after the login screen 101c is displayed, the class presentation screen 150 is displayed as the initial screen. However, that is not the only possible case. Alternatively, in the student terminal 20, after the login screen 101c is displayed, the screen can be changed to a classroom selection screen and then to the class presentation screen 150.

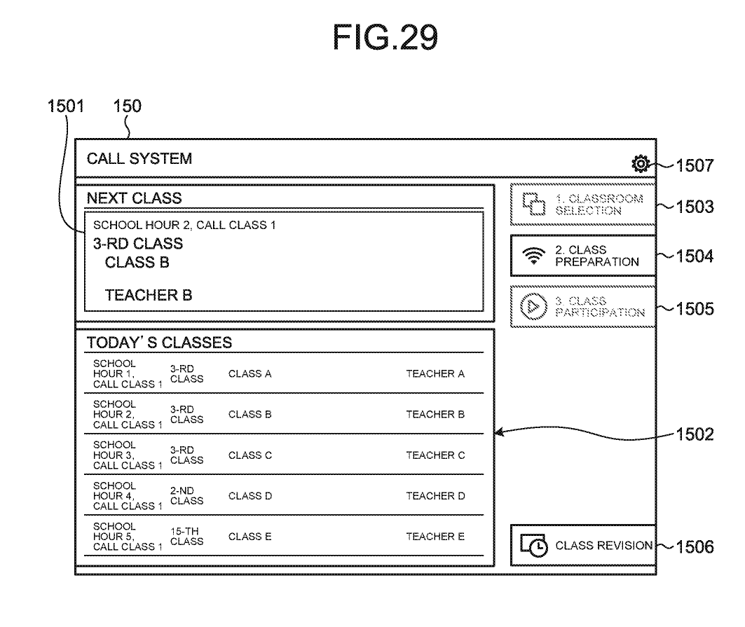

In FIG. 29 is illustrated an example of the class presentation screen 150 according to the embodiment. The class presentation screen 150 includes a class display area 1501 and a class list display area 1502. The class presentation screen 150 further includes buttons 1503, 1504, 1505, and 1506 and a system setting icon 1507. In response to an operation thereof, the system setting icon 1507 changes the screen of the student terminal 20 from the class presentation screen 150 to the option screen 105.

The class list display area 1502 is used to display a list of classes to be taken by the concerned student on that day. The information about each class displayed in the class list display area 1502 contains, in an identical manner to the class display area 1501, a variety of information indicating the classroom, the school hour, the class name, and the teacher in charge.

With reference to FIG. 29, the button 1503 is meant for selecting a classroom. In response to an operation of the button 1503, the student terminal 20 changes the screen to the classroom selection screen. In the example in which the school 1 includes the classrooms 2a, 2b, and 2c; the student terminal 20 displays a list of the classrooms 2a, 2b, and 2c in response to an operation of the button 1503 and prompts the selection of a classroom.

When a classroom is selected in response to an operation of the button 1503, information about the class to be conducted next in the selected classroom (for example, the classroom 2a) is displayed in the class display area 1501. The information about the class as displayed in the class display area 1501 contains the information indicating the classroom in which that class will be conducted, the information indicating the time at which that class will be conducted (i.e., the school hour), the name of that class, and the name of the teacher in charge. Based on the class display area 1501, a student can carry the student terminal 20 to the classroom in which the class is going to be conducted.

The button 1504 is meant for preparing for the purpose of taking the class in the classroom that is selected in response to an operation of the button 1503. In response to an operation of the button 1504, the student terminal 20 changes the screen to the connection screen 151. As a result, the operations from Steps S321 to S323 illustrated in FIG. 12 are performed and, in the classroom selected in response to an operation of the button 1503 (for example, in the classroom 2a), the student terminal 20 becomes able to connect to the class management server 30 via the access point installed in that classroom (for example, the AP 22a). Thus, even a student who has not registered to take classes can attend the lecture by connecting to the class management server 30.

The button 1504 is meant for taking the class displayed in the class display area 1501. In the example illustrated in FIG. 29, the display of the button 1505 is grayed out and the function thereof is disabled. Meanwhile, in the connection completion screen 152 explained earlier, the button 1503 in the class presentation screen 150 is grayed out and disabled, while the button 1504 in the class presentation screen 150 is released from the grayed-out state and is enabled.

The button 1506 is meant for revising the class. In response to an operation of the button 1506, the student terminal 20 changes the screen to the timetable screen 180.

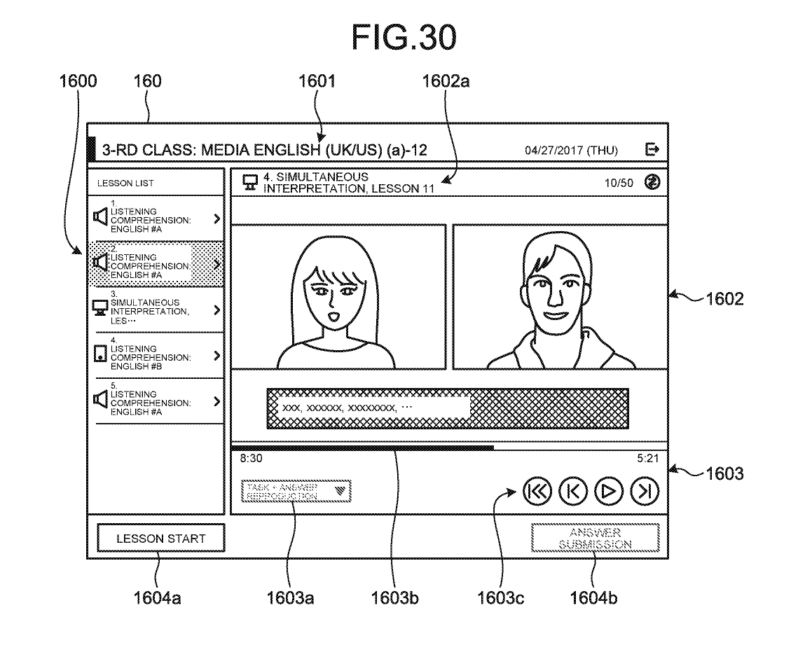

In FIG. 30 is illustrated an example of the viewing mode screen 160. Herein, the viewing mode screen 160 corresponds to the class screen that is presented from the class management server 30 at Step S330 illustrated in FIG. 12. With reference to FIG. 30, the viewing mode screen 160 includes a lesson display portion 1600, a title display area 1601, a contents display portion 1602, and a control area 1603. Moreover, in the viewing mode screen 160, buttons 1604a and 1604b are provided in the lowermost part.

The lesson display portion 1600 is used to display a list of lessons included in the class that is being taken using the student terminal 20. Each lesson displayed in the lesson display portion 1600 includes the lesson name and an icon indicating the type of the lesson. The title display area 1601 is used to display the lesson name of the lesson that is currently selected in the lesson display portion 1600. The contents display portion 1602 is used to display the contents included in the lesson that is currently selected in the lesson display portion 1600; and an area 1602a is used to display the lesson name of that lesson.

The control area 1603 includes a plurality of operators 1603c meant for controlling the reproduction of the contents present in the contents display portion 1602; includes a progress bar 1603b for indicating the position of reproduction of the contents; and includes a selection portion 1603a meant for selecting data to be output as the deliverable. In the selection portion 1603a, for example, it is possible to either select a combination of a task and an answer or select only an answer. Herein, the task implies the voice of contents and the answer implies a recorded voice.

The button 1604a is meant for instructing the start of the selected lesson. For example, in response to an operation of the button 1604a, the student terminal 20 performs voice recording of the voice picked up by the microphone 2021 that is connected to the student terminal 20. This operation corresponds to the operation performed at Step S334 illustrated in FIG. 12. In the student terminal 20, for example, the deliverable storing unit 204 stores voice data of that voice in a file and stores the voice data file in the storage 2004 of the student terminal 20; and thus voice recording is performed.

The button 1604b is meant for submitting the answer. More particularly, for example, in response to an operation of the button 1604b, the student terminal 20 can send the recorded voice as the answer, that is, as the deliverable to the class management server 30. In the example illustrated in FIG. 30, since the voice recording in the selected lesson has not yet started, the button 1604b is grayed out and the function thereof is disabled.

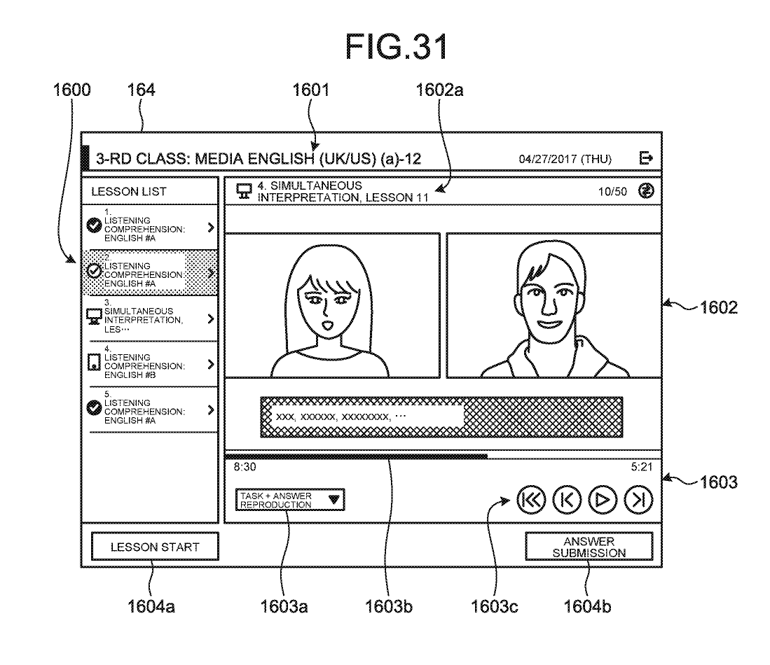

In FIG. 31 is illustrated an example of the viewing mode screen 164 according to the embodiment after the answer has been given. In the viewing mode screen 164 illustrated in FIG. 31, as compared to the viewing mode screen 160 illustrated in FIG. 30, the grayed-out state of the button 1604b is released and the function thereof is enabled. For example, in the viewing mode screen 160 illustrated in FIG. 30, at the point of time of completion of the voice recording performed by operating the button 1604a, the student terminal 20 releases the grayed-out state of the button 1604b and enables its function. In response to an operation of the button 1604b, the student terminal 20 changes the screen to the voice answer confirmation screen 162.

Meanwhile, when the button 1604a meant for instructing the start of the lesson is operated in the viewing mode screen 164, the student terminal 20 again performs voice recording. In that case, the recorded voice data is managed in a distinguishable manner from the voice data recorded in the previous instance. For example, in the student terminal 20, the deliverable storing unit 204 sets the file name of a file for storing the recorded voice data to be a unique file name for every instance of voice recording, and stores the files in the storage 2004. As far as the unique file name set for every instance of voice recording, for example, it is possible to think of a file name to which a serial number is attached that increases in value for every instance of voice recording. As a result, the student terminal 20 can create a plurality of answers for a single lesson.

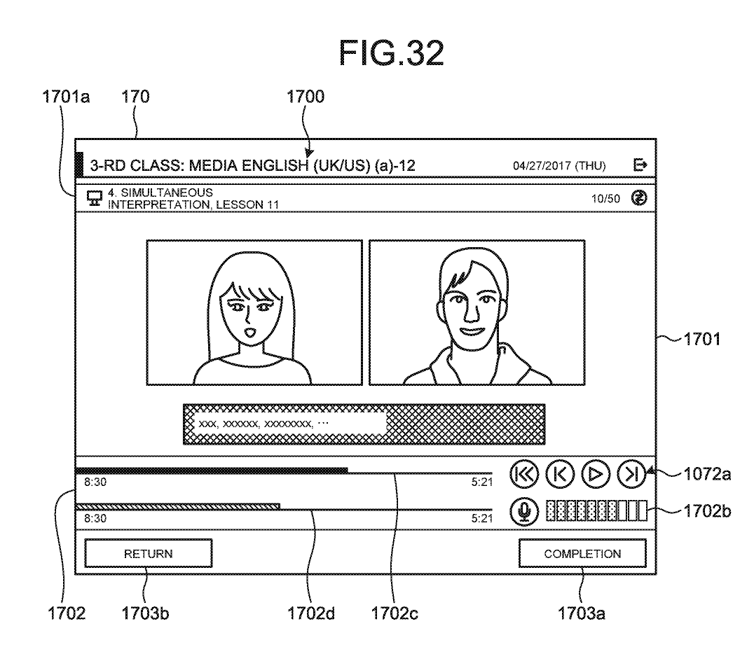

In FIG. 32 is illustrated an example of the lesson screen 170 according to the embodiment. In response to an operation of the button 1604a in the viewing mode screen 160 illustrated in FIG. 30, the student terminal 20 changes the screen to the lesson screen 170 that includes a title display area 1700, a contents display portion 1701, a control area 1702, and buttons 1703a and 1703b.

The title display area 1700 is used to display the class name of the class being conducted. Moreover, in the contents display portion 1701, a lesson name display area 1701a is provided in the upper part for displaying the lesson name of the lesson being carried out.

In the example illustrated in FIG. 32, the control area 1702 includes a plurality of operators 1702a meant for controlling the reproduction of the contents presented in the contents display portion 1701; includes a level meter 1702b indicating the state of voice pick-up; includes a progress bar 1702c for indicating the position of reproduction of the contents displayed in the contents display portion 1701; and includes a voice recording bar 1702d for indicating the elapse of the voice recording period.

The button 1703a is a completion button operated upon the completion of voice recording. In response to an operation of the button 1703a, the student terminal 20 stores the recorded voice data in a file having a predetermined file name assigned thereto, and stores that file in the storage 2004, for example. The button 1703b is meant for returning to the previous screen. For example, after the viewing mode screen 160 changes to the lesson screen 170; in response to an operation of the button 1703b, the student terminal 20 changes the screen back to the viewing mode screen 160. At that time, the viewing mode screen 160 is substituted by the viewing mode screen 164 in which the button 1604b meant for submitting the answer is enabled.

Meanwhile, in the lesson screen 171 meant for text input, the operators 1702a and the progress bar 1702c are displayed in the control area 1702. In the lesson screen 170, the area in which the level meter 1702b and the voice recording bar 1702d are displayed is treated as the text input area.

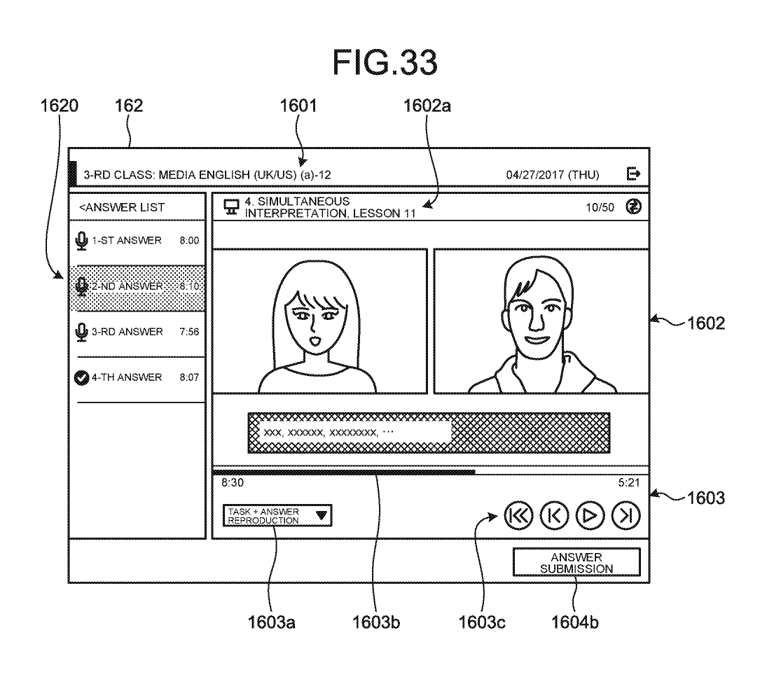

In FIG. 33 is illustrated an example of the voice answer confirmation screen 162 according to the embodiment. In the example illustrated in FIG. 33, the voice answer confirmation screen 162 has an identical screen configuration to the screen configuration of the viewing mode screen 160 explained with reference to FIG. 30, and includes the title display area 1601, the contents display portion 1602, and the control area 1603. The contents display portion 1602 includes the lesson name display area 1602a for displaying the lesson name of the lesson corresponding to the displayed contents. Moreover, in the voice answer confirmation screen 162, the button 1604b meant for submitting the answer, that is, the deliverable is provided in the lowermost part.

Meanwhile, in the voice answer confirmation screen 162, an answer list display portion 1620 is provided in place of the lesson display portion 1600 provided in the viewing mode screen 160. The answer list display portion 1620 is used to display a list of answers that are created in the lesson displayed in the lesson name display area 1602a. In the example illustrated in FIG. 33, the answers of four instances are displayed in the answer list display portion 1620, thereby indicating that voice recording is performed for four times in a single lesson and four answers are created.

The student terminal 20 can reproduce the voice data of the answers specified in the answer list display portion 1620. For example, the student who is using the concerned student terminal 20 can sequentially specify and reproduce the answers displayed in the answer list display portion 1620 and, based on the results of reproduction, can decide on the answer to be submitted. In response to an operation of the button 1604b, the student terminal 20 sends, as the deliverable of the concerned lesson to the class management server 30, the voice data corresponding to the answer specified in the answer list display portion 1620 (Step S340 illustrated in FIG. 12).

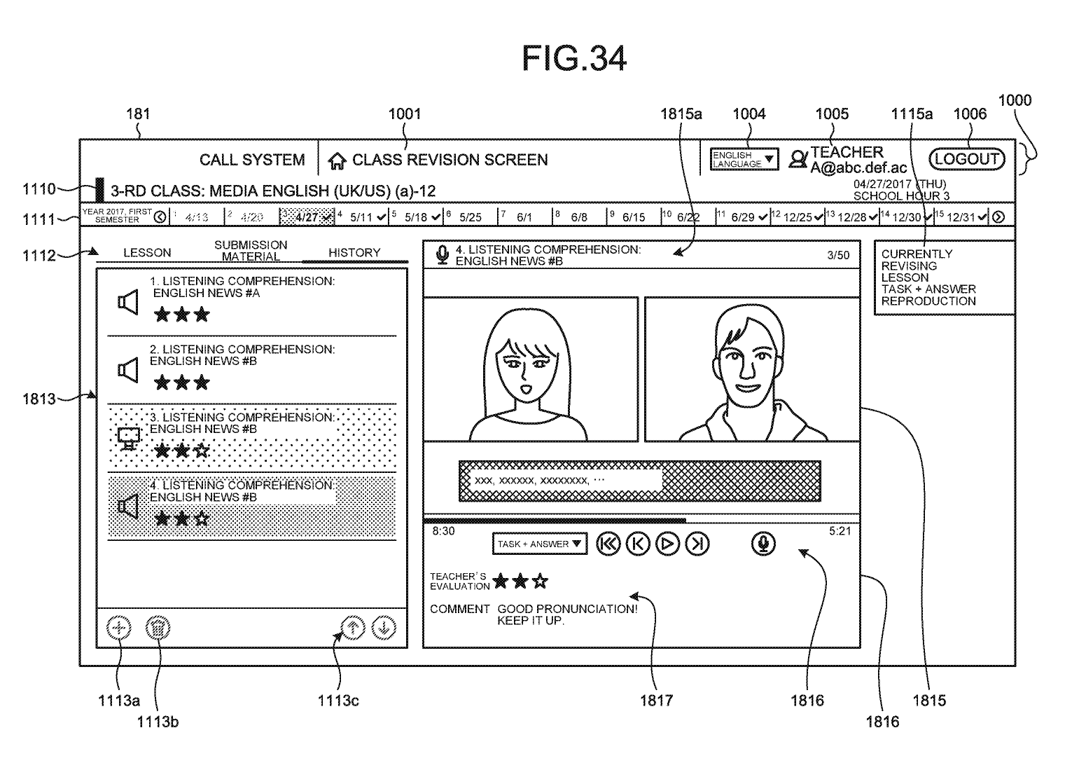

In FIG. 34 is illustrated an example of the class revision screen 181 according to the embodiment. As described earlier, the timetable screen 180 changes to the class revision screen 181. Herein, the timetable screen 180 has the same screen configuration as that of the staff member timetable screen 102 explained with reference to FIG. 14; and is meant for selectively displaying, in the timetable display area 1025 of the staff member timetable screen 102, the class taken by the student who had performed login from the login screen 101c.

With reference to FIGS. 1 and 2, the student d uses the terminal device 20d from the outside of the classroom (for example, from the home 5) and accesses the class management server 30. As described earlier, the terminal device 20d can be implemented using an identical configuration to the configuration of the teacher PC 21, and has a browser installed therein. Thus, in the terminal device 20d, the UI presented by the class management server 30 is created in the browser.

The terminal device 20d follows the same sequence of operations as the sequence of operations followed by the teacher PC 21 to perform an access operation illustrated in FIG. 11, and accesses the class management server 30 by performing an authentication operation according to the operations performed at Steps S200 to S206. In response to the access from the terminal device 20d, the class management server 30 presents, as the initial screen to the terminal device 20d, a timetable screen in which the lesson taken by the student d is selectively displayed (see Step S210 illustrated in FIG. 11). When the student d specifies the desired school hour from the timetable screen, the terminal device 20d requests the class management server 30 for the class screen of the specified school hour. In response to that request, the class management server 30 refers to the task information table (see Table 5) stored in the class information DB 35 and creates the class revision screen 181.

Returning to the explanation with reference to FIG. 34, the class revision screen 181 includes the same constituent elements as the class initial screen 111 explained earlier with reference to FIG. 17. With reference to FIG. 34, the portions identical to those in the class initial screen 111 illustrated in FIG. 17 are referred to by the same reference numerals, and the detailed explanation thereof is not repeated. In the class revision screen 181, the title bar area 1000 in the upper part includes the screen title 1001, the language selecting portion 1004, the login information display portion 1005, and the logout button 1006.

In the example illustrated in FIG. 34, the class name display portion 1110 is provided below the title bar area 1000; and the time schedule specification bar 1111 is provided below the class name display portion 1110. Moreover, a lesson display portion 1813 and a contents presentation portion 1815 are provided below the time schedule specification bar 1111. The contents presentation portion 1815 corresponds to, for example, the contents presentation portion 1114 in the class initial screen 111. On the right-hand side of the contents presentation portion 1815, the status display portion 1115a is provided.

The class name display portion 1110 is used to display the class name of the class that is conducted at the school hour specified in the timetable screen 180. The time schedule specification bar 1111 is used to display a list of time schedules of the classes included in the class course that also includes the concerned class. The lesson display portion 1813 is used to display a list of lessons related to the class having the time schedule specified in the time schedule specification bar 1111. Meanwhile, in the class revision screen 181, the display of each lesson also includes information indicating the evaluation offered by the teacher to the deliverable submitted by the student d for that lesson.

The contents presentation portion 1815 is meant for presenting the contents used in the lesson specified in the lesson display portion 1813.

Above the lesson display portion 1813, the tab 1112 is provided that includes tabs for switching between a lesson list, a submission material list, and a history list. In the example illustrated in FIG. 34, in the tab 1112, the tab for displaying, in the lesson display portion 1113, the history of the lesson taken by the student d is specified. In that case, in the lesson display portion 1813, for example, from among the lessons included in the specified class, sets of information indicating the lessons for which the deliverable is submitted are selectively listed.

Meanwhile, in the tab 1112 in the class revision screen 181, when the submission material list is specified, for example, a list of submission materials, that is, deliverables submitted in that class is displayed in the lesson display portion 1813 along with the evaluation offered to the deliverables. In the tab 1112, when the lesson list is specified, for example, a list of sets of information of all lessons included in the specified class is displayed in the lesson display portion 1813.

In the class revision screen 181, the buttons 1113a, 1113b, and 1113c that are respectively meant for instructing addition of a lesson, instructing deletion of a lesson, and instructing a change in the sequence of lessons are grayed out, and their functions are disabled.

The contents presentation portion 1815 is meant for presenting the contents to be used in the lesson specified in the lesson display portion 1813. In the contents presentation portion 1815, the name of the concerned lesson is displayed in a title area 1815a. When video data represents the contents, that video data is displayed in the contents presentation portion 1815 as illustrated in FIG. 34. When data other than video data represents the contents, for example, an icon image indicating the type of the contents is displayed in the contents presentation portion 1815.

In the example illustrated in FIG. 34, below the contents presentation portion 1815, a control area 1816 and an evaluation information area 1817 are provided. The control area 1816 includes various operators meant for controlling the reproduction of the contents displayed in the contents presentation portion 1815; includes a progress bar for indicating the position of reproduction of the contents; and includes a selection portion meant for selecting data to be reproduced. In the selection portion, for example, it is possible to either select a combination of a task and an answer or select only an answer.

The evaluation information area 1817 is used to display information indicating the evaluation offered to the deliverable submitted for the lesson that is specified in the lesson display portion 1813. In the example illustrated in FIG. 34, in the evaluation information area 1817, a three-grade evaluation is displayed along with a comment with respect to the evaluation.

As described above, in the CALL system based on the information processing system according to the embodiment, the classes and the lessons are associated with the deliverables and are presented in the teacher PC 21 and the student terminals 20. As a result, for example, the teacher can easily understand the evaluation offered to the deliverable of each student who took the class conducted by that teacher, and thus can conduct the class in an efficient manner. Moreover, each student too can understand the deliverable submitted in the class taken by him or her, and can enhance his or her learning efficiency.

Meanwhile, in the explanation given above, the CALL system based on the information processing system according to the embodiment is completely configured within a single school 1. However, that is not the only possible case. Alternatively, the CALL system based on the information processing system according to the embodiment can be configured in an integrated manner across a plurality of schools (school buildings). Moreover, the network 10 in the school 1 and the networks in other schools either can be connected via the FW 37 and the Internet 50 or can be directly connected using a dedicated line. Meanwhile, the information processing system according to the embodiment is not limited to be implemented in a CALL system and can also be implemented for other purposes.

According to an aspect of the present invention, it becomes possible to easily understand the relationship between delivered contents and the data sent in response to those contents.

Meanwhile, in the present invention, a terminal device capable of communicating with an information processing device, includes: an obtaining unit that obtains, from the information processing device, task information containing a task and a request for an answer to the task; a presenting unit that presents the task, which is included in the task information obtained by the obtaining unit, to a user; an input receiving unit that, in response to the request for an answer as included in the task information obtained by the obtaining unit, receives input of an answer to the task which is presented in the presenting unit; and a sending unit that sends the answer, whose input is received by the input receiving unit, in a corresponding manner to the task, which is presented in the presenting unit, to the information processing device.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising an information processing device, a first terminal device, and a second terminal device, wherein
the information processing device includes:
a first memory having first computer readable instructions stored thereon; and
at least one first processor configured to execute the first computer readable instructions to,
set, in response to an instruction from the first terminal device, task information containing a task and a request for an answer to the task, and
manage the task information,
the second terminal device includes:
a second memory having second computer readable instructions stored thereon; and
at least one second processor configured to execute the second computer readable instructions to,
obtain the task information from the first processor,
present the task, which is included in the obtained task information, to a user,
receive, in response to the request for an answer as included in the obtained task information, input of an answer to the presented task, and
send the received answer in a corresponding manner to the presented task to the information processing device, and
for each of sets of identification information enabling identification of the second terminal device that sent the answer, the at least one first processor manages the answer, which is sent by the at least one second processor in a corresponding manner to the task, in a corresponding manner to the task information containing the task.

2. The information processing system according to claim 1, wherein
in response to an instruction from the first terminal device, the at least one first processor specifies a set of task information, from among sets of the task information managed therein, that is obtainable by the at least one second processor.

3. The information processing system according to claim 1, wherein
in response to an instruction from the first terminal device, the at least one first processor manages the task information in a corresponding manner to a time slot and a location specified by the first terminal device.

4. The information processing system according to claim 1, wherein
in response to an instruction from the first terminal device, the at least one first processor presents, to the first terminal device, a list of sets of the task information, which is specified by the first terminal device, corresponding to the sets of identification information.

5. The information processing system according to claim 4, wherein
in response to an instruction from the first terminal device, the at least one first processor presents, to the first terminal device, the list of sets of the task information along with information indicating whether or not the answer is associated with the task information corresponding to each of the sets of identification information.

6. The information processing system according to claim 5, wherein
in response to an instruction from the first terminal device, for each of the sets of identification information, when the answer is associated with the task information corresponding to concerned set of identification information, the at least one first processor associates an evaluation value, which is specified for the answer by the first terminal device, to the answer and presents the answer to the first terminal device.

7. The information processing system according to claim 1, wherein
the task includes at least a voice as contents, and
the at least one first processor sets, in response to an instruction from the first terminal device, the task that includes details indicating reproduction of a first voice included in the contents and indicating voice recording of a second voice in form of utterance by a user according to the reproduced first voice.

8. The information processing system according to claim 7, wherein
the at least one first processor
performs voice recording of the second voice in a concurrent manner to reproduction of the first voice, and
in response to an instruction from the first terminal device, sets the task that includes a request for the answer in which the recorded second voice is to be sent to the information processing device.

9. The information processing system according to claim 7, wherein
the at least one first processor
alternately performs reproduction of each of a plurality of the first voice and voice recording of the second voice corresponding to the reproduced first voice, and
in response to an instruction from the first terminal device, sets the task that includes a request for the answer in which the recorded second voice is to be sent to the information processing device.

10. The information processing system according to claim 7, wherein
the contents include the first voice and a video that is reproduced in synchronization with the first voice, and
the at least one first processor
performs voice recording of the second voice in a concurrent manner to reproduction of the video included in the contents and reproduction of the first voice synchronized with the video, and
in response to an instruction from the first terminal device, sets the task that includes a request for the answer in which the recorded second voice is to be sent to the information processing device.

11. The information processing system according to claim 7, further comprising a display device
that is capable of displaying a video which is included in the contents input from an external device and which is reproduced in synchronization with the first voice, and
that is capable of sending the video to the information processing device, wherein
the at least one first processor
performs voice recording of the second voice in a concurrent manner to reproduction of the video, which is included in the contents sent from the display device, and reproduction of the first voice synchronized with the video, and
in response to an instruction from the first terminal device, sets the task that includes a request for the answer in which the recorded second voice is to be sent to the information processing device.

12. The information processing system according to claim 7, wherein
the at least one first processor
performs, in a plurality of the second terminal device, voice recording and communication of a third voice that is in form of utterance by a user of each of the second terminal devices, and
in response to an instruction from the first terminal device, sets the task that includes a request for the answer in which the recorded third voices, each of which is recorded in one of the second terminal devices, are to be sent to the information processing device.

13. The information processing system according to claim 1, wherein
the second terminal device further includes a memory unit for storing the answer whose input is received by the at least one second processor in response to the task, and
when a plurality of the answer corresponding to the task is stored in the memory unit, the at least one second processor sends, to the information processing device and in a corresponding manner to the task, the answer selected from among the answers according to an instruction from a user and the identification information.

14. The information processing system according to claim 1, wherein
the at least one first processor sets, in a corresponding manner to a predetermined location, whether or not to allow connection of the second terminal device.

15. The information processing system according to claim 1, wherein
the at least one first processor further presents, in the first terminal device, a user interface meant for inputting the instruction.

16. An information processing method implemented in an information processing system that includes an information processing device, a first terminal device, and a second terminal device, the information processing method comprising:
setting, in response to an instruction from the first terminal device, task information containing a task and a request for an answer to the task;
managing, by a managing unit, that includes managing the task information;
obtaining, by the second terminal device, that includes obtaining the task information from the managing unit;
presenting the task, which is included in the task information obtained at the obtaining, to a user;
input-receiving that, in response to the request for an answer as included in the task information obtained at the obtaining, includes receiving input of an answer to the task which is presented in the presenting; and
sending the answer, whose input is received at the input-receiving, and identification information, which enables identification of the second terminal device, in a corresponding manner to the task, which is presented at the presenting, to the information processing device, wherein
for each of sets of identification information enabling identification of the second terminal device that sent the answer, the managing includes managing the answer, which is sent at the sending in a corresponding manner to the task, in a corresponding manner to the task information containing the task.

17. An information processing device capable of communicating with a first terminal device and a second terminal device, comprising:
a memory having computer readable instructions stored thereon; and
at least one processor configured to execute the computer readable instructions to,
set, in response to an instruction from the first terminal device, task information containing a task and a request for an answer to the task;
present, in the first terminal device, a user interface meant for inputting the instruction;
manage the task information; and
receive the answer which is sent from the second terminal device and which is associated to the task included in the task information that is obtained by the second terminal device, wherein
for each of sets of identification information enabling identification of the second terminal device that sent the answer, the at least one processor further manages the received answer in a corresponding manner to the task information containing the task.
